(19) United States
(12) Patent Application Publication
(10) Pub. No.: US 2025/0008440 A1
(43) Pub. Date: Jan. 2, 2025

(54) PAGING MONITORING FOR MULTICAST AND BROADCAST SESSION

(71) Applicant: Samsung Electronics Co., Ltd., Suwon-si (KR)

(72) Inventors: Anil Agiwal, Allen, TX (US); Shiyang Leng, Allen, TX (US); Kyeongin Jeong, Allen, TX (US)

(21) Appl. No.: 18/733,135

(22) Filed: Jun. 4, 2024

Related U.S. Application Data
(60) Provisional application No. 63/523,554, filed on Jun. 27, 2023.
(60) Provisional application No. 63/525,331, filed on Jul. 6, 2023.

(51) Int. Cl. H04W 52/02; H04W 68/02; H04W 72/1273; H04W 76/40

(52) U.S. Cl. CPC H04W 52/0235; H04W 68/02; H04W 72/1273; H04W 76/40

(57) ABSTRACT

Methods and apparatuses for a paging monitoring operation for a multicast and broadcast session in a wireless communication system. A method performed by a user equipment (UE) includes monitoring for a low power wakeup signal (LP WUS) on a carrier of a cell where the UE is camped; receiving the LP WUS; instructing a main receiver (MR) to monitor for multicast broadcast (MBS) session data in response to a reception of the LP WUS; and receiving the MBS session data when at least one MBS session is activated.

### CROSS-REFERENCE TO RELATED APPLICATIONS AND CLAIM OF PRIORITY

The present application claims priority to U.S. Provisional Patent Application No. 63/523,554, filed on Jun. 27, 2023, and U.S. Provisional Patent Application No. 63/525,331, filed on Jul. 6, 2023. The contents of the above-identified patent documents are incorporated herein by reference.

### TECHNICAL FIELD

The present disclosure relates generally to wireless communication systems and, more specifically, the present disclosure relates to a paging monitoring operation for a multicast and broadcast session in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a paging monitoring operation for a multicast and broadcast session in a wireless communication system.

In one embodiment, a user equipment (UE) in a wireless communication system is provided. The UE comprises a low-power receiver (LR) configured to: monitor for a low power wakeup signal (LP WUS) on a carrier of a cell where the UE is camped and receive the LP WUS. The UE further comprises a processor operably coupled to the LR, the processor configured to instruct a main receiver (MR) to monitor for multicast broadcast (MBS) session data in response to a reception of the LP WUS; and the MR operably coupled to the processor, the MR configured to receive the MBS session data when at least one MBS session is activated.

In another embodiment, a method of a UE comprising an LR in a wireless communication system is provided. The method comprises: monitoring for an LP WUS on a carrier of a cell where the UE is camped; receiving the LP WUS; instructing an MR to monitor for MBS session data in response to a reception of the LP WUS; and receiving the MBS session data when at least one MBS session is activated.

In yet another embodiment, a BS in a wireless communication system is provided. The BS comprises a processor configured to generate an LP WUS. The UE further comprises a transceiver operably coupled to the processor, the transceiver configured to: transmit, to a UE comprising an LR, the LP WUS on a carrier of a cell where the UE is camped, and transmit, to the UE, MBS session data after transmitting the LP WUS, wherein the MBS session data is monitored by an MR of the UE when at least one MBS session is activated.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to embodiments of the present disclosure;

FIG. 6 illustrates an example of a signaling flow between a UE and a gNB according to embodiments of the present disclosure;

FIG. 7 illustrates a flowchart of a method for monitoring PO according to embodiments of the present disclosure;

FIG. 8 illustrates an example of a signaling flow between a UE and a gNB according to embodiments of the present disclosure;

FIG. 9 illustrates a flowchart of a method for monitoring PO and receiving a paging message according to embodiments of the present disclosure;

FIG. 10 illustrates an example of a signaling flow between a UE and a gNB according to embodiments of the present disclosure;

FIG. 11 illustrates a flowchart of a method for monitoring PO according to embodiments of the present disclosure;

FIG. 12 illustrates a flowchart of a method for monitoring PO according to embodiments of the present disclosure;

FIGS. 13A and 13B illustrate examples of LP WUS based paging monitoring according to embodiments of the present disclosure;

FIG. 14 illustrates an example of LP WUS subgroup ID determination according to embodiments of the present disclosure;

FIG. 15 illustrates a flowchart of a method for receiving a paging message according to embodiments of the present disclosure;

FIG. 16 illustrates a flowchart of a method for transmitting a paging message according to embodiments of the present disclosure;

FIG. 17 illustrates an example of LP WUS subgroup ID determination according to embodiments of the present disclosure;

FIG. 18 illustrates a flowchart of a method for receiving a paging message according to embodiments of the present disclosure;

FIG. 19 illustrates another flowchart of a method for receiving a paging message according to embodiments of the present disclosure;

FIG. 20 illustrates an example of LP WUS subgroup ID determination according to embodiments of the present disclosure;

FIG. 21 illustrates a flowchart of a method for receiving a paging message according to embodiments of the present disclosure;

FIG. 22 illustrates a flowchart of a method for transmitting a paging message according to embodiments of the present disclosure;

FIG. 23 illustrates an example of PEI-O and PO determination according to embodiments of the present disclosure;

FIG. 24 illustrates a flowchart of a method for receiving a paging message according to embodiments of the present disclosure;

FIG. 25 illustrates a flowchart of a method for transmitting a paging message according to embodiments of the present disclosure;

FIGS. 26-32 illustrate examples of PEI-O and PO determination according to embodiments of the present disclosure; and

FIG. 33 illustrates an example of a method for a paging monitoring operation for a multicast and broadcast session according to embodiments of the present disclosure.

### DETAILED DESCRIPTION

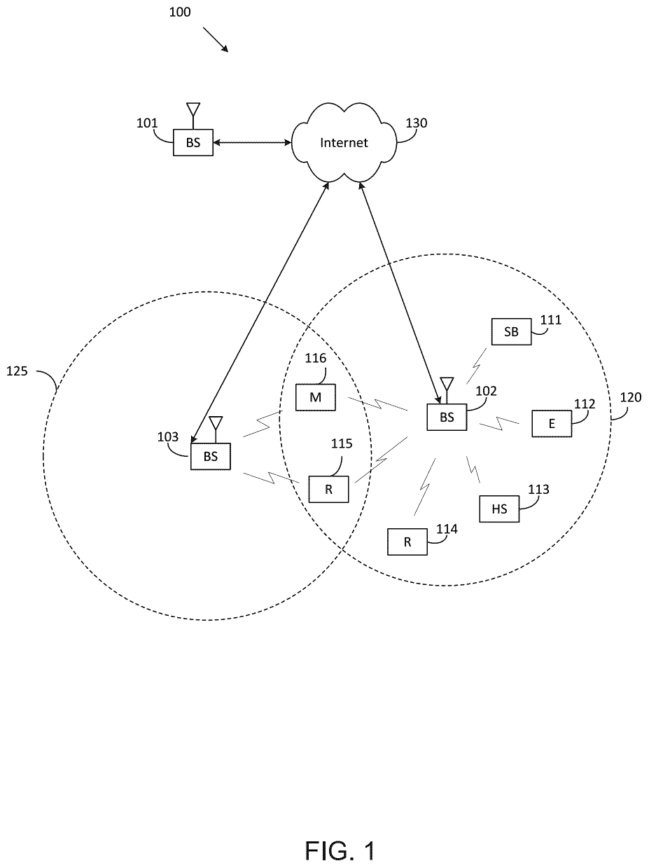

FIGS. 1 through 33, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANS), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a paging monitoring operation for a multicast and broadcast session in a wireless communication system. In certain embodiments, and one or more of the gNBs 101-103 includes circuitry, programing, or a combination thereof, to support a paging monitoring operation for a multicast and broadcast session in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

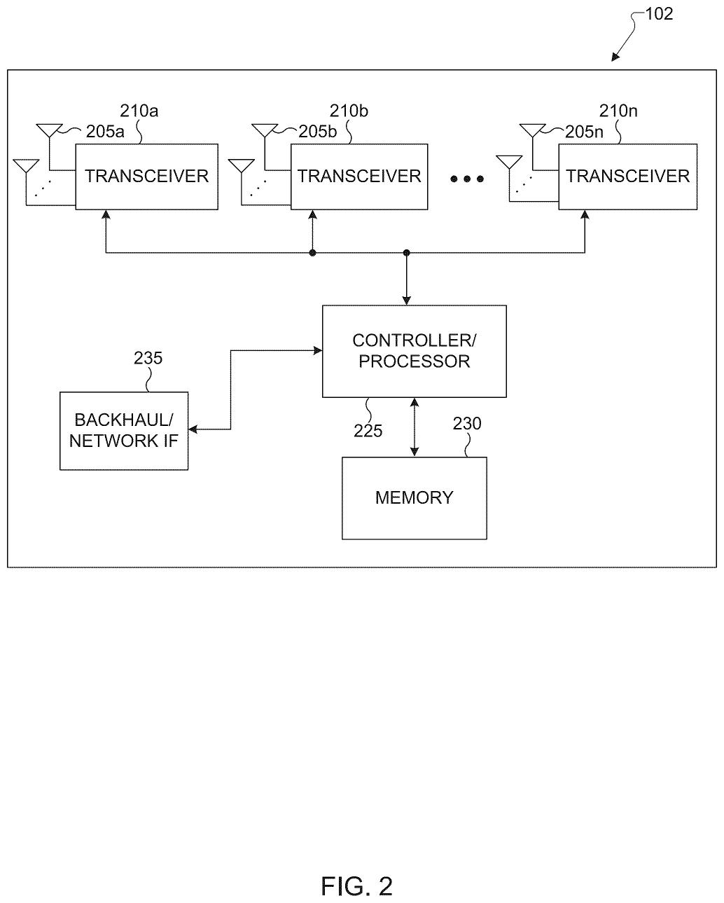

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support a paging monitoring operation for a multicast and broadcast session in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

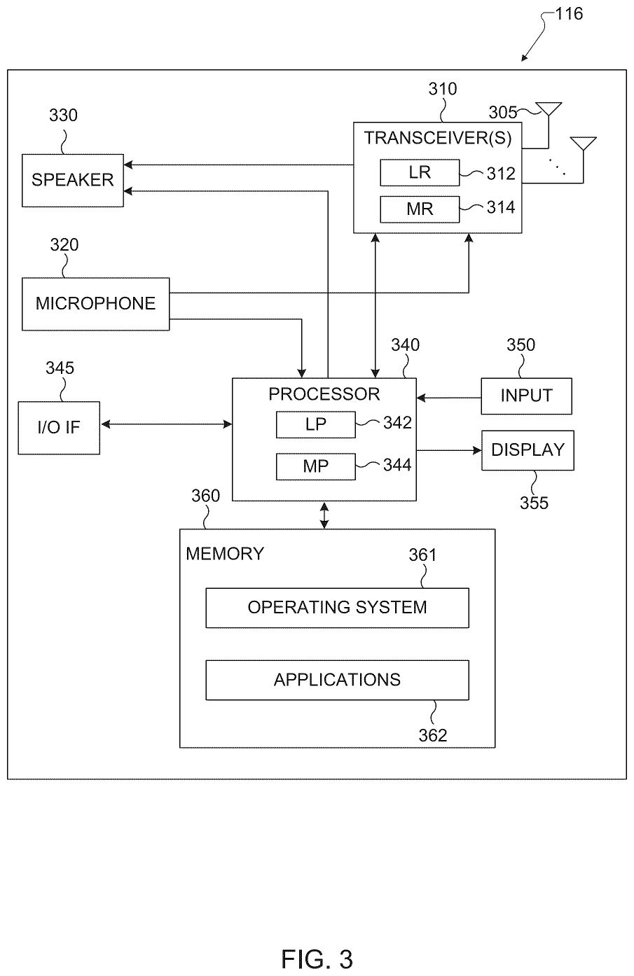

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a paging monitoring operation for a multicast and broadcast session in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one LR 312 and at least one MR 314. For example, as discussed in greater detail below, the LR 312 may be configured or utilized to receive low power signals (e.g., a LP-WUS), for example, when the UE 116 is in a sleep state (e.g., such as an ultra-deep sleep state as discussed in greater detail below), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

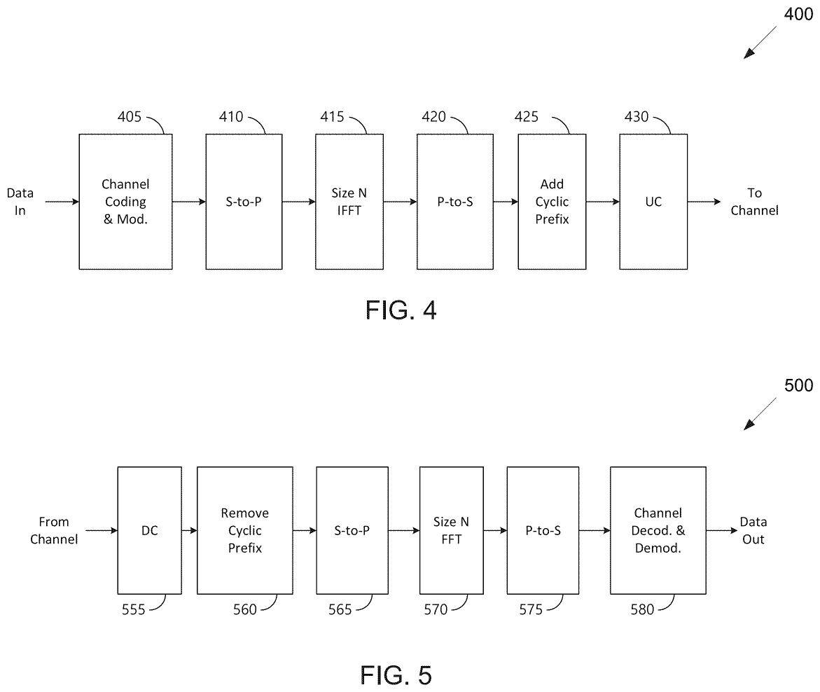

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a paging monitoring operation for a multicast and broadcast session in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A paging operation allows the network to reach UEs in an RRC_IDLE and in an RRC_INACTIVE state through paging messages, and to notify UEs in an RRC_IDLE, an RRC_INACTIVE, and an RRC_CONNECTED state of system information change and earthquake and tsunami warning system (ETWS)/commercial mobile alert system (CMAS) indications through a short messages. Both paging messages and short Messages are addressed with P-RNTI on PDCCH, but while the former is sent on PCCH logical channel (TB carrying a paging message is transmitted over PDSCH (Physical downlink shared channel)), the latter is sent over PDCCH directly.

While in an RRC_IDLE the UE monitors the paging channels for CN-initiated paging. While in an RRC_INACTIVE with no ongoing SDT procedure the UE monitors paging channels for RAN-initiated paging and CN-initiated paging. A UE need not monitor paging channels continuously though; Paging DRX is defined where the UE in the RRC_IDLE or the RRC_INACTIVE is only required to monitor paging channels during one paging occasion (PO) per DRX cycle. The paging DRX cycles are configured by the network: (1) for CN-initiated paging, a default cycle is broadcast in system information; (2) for CN-initiated paging, a UE specific cycle can be configured via NAS signalling; and (3) for RAN-initiated paging, a UE-specific cycle is configured via RRC signalling. In one example, the UE uses the shortest of the DRX cycles applicable i.e., a UE in the RRC_IDLE uses the shortest of the first two cycles above, while a UE in the RRC_INACTIVE uses the shortest of the three.

In order to reduce UE power consumption due to false paging alarms, the group of UEs monitoring the same PO can be further divided into multiple subgroups. With subgrouping, a UE may monitor PDCCH in its PO for paging if the subgroup to which the UE belongs is paged as indicated via associated paging early indication (PEI). If a UE cannot find its subgroup ID with the PEI configurations in a cell or if the UE is unable to monitor the associated PEI occasion corresponding to its PO, it may monitor the paging in its PO.

NR system enables resource efficient delivery of multicast/broadcast services (MBS). A UE can receive data of MBS multicast session in the RRC_CONNECTED state or the RRC_INACTIVE state after joining the MBS multicast session. It is up to a gNB whether the UE receives data of MBS multicast session in the RRC CONNECTED state or the RRC INACTIVE state. The gNB moves the UE from the RRC_CONNECTED state to the RRC_INACTIVE state via dedicated RRC signalling, and moves the UE from the RRC_INACTIVE state to the RRC_CONNECTED state via the group notification or RAN-initiated paging. A gNBs supporting MBS use a group notification mechanism to notify the UEs in the RRC_INACTIVE state when the session is already activated and the gNB has multicast session data to deliver. Upon reception of the group notification, the UEs reconnect to the network or resume the connection and transition to the RRC_CONNECTED state from either the RRC_IDLE state or the RRC_INACTIVE state. For the group notification, the gNB includes TMGI(s) of activated session in a paging message.

A low power wakeup receiver (LP-WUR or LR) and wakeup signal design is being studied to minimize UE power consumption. LP-WUR or LR is a receiver module (e.g., the Tx and Rx modules may be implemented by hardware, software, or a combination of software and hardware in the system) operating for receiving/processing signals/channel related to low-power wake-up. The LR is expected to consume 1/100 of power consumed by main radio (also referred as an MR) in a UE which is used to receive downlink signals (such as PDCCH, PDSCH, etc.) from base station. MR is the Tx/Rx module operating for signals/channels apart from signals/channel related to low-power wake-up. It is expected that the UE in an RRC_IDLE or an RRC_INACTIVE monitor Low power wakeup signal (LP WUS) using the LR if the UE and camped cell supports LP WUS. If the LP WUS is received (or LP WUS for a UE/UE specific paging subgroup is received), the UE monitors PEI (using MR) and subsequently the UE monitors PO and receives a paging message if PEI indicates paging for the UE/UE specific paging subgroup. A UE supporting LP WUS is camped in a cell supporting LP WUS. The UE monitors LP WUS.

In one example of LP WUS design 1, a reception of LP WUS indicates a UE to wake up and monitor paging e.g., monitor PEI/PO (PEI in case camped cell and the UE supports PEI and criteria (If PEI configuration is provided in system information and If lastUsedCellOnly is configured in system information of a cell, the UE monitors PEI in this cell if the UE most recently received RRCRelease without noLastCellUpdate in this cell. Otherwise i.e., if lastUsedCellOnly is not configured in system information of a cell, the UE monitors PEI in the camped cell) to monitor PEI is met, PO in case camped cell and/or the UE does not support PEI and/or criteria to monitor PEI is not met) and absence of LP WUS indicates the UE to not monitor paging i.e., not monitor PEI/PO. In this design, the UE does not monitor PEI/PO when the UE does not receive LP WUS in the monitored LP WUS occasion.

In one example of LP WUS design 2, LP WUS includes information indicating a UE to wake up and monitor paging i.e., monitor PEI/PO (PEI in case camped cell and the UE supports PEI and criteria (If PEI configuration is provided in system information and If lastUsedCellOnly is configured in system information of a cell, the UE monitors PEI in this cell if the UE most recently received RRCRelease without noLastCellUpdate in this cell. Otherwise i.e., if lastUsedCellOnly is not configured in system information of a cell, the UE monitors PEI in the camped cell) to monitor PEI is met; PO in case camped cell and/or the UE does not support PEI and/or criteria to monitor PEI is not met). In this case, the UE does not monitor PEI/PO when information in LP WUS does not indicate the UE to wake up and monitor paging i.e., monitor PEI/PO. Information indicating the UE to wake up may be 1 bit information (the bit may be set to 1 or 0 to indicate the UE to wake up/monitor paging or not wake up/monitor paging respectively or vice versa).

LP WUS includes information indicating one or more paging subgroup(s) to wake up and monitor paging i.e., PO. Here paging subgroups is same as paging subgroups of PEI. In this case, a UE does not monitor PO when information in LP WUS does not indicate to wake up and monitor paging i.e., monitor PO for UE's paging subgroup. Information indicating a UE to wake up may be 1 bit information per paging subgroup (the bit may be set to 1 or 0 to indicate UE's belonging to the paging subgroup to wake up or not wake up respectively or vice versa). Information indicating a UE to wake up/monitor paging may be inclusion of UE's paging subgroup id in the LP WUS payload.

LP WUS includes information indicating WUS subgroup(s) to wake up and monitor paging i.e., monitor PEI/PO (PEI in case camped cell and a UE supports PEI and criteria (If PEI configuration is provided in system information and If lastUsedCellOnly is configured in system information of a cell, the UE monitors PEI in this cell if the UE most recently received RRCRelease without noLastCellUpdate in this cell. Otherwise i.e., if lastUsedCellOnly is not configured in system information of a cell, the UE monitors PEI in the camped cell) to monitor PEI is met; PO in case camped cell and/or the UE does not support PEI and/or criteria to monitor PEI is not met). WUS subgroups can be different from paging subgroups. In this case, a UE does not monitor PEI/PO when information in LP WUS does not indicate UE's WUS subgroup(s) to wake up and monitor paging i.e., monitor PEI/PO. Information indicating the UE to wake up may be 1 bit information per paging subgroup (the bit may be set to 1 or 0 to indicate UE's belonging to the WUS subgroup to wake up or not wake up respectively or vice versa). Information indicating the UE to wake up/monitor paging may be inclusion of UE's WUS subgroup id in the LP WUS payload.

The consequence is that if a UE supports MBS and LP WUS does not indicate a UE/UE's paging subgroup to wakeup/monitor paging as there is no CN/RAN paging for the UE or SI/emergency notification, it may not be able to receive MBS group notification and may miss to receive multicast sessions. So, enhancement to monitor paging, specifically monitoring MBS group notification based on LR/LP WUS is needed.

In one embodiment, 1 bit MBS group notification in LP WUS is provided. A UE monitors PO if MBS group notification is received in LP WUS: (1) MBS group notification bitmap in LP WUS, where each bit is mapped to MBS multicast session(s) or TMGI(s); (2) MBS paging subgroup and indication of MBS paging subgroup in LP WUS; (3) Skipping monitoring LP WUS if a UE expects MBS group notification; and (4) Criteria to monitor LP WUS, activation/deactivation.

A UE is in the RRC_CONNECTED state and receiving data of MBS multicast session. If there is temporarily no data to be sent to the UEs for the multicast session that is active, the gNB may move the UE to the RRC_INACTIVE state by sending an RRCRelease message with a suspend configuration. If MBS multicast session is deactivated, the gNB may move the UE to an RRC_IDLE by sending the RRCRelease message without the suspend configuration or the RRC_INACTIVE state by sending the RRCRelease message with the suspend configuration.

While the UE is in the RRC_IDLE or the RRC_INACTIVE state, if MBS multicast session is already activated and the gNB has multicast session data to deliver, the gNB transmits LP WUS indicating MBS group notification or MBS paging. LP WUS can be transmitted on same DL carrier/frequency as the carrier/frequency on which PDCCH/PDSCH are transmitted. LP WUS can be transmitted on different DL carrier/frequency than the carrier/frequency on which PDCCH/PDSCH are transmitted. The DL carrier/frequency for LP WUS can be signaled by the gNB in SI (e.g., SIB1 or MIB or another SIB). The DL BWP for transmitting LP WUS can be initial DL BWP or it can be a different BWP signaling by the gNB in SI (e.g., SIB1 or MIB or another SIB).

MBS group notification/MBS paging indication can be 1 bit information. It can be set to 1 to indicate MBS group notification/MBS paging. Alternately, it can be a dedicated sequence for MBS group notification/MBS paging with which the LP WUS is scrambled. Alternately, it can be a dedicated LP WUS occasion for MBS group notification/MBS paging. LP WUS indicating MBS group notification/paging is followed by transmission of PDCCH addressed to P-RNTI in PO. The DCI of this PDCCH provides scheduling information of DL TB transmitted on PDSCH and this TB includes a paging message. The paging message includes an MBS session ID (i.e., TMGI or Temporary Mobile Group Identity) of the multicast session.

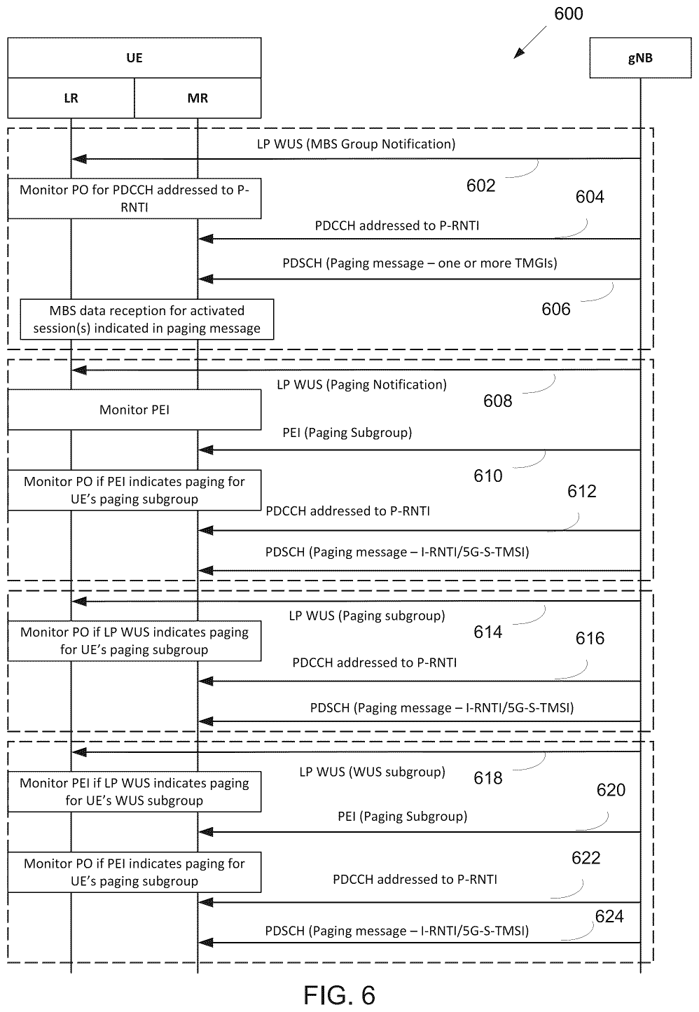

FIG. 6 illustrates an example of a signaling flow 600 between a UE and a gNB according to embodiments of the present disclosure. As illustrated in FIG. 6, the UE includes an LR and a MR. The LR and the MR may be included in a transceiver as illustrated in FIG. 6. The signaling flow 600 as may be performed by a UE (e.g., 111-116 as illustrated in FIG. 1) and a base station (e.g., 101-103 as illustrated in FIG. 6). An embodiment of the signaling flow 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

In an embodiment, as illustrated in FIG. 6, in step 602, the gNB sends LP WUS (e.g., MBS group notification) to the UE. In step 604, the gNB sends PDCCH addressed to P-RNTI to the UE. In step 606, gNB sends PDSCH (e.g., paging message-one or more TMGIs) to the UE. The MR of the UE receives the PDCCH and PDSCH, and LR of the UE receives the LP WUS. In step 608, the gNB sends LP WUS (e.g., paging notification) to the UE. In an alternate embodiment as illustrated in FIG. 6, in step 610, the gNB sends PEI (e.g., paging subgroup). In step 612, the gNB sends the PDSCH (e.g., paging message), In step 616, the gNB sends the PDCCH addressed to P-RNTI to the UE. In step 618, the gNB sends the LP-WUS to the UE. In step 620, the gNB sends the PEI (e.g., paging subgroup) to the UE. In step 622, the gNB sends the PDCCH addressed to P-RNTI. Finally, in step 624, the gNB sends the PDSCH (e.g., paging message) to the UE. The MR of the UE receives the PEI, PDCCH and PDSCH, and LR of the UE receives the LP WUS.

While the UE is an RRC_IDLE or an RRC_INACTIVE state, if RAN paging or CN paging is received by a gNB: (1) the gNB may transmit LP WUS indicating paging/wakeup indication or indicating paging/wakeup indication for UE's paging subgroup/WUS subgroup; (2) the gNB may also transmit PEI indicating paging/wakeup indication for UE's paging subgroup if the gNB and the UE supports PEI and paging subgroup indication in LP WUS is not supported; (3) the gNB may transmit PDCCH addressed to P-RNTI in PO. The DCI of this PDCCH provides scheduling information of DL TB which includes a paging message. The paging message includes UE's identity (I-RNTI for RAN paging, 5G-S-TMSI for CN paging).

A UE is in an RRC_IDLE or an RRC_INACTIVE state. The UE is interested in MBS group notification. The UE is also interested in receiving CN paging (in the RRC_IDLE and in the RRC_INACTIVE) and RAN paging (in the RRC_INACTIVE).

A UE may monitor LP WUS, if the UE supports LP WUS and/or is camped in a cell supporting LP WUS and/or cell quality or RSRP of DL path loss reference is below a configured threshold and/or a gNB has indicated to monitor LP WUS for UE's paging subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) and/or not at cell edge criteria is met and/or “If lastUsedCellOnlyLPWUS is configured in system information of camped cell and the UE most recently received RRCRelease without noLastCellUpdate in this cell” and/or “If lastUsedCellOnlyLPWUS is not configured in system information of camped cell.” LR is used to receive LP WUS.

LP WUS can be monitored on same DL carrier/frequency as the carrier/frequency on which PDCCH/PDSCH are received. LP WUS can be received on different DL carrier/frequency than the carrier/frequency on which PDCCH/PDSCH are received. The DL carrier/frequency for LP WUS can be signaled by the gNB in SI (e.g., SIB1 or MIB or another SIB). The DL BWP for receiving LP WUS can be initial DL BWP or it can be a different BWP signalled by the gNB in SI (e.g., SIB1 or MIB or another SIB).

If LP WUS received by the UE indicates/includes MBS group notification/MBS paging indication or if the UE does not or cannot monitor LP WUS, the UE monitors its PO for PDCCH addressed to P-RNTI. MBS group notification/MBS paging indication can be 1 bit information set to 1. Alternately, it can be a dedicated sequence for MBS with which the LP WUS is scrambled. Alternately, it can be a dedicated LP WUS occasion for MBS group notification/MBS paging indication. Note that even if the cell and UE support PEI, the UE may not monitor PEI in this case. MR is used to monitor PO and receive PDCCH/PDSCH.

The UE receives PDCCH addressed to P-RNTI in the monitored PO. The UE receives and decodes the DL TB scheduled by this PDCCH. The UE receives the paging message in decoded DL TB. The UE obtains the list (paging group list) of one or more MBS session ids (or TMGIs) in the paging message. If the TMGI of an MBS session joined by the UE is included in paging group list: (1) if the UE is in an RRC_IDLE, RRC in the UE may forward the TMGI to upper layer i.e., NAS which may then initiate the RRC connection setup to enter an RRC_CONNECTED for receiving the multicast session data; (2) if the UE is in an RRC_INACTIVE and multicast session data reception is not supported in the RRC_INACTIVE, RRC in the UE may forward the TMGI to upper layer and may also initiate RRC connection resume procedure to enter the RRC_CONNECTED for receiving the multicast session data; (3) if the UE is in the RRC_INACTIVE and multicast session data reception is supported in the RRC_INACTIVE and for the TMGI there is indication in the paging message to resume data reception, the UE starts receiving the multicast session data in the RRC_INACTIVE, starts monitoring PDCCH addressed to G-RNTI of the MBS session; and (4) MR is used for multicast session data reception.

If LP WUS received by the UE does not indicates/includes MBS group notification/MBS paging indication or the UE is not interested in MBS group notification/MBS paging indication, and LP WUS indicates paging/wakeup/PO monitoring indication for UE's paging subgroup: the UE monitors its PO for PDCCH addressed to P-RNTI. MR is used to monitor PO and receive PDCCH/PDSCH.

If LP WUS received by the UE does not indicates/includes MBS group notification/MBS paging indication or the UE is not interested in MBS group notification/MBS paging indication, and LP WUS indicates paging/wakeup/PEI monitoring indication (i.e., there is no subgroup specific indication in LP WUS): (1) the UE monitors PEI if camped cell and the UE supports PEI and criteria (If a PEI configuration is provided in system information and If lastUsedCellOnly is configured in system information of a cell, the UE monitors PEI in this cell if the UE most recently received RRCRelease without noLastCellUpdate in this cell. Otherwise i.e., if lastUsedCellOnly is not configured in system information of a cell, the UE monitors PEI in the camped cell) to monitor PEI is met. If bit corresponding to UE's paging subgroup is set to 1 in PEI, the UE monitors PO for PDCCH addressed to P-RNTI; (2) if camped cell and/or the UE does not support PEI and/or criteria to monitor PEI is not met, the UE monitors its PO for PDCCH addressed to P-RNTI; and (3) MR is used to monitor PO/PEI and receive PDCCH/PDSCH.

If LP WUS received by the UE does not indicates/includes MBS group notification/MBS paging indication or the UE is not interested in MBS group notification/MBS paging indication, and LP WUS indicates paging/wakeup/PEI monitoring indication for UE's WUS subgroup: (1) the UE monitors PEI if camped cell and the UE supports PEI and criteria (If a PEI configuration is provided in system information and If lastUsedCellOnly is configured in system information of a cell, the UE monitors PEI in this cell if the UE most recently received RRCRelease without noLastCellUpdate in this cell. Otherwise i.e., if lastUsedCellOnly is not configured in system information of a cell, the UE monitors PEI in the camped cell) to monitor PEI is met. If bit corresponding to UE's paging subgroup is set to 1 in PEI, the UE monitors PO for PDCCH addressed to P-RNTI; (2) if camped cell and/or the UE does not support PEI and/or criteria to monitor PEI is not met, the UE monitors its PO for PDCCH addressed to P-RNTI; and (3) MR is used to monitor PO/PEI and receive PDCCH/PDSCH.

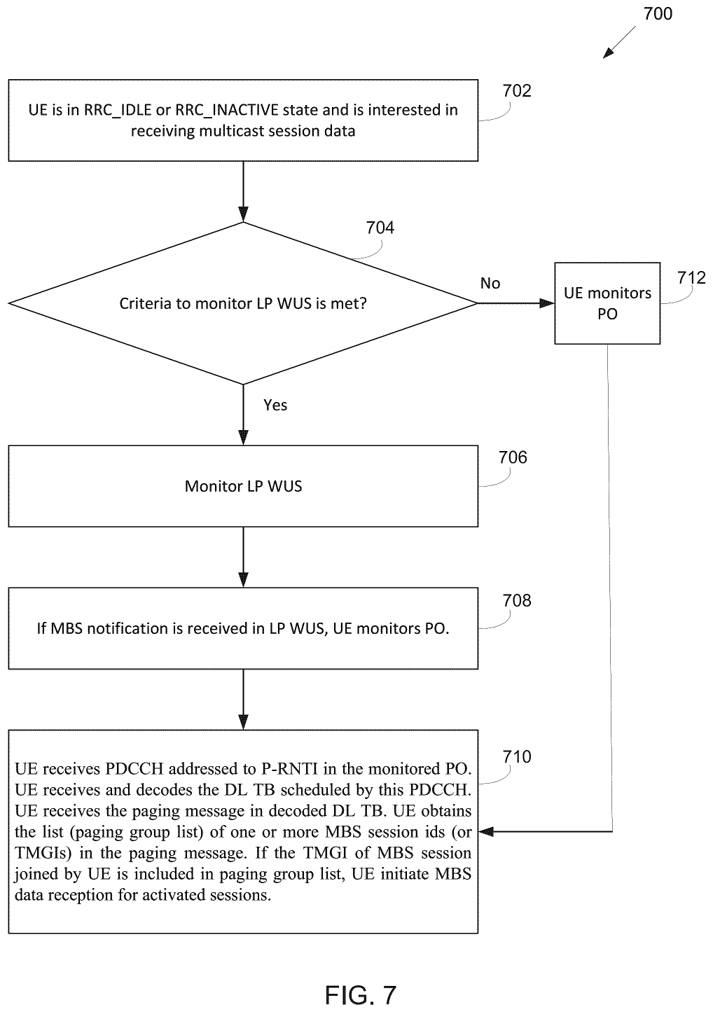

In one embodiment, the conditions for PO monitoring by a UE for MBS are shown in FIG. 7. The UE is in an RRC_IDLE or an RRC_INACTIVE state and is interested in receiving multicast session data. If criteria to monitor LP WUS is met, the UE monitor LP WUS. If MBS notification/MBS group notification/MBS paging indication is received in LP WUS, the UE monitors PO. If criteria to monitor LP WUS is not met, the UE monitors PO (the UE does not monitor PEI). The UE receives PDCCH addressed to P-RNTI in the monitored PO. The UE receives and decodes the DL TB scheduled by this PDCCH. The UE receives the paging message in decoded DL TB. The UE obtains the list (paging group list) of one or more MBS session ids (or TMGIs) in the paging message. If the TMGI of an MBS session joined by the UE is included in paging group list, the UE initiate MBS data reception for activated sessions.

FIG. 7 illustrates a flowchart of a method 700 for monitoring PO according to embodiments of the present disclosure. The method 700 as may be performed by a UE (e.g., 111-116 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, in step 702, the UE is in RRC_IDLE or RRC_INACTIVE state and is interested in receiving multicast session data. In step 704, the UE determines whether a criteria to monitor LP-WUS is met. If met, in step 716, the UE monitors the LP-WUS. If not in step 704, the UE monitors PO in step 712. In step 708, the UE monitors the PO if the MBS notification is received in LP WUS. In step 710, the UE receives PDCCH addressed to P-RNTI in the monitored PO. The UE receives and decodes the DL TB scheduled by this PDCCH. The UE receives the paging message in decoded DL TB. The UE obtains the list (paging group list) of one or more MBS session ids (or TMGIs) in the paging message. If the TMGI of MBS session joined by the UE is included in paging group list, the UE initiate MBS data reception for activated sessions.

The advantage of this approach is that a UE does not need to monitor PO for MBS until MBS notification/MBS group notification/MBS paging indication is received in LP WUS. Note that in existing system the UE monitors PO for MBS, thereby increasing power consumption of the UE supporting and interested in receiving multicast sessions.

A UE is in an RRC_CONNECTED state and receiving data of MBS multicast session. If there is temporarily no data to be sent to the UEs for the multicast session that is active, the gNB may move the UE to an RRC_INACTIVE state by sending an RRCRelease message with a suspend configuration. If MBS multicast session is deactivated, the gNB may move the UE to an RRC_IDLE by sending the RRCRelease message without the suspend configuration or the RRC_INACTIVE state by sending the RRCRelease message with the suspend configuration.

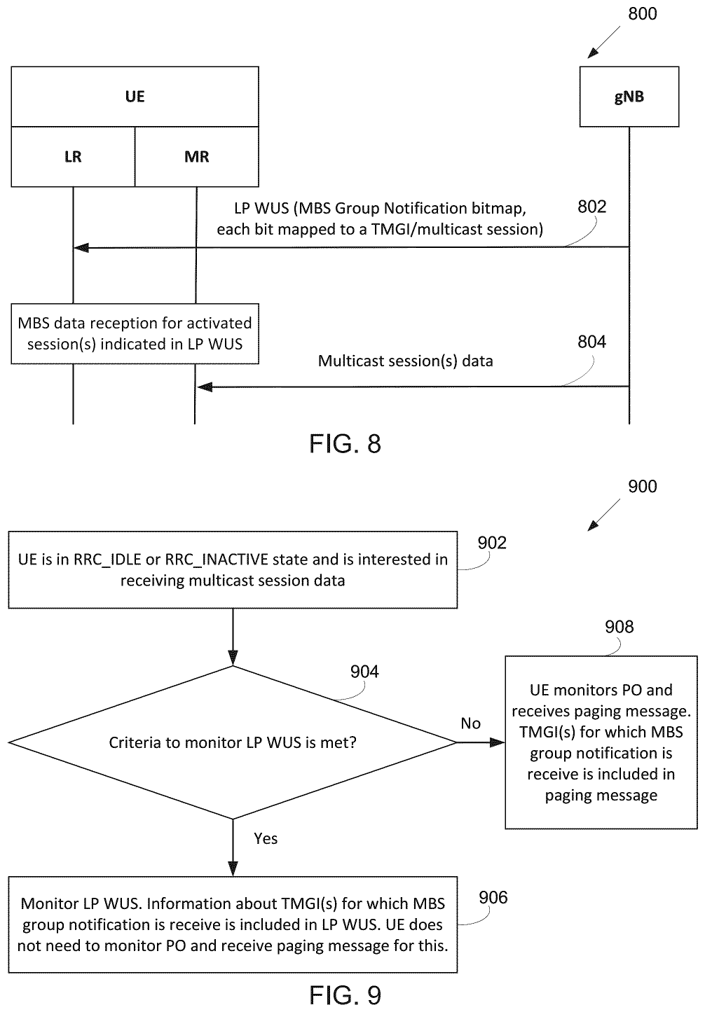

While the UE is in an RRC_IDLE or an RRC_INACTIVE state, if an MBS session is already activated and the gNB has multicast session data to deliver, the gNB transmits LP WUS indicating MBS notification/MBS group notification/MBS paging indication for the multicast sessions (or TMGI) as shown in FIG. 8. Based on this information the UE initiate MBS data reception for activated sessions. LP WUS can include a bit map for MBS notification/MBS group notification/MBS paging indication wherein each bit corresponds to a different TMGI. A list of TMGIs can be transmitted by the gNB in system information or MCCH and bits in LP WUS can be mapped from MSB to LSB or vice versa to TMGIs in the list sequentially starting from first TMGI in list. Alternative, LP WUS can include TMGI of multicast session for which the MBS session is already activated and the gNB has multicast session data to deliver. LP WUS may include indication indicating to resume multicast session data reception in the RRC_INACTIVE. The indication can be per TMGI or this indication can be common for all TMGIs.

FIG. 8 illustrates an example of a signaling flow 800 between a UE and a gNB according to embodiments of the present disclosure. As illustrated in FIG. 8, the UE includes an LR and an MR. The LR and the MR may be included in a transceiver. The method 800 as may be performed by a UE (e.g., 111-116 as illustrated in FIG. 1) and a BS (e.g., 101-103 as illustrated in FIG. 1). An embodiment of the signaling flow 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, in step 802, the gNB sends LP WUS (MBS group notification bitmap and each bit mapped to a TMGI/multicast session) to the UE. The UE receives LPWUS via the LR. In step 804, the gNB sends the multicast session data to the UE. The UE receives multicast session data via the MR.

LP WUS can be transmitted on same DL carrier/frequency as the carrier/frequency on which PDCCH/PDSCH are transmitted. LP WUS can be transmitted on different DL carrier/frequency than the carrier/frequency on which PDCCH/PDSCH are transmitted. The DL carrier/frequency for LP WUS can be signaled by the gNB in SI (e.g., SIB1 or MIB or another SIB). The DL BWP for transmitting LP WUS can be initial DL BWP or it can be a different BWP signaling by the gNB in SI (e.g., SIB1 or MIB or another SIB).

Note that even though LP WUS has information about the TMGIs, the gNB still transmit a paging message as UE(s) monitoring paging for MBS may or may not be monitoring LP WUS. LP WUS indicating MBS group notification is followed by transmission of PDCCH addressed to P-RNTI in PO. The DCI of this PDCCH provides scheduling information of DL TB transmitted on PDSCH and this TB includes the paging message. the paging message includes an MBS session ID (i.e., TMGI or Temporary Mobile Group Identity) of the multicast session.

A UE is in an RRC_IDLE or an RRC_INACTIVE state. The UE is interested in MBS group notification. The UE monitors LP WUS or PO for MBS group notification as follows (e.g., FIG. 9).

The UE may monitor LP WUS, if the UE supports LP WUS and/or is camped in a cell supporting LP WUS and/or cell quality or RSRP of DL path loss reference is below a configured threshold and/or a gNB has indicated to monitor LP WUS for UE's paging subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) and/or not at cell edge criteria is met and/or “If lastUsedCellOnlyLPWUS (or lastUsedCellOnly) is configured in system information of camped cell and the UE most recently received RRCRelease without noLastCellUpdate (or noLastCellUpdateLPWUS) in this cell” and/or “If lastUsedCellOnlyLPWUS (or lastUsedCellOnly) is not configured in system information of camped cell.” LR is used to receive LP WUS.

LP WUS can be monitored on same DL carrier/frequency as the carrier/frequency on which PDCCH/PDSCH are received. LP WUS can be received on different DL carrier/frequency than the carrier/frequency on which PDCCH/PDSCH are received. The DL carrier/frequency for LP WUS can be signaled by the gNB in SI (e.g., SIB1 or MIB or another SIB). The DL BWP for receiving LP WUS can be initial DL BWP or it can be a different BWP signalled by the gNB in SI (e.g., SIB1 or MIB or another SIB).

If the UE monitors LP WUS and If LP WUS received by the UE indicates/includes MBS notification/MBS group notification/MBS paging indication for MBS multicast session (TMGI) joined by the UE or if LP WUS received by the UE includes an MBS session id (TMGI) of MBS multicast session joined by the UE (as shown in FIG. 8), the UE initiates MBS multicast session data reception for activated sessions as follows: (1) if in the UE is in an RRC_IDLE, RRC in U the E may forward the TMGI to upper layer i.e., NAS which may then initiate the RRC connection setup to enter an RRC_CONNECTED for receiving the multicast session data; (2) if in the UE is in an RRC_INACTIVE and multicast session data reception is not supported in the RRC_INACTIVE, RRC in the UE may forward the TMGI to upper layer and may also initiate RRC connection resume procedure to enter the RRC_CONNECTED for receiving the multicast session data; (3) if the UE is in the RRC_INACTIVE and multicast session data reception is supported in the RRC_INACTIVE and for the TMGI there is indication in LP WUS to resume data reception in the RRC_INACTIVE, the UE starts receiving the multicast session data in the RRC_INACTIVE, starts monitoring PDCCH addressed to G-RNTI of the MBS session; (4) MR is used for multicast session data reception.

If the UE does not or cannot monitor LP WUS, the UE monitors its PO for PDCCH addressed to P-RNTI. Note that even if the cell and the UE supports PEI, the UE may not monitor PEI in this case. MR is used to monitor PO and receive PDCCH/PDSCH.

The UE receives PDCCH addressed to P-RNTI in the monitored PO. The UE receives and decodes the DL TB scheduled by this PDCCH. The UE receives the paging message in decoded DL TB. The UE obtains the list (paging group list) of one or more MBS session ids (or TMGIs) in the paging message. If the TMGI of an MBS session joined by the UE is included in paging group list, the UE initiate MBS data reception for activated sessions as follows.

If in the UE is in an RRC_IDLE, RRC in the UE may forward the TMGI to upper layer i.e., NAS which may then initiate the RRC connection setup to enter an RRC_CONNECTED for receiving the multicast session data.

If in the UE is in an RRC_INACTIVE and multicast session data reception is not supported in the RRC_INACTIVE, RRC in the UE may forward the TMGI to upper layer and may also initiate RRC connection resume procedure to enter the RRC_CONNECTED for receiving the multicast session data.

If the UE is in the RRC_INACTIVE and multicast session data reception is supported in the RRC_INACTIVE and for the TMGI there is indication in the paging message to resume data reception, the UE starts receiving the multicast session data in the RRC_INACTIVE, starts monitoring PDCCH addressed to G-RNTI of the MBS session.

MR is used for multicast session data reception.

FIG. 9 illustrates a flowchart of a method 900 for monitoring PO and receiving a paging message according to embodiments of the present disclosure. The method 900 as may be performed by a UE (e.g., 111-116 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, in step 902, the UE is in an RRC_IDLE or an RRC_INACTIVE state and is interested in receiving multicast session data. In step 904, the UE determines whether the criteria to monitor LP WUS is met. If yes in step 904, the UE monitors LP WUS in step 906. In step 906, information about TMGI(s) for which MBS group notification is receive is included in LP WUS. The UE does not need to monitor PO and receive paging message for this. If no in step 904, the UE in step 908 monitors PO and receives a paging message. In this step, TMGI(s) for which MBS group notification is received is included in the paging message.

The advantage of this approach is that a UE does not need to monitor PO at all for MBS as long as the UE monitors LP WUS. Note that in existing system the UE monitors PO for MBS, thereby increasing power consumption of the UE supporting and interested in receiving multicast sessions.

A UE is in an RRC_CONNECTED state and receiving data of MBS multicast session. If there is temporarily no data to be sent to the UEs for the multicast session that is active, the gNB may move the UE to an RRC_INACTIVE state by sending an RRCRelease message with a suspend configuration. If MBS multicast session is deactivated, the gNB may move the UE to an RRC_IDLE by sending the RRCRelease message without the suspend configuration or the RRC_INACTIVE state by sending the RRCRelease message with the suspend configuration.

While the UE is in an RRC_IDLE or an RRC_INACTIVE state, if an MBS session is already activated and the gNB has multicast session data to deliver, the gNB transmits LP WUS indicating paging/wakeup indication or indicating paging/wakeup indication for MBS paging subgroup/MBS WUS subgroup. MBS paging subgroup/MBS WUS subgroup identity can be pre-defined or signaling by the gNB.

LP WUS can be transmitted on same DL carrier/frequency as the carrier/frequency on which PDCCH/PDSCH are transmitted. LP WUS can be transmitted on different DL carrier/frequency than the carrier/frequency on which PDCCH/PDSCH are transmitted. The DL carrier/frequency for LP WUS can be signaled by the gNB in SI (e.g., SIB1 or MIB or another SIB). The DL BWP for transmitting LP WUS can be initial DL BWP or it can be a different BWP signaling by the gNB in SI (e.g., SIB1 or MIB or another SIB).

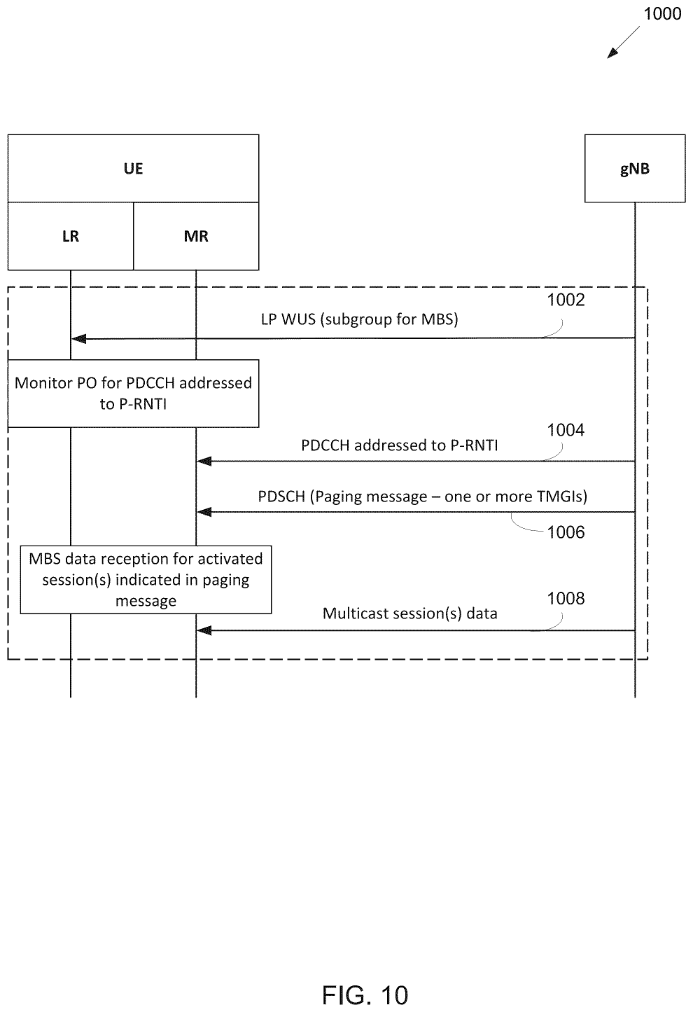

FIG. 10 illustrates an example of a signaling flow 1000 between a UE and a gNB according to embodiments of the present disclosure. As illustrated in FIG. 10, the UE includes an LR and an MR. The LR and the MR may be included in a transceiver. The signaling flow 1000 as may be performed by a UE (e.g., 111-116 as illustrated in FIG. 1) and a base station (e.g., 101-103 as illustrated in FIG. 1). An embodiment of the signaling flow 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10 the gNB in step 1002 sends the LP WUS (e.g., subgroup for MBS) which is received by the UE via the LR. In step 1004, the gNB sends the PDCCH addressed to P-RNTI which is received by the UE via the MR. In step 1006, the gNB sends the PDSCH (e.g., paging message) which is received by the UE via the MR. In step 1008, the gNB sends multicast session data which is received by the UE via the MR.

A UE is in an RRC_IDLE or an RRC_INACTIVE state. The UE is interested in MBS group notification.

A UE may monitor LP WUS, if the UE supports LP WUS and/or is camped in a cell supporting LP WUS and/or cell quality or RSRP of DL path loss reference is below a configured threshold and/or a gNB has indicated to monitor LP WUS for UE's paging subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

LP WUS can be monitored on same DL carrier/frequency as the carrier/frequency on which PDCCH/PDSCH are received. LP WUS can be received on different DL carrier/frequency than the carrier/frequency on which PDCCH/PDSCH are received. The DL carrier/frequency for LP WUS can be signaled by the gNB in SI (e.g., SIB1 or MIB or another SIB). The DL BWP for receiving LP WUS can be initial DL BWP or it can be a different BWP signalled by the gNB in SI (e.g., SIB1 or MIB or another SIB).

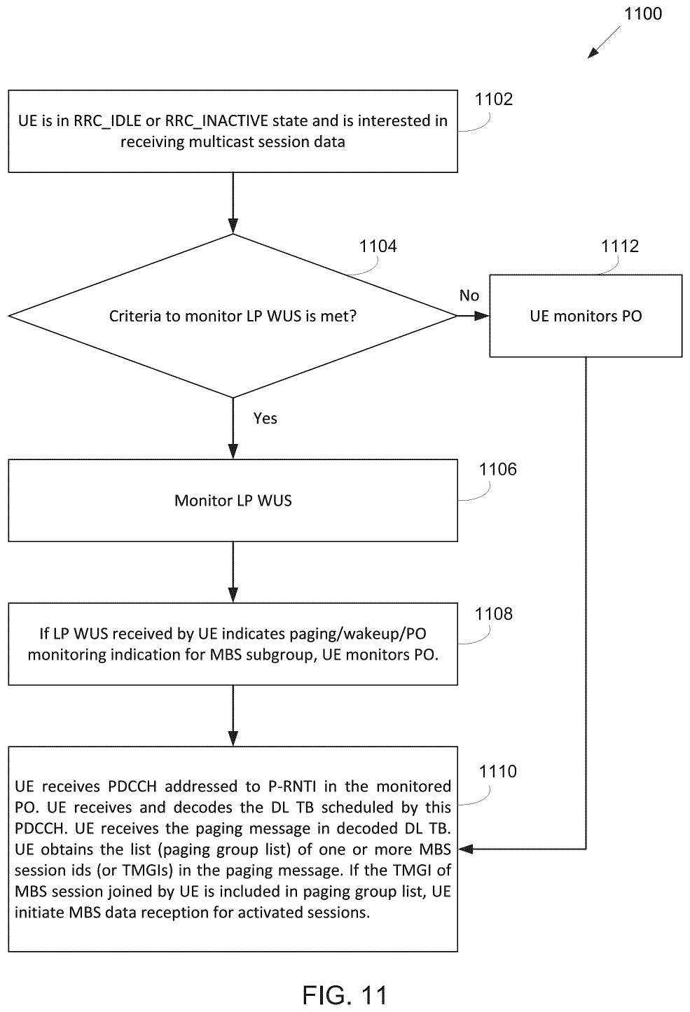

If the UE monitor LP WUS and If LP WUS received by the UE indicates paging/wakeup/PO monitoring indication for MBS subgroup, or if the UE does not or cannot monitor LP WUS (FIG. 10 and FIG. 11).

The UE receives PDCCH addressed to P-RNTI in the monitored PO. UE receives and decodes the DL TB scheduled by this PDCCH. The UE receives the paging message in decoded DL TB. The UE obtains the list (paging group list) of one or more MBS session ids (or TMGIs) in the paging message. If the TMGI of an MBS session joined by the UE is included in paging group list: (1) if in the UE is in an RRC_IDLE, RRC in the UE may forward the TMGI to upper layer i.e., NAS which may then initiate the RRC connection setup to enter an RRC_CONNECTED for receiving the multicast session data; (2) if in the UE is in an RRC_INACTIVE and multicast session data reception is not supported in the RRC_INACTIVE, RRC in the UE may forward the TMGI to upper layer and may also initiate RRC connection resume procedure to enter the RRC_CONNECTED for receiving the multicast session data; (3) if the UE is in the RRC_INACTIVE and multicast session data reception is supported in the RRC_INACTIVE and for the TMGI there is indication in the paging message to resume data reception, the UE starts receiving the multicast session data in the RRC_INACTIVE, starts monitoring PDCCH addressed to G-RNTI of the MBS session; and (4) MR is used for multicast session data reception.

FIG. 11 illustrates a flowchart of a method 1100 for monitoring PO according to embodiments of the present disclosure. The method 1100 as may be performed by a UE (e.g., 111-116 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

In one embodiment, the conditions for PO monitoring by a UE for MBS are shown in FIG. 11. The UE is in an RRC_IDLE or an RRC_INACTIVE state and is interested in receiving multicast session data. If criteria to monitor LP WUS is met, the UE monitor LP WUS. If LP WUS received by the UE indicates paging/wakeup/PO monitoring indication for MBS subgroup, the UE monitors PO. If criteria to monitor LP WUS is not met, the UE monitors PO. The UE receives PDCCH addressed to P-RNTI in the monitored PO. The UE receives and decodes the DL TB scheduled by this PDCCH. The UE receives the paging message in decoded DL TB. The UE obtains the list (paging group list) of one or more MBS session ids (or TMGIs) in the paging message. If the TMGI of an MBS session joined by the UE is included in paging group list, the UE initiates MBS data reception for activated sessions.

As illustrated in FIG. 11, the UE is in an RRC_IDLE or an RRC_INACTIVE state and is interested in receiving multicast session data. In step 1104, the UE determines whether the criteria to monitor LP WUS is met. If yes, the UE in step 1106 monitors the LP WUS. In step 1108, if the LP WUS received by the UE indicates a paging/wakeup/PO monitoring indication for MBS subgroup, the UE monitors PO. In step 1110, the UE receives PDCCH addressed to P-RNTI in the monitored PO. The UE receives and decodes the DL TB scheduled by this PDCCH. The UE receives the paging message in decoded DL TB. The UE obtains the list (paging group list) of one or more MBS session ids (or TMGIs) in the paging message. If the TMGI of MBS session joined by the UE is included in the paging group list, the UE initiate MBS data reception for activated sessions.

A UE is in an RRC_CONNECTED state and receiving data of MBS multicast session. If there is temporarily no data to be sent to the UEs for the multicast session that is active, the gNB may move the UE to an RRC_INACTIVE state by sending an RRCRelease message with a suspend configuration. If MBS multicast session is deactivated, the gNB may move the UE to an RRC_IDLE state by sending the RRCRelease message without the suspend configuration or the RRC_INACTIVE state by sending the RRCRelease message with the suspend configuration.

While the UE is in an RRC_IDLE or an RRC_INACTIVE state, if MBS multicast session is already activated and the gNB has multicast session data to deliver, the gNB transmits LP WUS.

In one example of LP WUS design 1, a reception of LP WUS indicates the UE to wake up and monitor paging e.g., monitor PEI/PO and absence of LP WUS indicates the UE does not monitor paging i.e., not monitor PEI/PO.

In this design, if the UE expects MBS group notification in an RRC_IDLE/RRC_INACTIVE state, upon reception of LP WUS, the UE monitors PO. If the UE does expect MBS group notification in an RRC_IDLE/RRC_INACTIVE state, upon reception of LP WUS, the UE monitors PEI (the UE monitors PEI if camped cell and the UE supports PEI and criteria (If a PEI configuration is provided in system information and If lastUsedCellOnly is configured in system information of a cell, the UE monitors PEI in this cell if the UE most recently received RRCRelease without noLastCellUpdate in this cell. Otherwise i.e., if lastUsedCellOnly is not configured in system information of a cell, the UE monitors PEI in the camped cell) to monitor PEI is met) and then PO (if indicated by monitored PEI).

In this design, if MBS multicast session is already activated and the gNB has multicast session data to deliver, the gNB transmits LP WUS.

In one example of LP WUS design 2, LP WUS includes information indicating the UE to wake up and monitor paging i.e., monitor PEI/PO. In this case, the UE does not monitor PEI/PO when information in LP WUS does not indicate the UE to wake up and monitor paging i.e., monitor PEI/PO. Information indicating the UE to wake up may be 1 bit information (the bit may be set to 1 or 0 to indicate the UE to wake up or not wake up respectively or vice versa).

In this design, if the UE expects MBS group notification in an RRC_IDLE/RRC_INACTIVE state, upon reception of LP WUS with indication to wake up and monitor paging is set to 1, the UE monitors PO. If the UE does expect MBS group notification in an RRC_IDLE/RRC_INACTIVE state, upon reception of LP WUS, the UE monitors PEI (the UE monitors PEI if camped cell and the UE supports PEI and criteria (If a PEI configuration is provided in system information and If lastUsedCellOnly is configured in system information of a cell, the UE monitors PEI in this cell if the UE most recently received RRCRelease without noLastCellUpdate in this cell. Otherwise i.e., if lastUsedCellOnly is not configured in system information of a cell, the UE monitors PEI in the camped cell) to monitor PEI is met) and then PO (if indicated by monitored PEI).

In this design, if MBS multicast session is already activated and the gNB has multicast session data to deliver, the gNB transmits LP WUS with indication to wake up and monitor paging is set to 1.

In one example of LP WUS design 3, LP WUS includes information indicating one or more paging subgroup(s) to wake up and monitor paging i.e., PO. Here paging subgroups is same as paging subgroups of PEI. In this case, the UE does not monitor PO when information in LP WUS does not indicate to wake up and monitor paging i.e., monitor PO for UE's paging subgroup. Information indicating the UE to wake up may be 1 bit information per paging subgroup (the bit may be set to 1 or 0 to indicate UE's belonging to the paging subgroup to wake up or not wake up respectively or vice versa). Information indicating the UE to wake up may be inclusion of UE's paging subgroup id in the LP WUS payload.

In this design, upon reception of LP WUS with indication to wake up and monitor paging is set to 1 for UE's paging subgroup, the UE monitors PO.

In this design, if MBS multicast session is already activated and the gNB has multicast session data to deliver, the gNB transmits LP WUS with indication to wake up and monitor paging is set to 1 for each paging subgroups.

In one example of LP WUS design 4, LP WUS includes information indicating WUS subgroup(s) to wake up and monitor paging i.e., monitor PEI/PO (PEI in case cell and the UE supports PEI, PO in case camped cell and/or the UE does not support PEI). WUS subgroups can be different from paging subgroups. In this case, the UE does not monitor PEI/PO when information in LP WUS does not indicate UE's WUS subgroup(s) to wake up and monitor paging i.e., monitor PEI/PO. Information indicating the UE to wake up may be 1 bit information per paging subgroup (the bit may be set to 1 or 0 to indicate UE's belonging to the WUS subgroup to wake up or not wake up respectively or vice versa). Information indicating the UE to wake up may be inclusion of UE's WUS subgroup id in the LP WUS payload.

In this design, if the UE expects MBS group notification in an RRC_IDLE/RRC_INACTIVE state, upon reception of LP WUS with indication to wake up and monitor paging is set to 1 for UE's WUS subgroup, the UE monitors PO. If the UE does expect MBS group notification in an RRC_IDLE/RRC_INACTIVE state, upon reception of LP WUS with indication to wake up and monitor paging is set to 1 for UE's WUS subgroup, the UE monitors PEI (if a UE/cell supports PEI) and then PO (if indicated by monitored PEI).

In this design, if MBS multicast session is already activated and the gNB has multicast session data to deliver, the gNB transmits LP WUS with indication to wake up and monitor paging is set to 1 for each WUS subgroups.

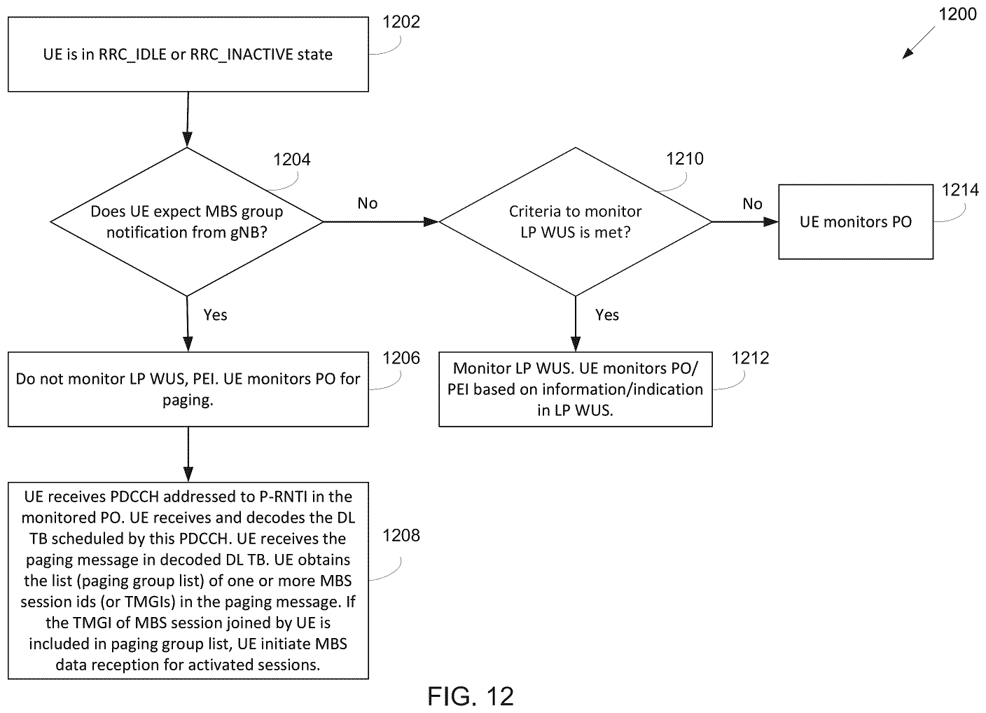

FIG. 12 illustrates a flowchart of a method 1200 for monitoring PO according to embodiments of the present disclosure. The method 2100 as may be performed by a UE (e.g., 111-116 as illustrated in FIG. 1). An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, in step 1202, the UE is in an RRC_IDLE or an RRC_INACTIVE state. In step 1204, the UE determines whether the UE expects MBS group notification from the gNB. If yes, the UE in step 1206 does not monitor LP WUS and monitors PO for the paging. In step 1208, the UE receives the PDCCH addressed to P-RNTI in the monitored PO. The UE receives and decodes the DL TB scheduled by this PDCCH. The UE receives the paging message in decoded DL TB. The UE obtains the list (paging group list) of one or more MBS session ids (or TMGIs) in the paging message. If the TMGI of MBS session joined by the UE is included in the paging group list, the UE initiate MBS data reception for activated sessions. In step 1204, if no, the UE in step 1210 determines the criteria to monitor LP WUS is met. If yes, the UE in step 1212 monitors LP WUS. The UE monitors PO/PEI based on information/indication in the LP WUS. If no in step 1210, the UE monitors PO in step 1214.

If the UE expects MBS group notification from the gNB (the UE expects MBS group notification if camped cell supports MBS and the UE has joined one or more MBS multicast sessions): (1) the UE does not monitor LP WUS, PEI; and (2) the UE monitors PO for paging.

If the UE does not expect MBS group notification from the gNB: (1) if criteria to monitor LP WUS is met (the UE may monitor LP WUS, if the UE supports LP WUS and/or is camped in a cell supporting LP WUS and/or cell quality or RSRP of DL path loss reference is below a configured threshold and/or the gNB has indicated to monitor LP WUS for UE's paging subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.”): (2) the UE monitors LP WUS. LR is used to receive LP WUS. LP WUS can be monitored on same DL carrier/frequency as the carrier/frequency on which PDCCH/PDSCH are received. LP WUS can be received on different DL carrier/frequency than the carrier/frequency on which PDCCH/PDSCH are received. The DL carrier/frequency for LP WUS can be signaled by the gNB in SI (e.g., SIB1 or MIB or another SIB). The DL BWP for receiving LP WUS can be initial DL BWP or it can be a different BWP signaling by the gNB in SI (e.g., SIB1 or MIB or another SIB); (3) the UE monitors PO/PEI based on information/indication in LP WUS.

In such examples: (1) if LP WUS indicates paging/wakeup/PO monitoring indication for UE's paging subgroup: the UE monitors its PO for PDCCH addressed to P-RNTI. MR is used to monitor PO/PEI and receive PDCCH/PDSCH; and (2) if LP WUS indicates paging/wakeup/PEI monitoring indication (i.e., there is no subgroup specific indication in LP WUS): (i) the UE monitors PEI if camped cell and the UE supports PEI. If bit corresponding to UE's paging subgroup is set to 1 in PEI, the UE monitors PO for PDCCH addressed to P-RNTI; (ii) if camped cell and/or the UE does not support PEI, the UE monitors its PO for PDCCH addressed to P-RNTI; and (iii) MR is used to monitor PO/PEI and receive PDCCH/PDSCH.

If LP WUS indicates paging/wakeup/PEI monitoring indication for UE's WUS subgroup: (1) the UE monitors PEI if camped cell and the UE supports PEI. The UE then monitors PO if PEI indicates paging for UE's paging subgroup. If bit corresponding to UE's paging subgroup is set to 1 in PEI, the UE monitors PO for PDCCH addressed to P-RNTI; (2) if camped cell and/or the UE does not support PEI, the UE monitors its PO for PDCCH addressed to P-RNTI; and (3) MR is used to monitor PO/PEI and receive PDCCH/PDSCH. Else (If criteria to monitor LP WUS is not met), the UE monitors PO.

In one embodiment, if a UE is in an RRC_INACTIVE state and small data transmission procedure is ongoing, the UE may not monitor LP WUS. If small data transmission procedure is not ongoing, the UE may monitor LP WUS, if criteria to monitor LP WUS is met (the UE may monitor LP WUS, if the UE supports LP WUS and/or is camped in a cell supporting LP WUS and/or cell quality or RSRP of DL path loss reference is below a configured threshold and/or a gNB has indicated to monitor LP WUS for UE's paging subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.”).

In one embodiment, LP WUS monitoring is restricted to cell in which a UE has last received RRCRelease message: (1) if a UE/cell supports LP WUS and if the UE is in coverage of LP WUS (i.e., cell quality is less than a configured threshold or RSRP of downlink path loss reference is less than a configured threshold) and if the UE is in same cell in which the UE has last received RRCRelease message, the UE monitors LP-WUS; else the UE does not monitor LP-WUS.

If a UE/cell supports LP WUS and if a UE is in coverage of LP WUS (i.e., cell quality is less than a configured threshold or RSRP of downlink path loss reference is less than a configured threshold) and if lastUsedCellOnlyWUS is configured in system information of a cell and if the UE is in same cell in which the UE has last received RRCRelease message: (1) the UE monitors LP-WUS, else the UE does not monitor LP-WUS.

In one embodiment, if a UE/cell supports LP WUS and if a UE is in coverage of LP WUS (i.e., cell quality is less than a configured threshold or RSRP of downlink path loss reference is less than a configured threshold) and if lastUsedCellOnlyWUS (or lastUsedCellOnly) is configured in system information of a cell and the UE most recently received RRCRelease without noLastCellUpdateWUS (or noLastCellUpdate) in this cell; or if a UE/cell supports LP WUS and if the UE is in coverage of LP WUS (i.e., cell quality is less than a configured threshold or RSRP of downlink path loss reference is less than a configured threshold) and if lastUsedCellOnlyWUS (or lastUsedCellOnly) is not configured in system information of a cell; or the UE monitors LP-WUS, else the UE does not monitor LP-WUS.

Note that condition “if a UE is in coverage of LP WUS” can be skipped if LP WUS has same coverage as PDCCH. Or threshold for LP WUS coverage can be optionally signaled, the UE checks this condition if threshold is configured.

In one embodiment, whether a UE is allowed to monitor LP WUS is signaled in an RRCRelease message. The RRCRelease message is sent by a gNB to a UE.

In one embodiment, a gNB can group UEs into various groups. The groups which are allowed to monitor LP-WUS can be signaled in system information. The UE can monitor LP WUS if monitoring is allowed for group to which the UE belongs.

In one embodiment, a gNB can indicate per paging subgroup whether to monitor LP WUS or not. A UE can monitor LP WUS if monitoring is allowed for paging subgroup to which the UE belongs.

Paging in fifth generation wireless communication system: In the 5th generation (also referred as NR or New Radio) wireless communication system, a UE can be in one of the following RRC state: RRC IDLE, RRC INACTIVE and RRC CONNECTED. Paging allows the network to reach UEs in an RRC_IDLE and in an RRC_INACTIVE state through paging messages, and to notify UEs in an RRC_IDLE, an RRC_INACTIVE, and an RRC_CONNECTED state of system information change and ETWS/CMAS indications through Short Messages. Both paging messages and Short Messages are addressed with P-RNTI on PDCCH, but while the former is sent on PCCH logical channel (TB carrying paging message is transmitted over PDSCH (Physical downlink shared channel)), the latter is sent over PDCCH directly.

The UE may use discontinuous reception (DRX) in an RRC_IDLE and an RRC_INACTIVE state in order to reduce power consumption. The UE monitors one PO per DRX cycle. A PO is a set of PDCCH monitoring occasions and can consist of multiple time slots (e.g., subframe or OFDM symbol) where paging DCI can be sent. One paging frame (PF) is one radio frame and may contain one or multiple PO(s) or starting point of a PO.

The PF and PO for paging are determined by the following formulae: (1) SFN for the PF is determined by: (SFN+PF_offset)mod T=(T div N)*(UE_ID mod N); (2) Index (i_s), indicating the index of the PO is determined by: i_s=floor (UE_ID/N)mod Ns.

The following parameters are used for the calculation of PF and i_s above: (1) T: DRX cycle of the UE; (2) N: number of total paging frames in T; (3) Ns: number of paging occasions for a PF; (4) PF_offset: offset used for PF determination; (5) UE_ID; and (6) if the UE operates in eDRX: 5G-S-TMSI mod 4096, else: 5G-S-TMSI mod 1024.

In order to reduce UE power consumption due to false paging alarms, the group of UEs monitoring the same PO can be further divided into multiple subgroups. With subgrouping, a UE may monitor PDCCH in its PO for paging if the subgroup to which the UE belongs is paged as indicated via associated PEI. If a UE cannot find its subgroup ID with the PEI configurations in a cell or if the UE is unable to monitor the associated PEI occasion corresponding to its PO, it may monitor the paging in its PO.

Paging with CN assigned subgrouping is used in the cell which supports CN assigned subgrouping. A UE supporting CN assigned subgrouping in an RRC_IDLE or an RRC_INACTIVE state can be assigned a subgroup ID (between 0 to 7) by AMF through NAS signalling.

If the UE is not configured with a CN assigned subgroup ID, or if the UE configured with a CN assigned subgroup ID is in a cell supporting only UE_ID based subgrouping, the subgroup ID of the UE is determined by the formula below: dubgroupID=(floor (UE_ID/(N*N_{S})) mod subgroupsNumForUEID)+(subgroupsNumPerPO−subgroupsNumForUEID), where: (1) N: number of total paging frames in T, which is the DRX cycle of an RRC_IDLE state; (2) Ns: number of paging occasions for a PF; (3) UE_ID: 5G-S-TMSI mod X, where X is 32768, if eDRX is applied; otherwise, X is 8192; and (4) subgroupsNumForUEID: number of subgroups for UE_ID based subgrouping in a PO, which is broadcasted in system information.

The UE monitors one PEI occasion per DRX cycle. A PEI occasion (PEI-O) is a set of PDCCH monitoring occasions (MOs) and can consist of multiple time slots (e.g., subframes or OFDM symbols) where PEI can be sent. In multi-beam operations, the UE assumes that the same PEI is repeated in all transmitted beams and thus the selection of the beam(s) for the reception of the PEI is up to UE implementation.

The time location of PEI-O for UE's PO is determined by a reference point and an offset: (1) the reference point is the start of a reference frame determined by a frame-level offset from the start of the first PF of the PF(s) associated with the PEI-O, provided by pei-Frame Offset in SIB1; The first PF of the PFs associated with the PEI-O is provided by (SFN for PF)−floor (i_{PO}/N_{S})*T/N; where i_{PO}=((UE_IDmodN)·N_{S}+i_s)mod N_{PO}^{PEI} is a paging occasion index, N_{PO}^{PEI}, is signaled by po-NumPerPEI; (2) the offset is a symbol-level offset from the reference point to the start of the first PDCCH MO of this PEI-O, provided by firstPDCCH-MonitoringOccasionOfPEI-O in SIB1.

Currently, UEs need to periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the MR and a separate LR which has the ability to monitor wake-up signal with ultra-low power consumption. Main radio works for data transmission and reception, which can be turned off or set to deep sleep unless it is turned on.

A low power wakeup receiver and wakeup signal design is being studied to minimize UE power consumption. The LR is expected to consume 1/100 of power consumed by MR. It is expected that UE in an RRC_IDLE or an RRC_INACTIVE monitor LP WUS using the LR if the UE and camped cell supports LP WUS. A gNB transmits low power wakeup signal when it needs to send RAN paging or CN paging to the UE or SI/emergency notifications to the UE. If the LP WUS is received, the UE monitors PEI (using MR) and/or subsequently the UE monitors PO (using MR) and receives a paging message (if scheduled by monitored PO) if PEI indicates paging for the UE/UE specific paging subgroup.

The consequence of monitoring PEI/PO upon reception of LP WUS is that many a times a UE may unnecessary wakeup its MR to monitor PEI/PO as there can be common LP WUS occasion for several PFs/PO. If there is paging for any UE in any of PFs and POs corresponding to a LP WUS occasion, LP WUS is sent and all UEs monitoring it unnecessarily wakeup MR and monitor PEI/PO. FIG. 6 is an example of LP WUS based paging monitoring wherein there is one LP WUS occasion for every 5 PFs or 20 POs. In this case when paging is there for a UE belonging to one of the 20 POs, all UEs monitoring these 20 POs wakes up MR and monitor PEI/PO. FIG. 6 is another example of LP WUS based paging monitoring wherein there is one LP WUS occasion for every PF or 4 POs. In this case when paging is there for a UE belonging to one of the 4 POs, all UEs monitoring these 4 POs wakes up MR and monitor PEI/PO. Enhancement is needed to reduce unnecessary wakeup of MR.

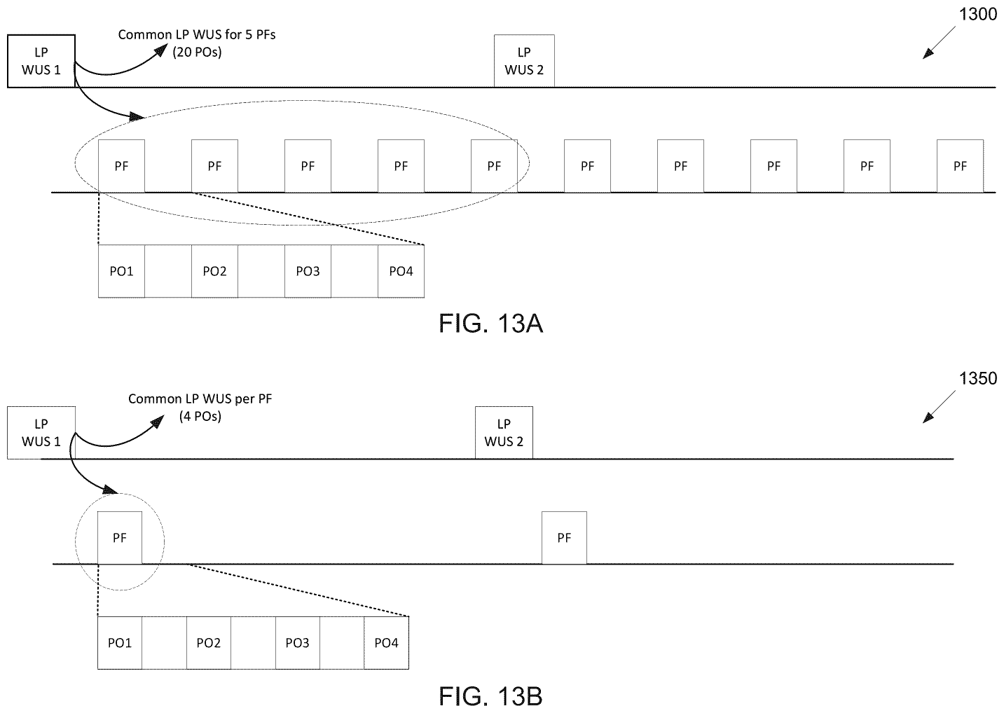

FIGS. 13A and 13B illustrate examples of LP WUS based paging monitoring 1300 and 1350 according to embodiments of the present disclosure. An embodiment of the LP WUS based paging monitoring 1300 shown in FIGS. 13A and 13B are for illustration only.

In one embodiment, handling false alarms are provided including: (1) LPWUS subgrouping mechanisms; (2) LPWUS subgroup specific indication per PO of PEI in LP WUS payload, to monitor PEI; (3) LPWUS subgroup specific indication per PO of PEI in LP WUS payload, to monitor PO; (4) LPWUS subgroup specific indication in LP WUS payload, to monitor PEI; (5) indication per PO of PEI in LP WUS payload, to monitor PEI; (6) LP WUS occasion mapping to LPWUS subgroup; (7) LP WUS occasion mapping to POs of PEI; (8) LP WUS occasion mapping to LPWUS subgroup+Indication per PO in LP WUS payload, to monitor PEI; (9) LP WUS occasion mapping to POs of PEI+LPWUS subgroup specific indication in LP WUS payload, to monitor PEI; (10) indication per PO for a set of POs in LP WUS payload, for POs occurring in LPWUS-O interval; (11) indication per PF for a set of PFs in LP WUS payload, for PFs occurring in LPWUS-O interval; (12) criteria to monitor LP WUS based on UE type and BWP; and (13) handling overlapping between SI reception and LP WUS occasion.

According to an embodiment of this disclosure, UEs can be categorized into LP WUS subgroups each identified by an LP WUS subgroup ID. The total number (Y) of LP WUS subgroups can be configurable. The configuration can be signaled in system information (e.g., SIB or SI message) or in an RRC message (e.g., RRC release message or RRCReconfiguration message). UE's LP WUS subgroup ID is determined (by a UE and a gNB) as shown in TABLE 1.

```
TABLE 1
LP WUS subgroup ID = paging subgroup ID mod Y; or
LP WUS subgroup ID = floor (paging subgroup ID/Y); or
LP WUS subgroup ID = (floor (UE_ID/(N*Ns)) mod LPWUSsubgroupsNumForUEID) + (Y−
  LPWUSsubgroupsNumForUEID), where LPWUSsubgroupsNumForUEID is the number of
  LPWUS subgroups for UE_ID based LP WUS subgrouping; or
LP WUS subgroup ID = floor (UE_ID/(N*Ns)) mod LPWUSsubgroupsNumForUEID, where
  LPWUSsubgroupsNumForUEID is the number of LPWUS subgroups for UE_ID based LP
  WUS subgrouping; or
LP WUS subgroup ID = paging subgroup ID; or
LP WUS subgroup ID = floor(UE_ID/(N*Ns)) mod Y; or
LP WUS subgroup ID = floor (UE_ID/A) mod Y, where A is the number of LPWUS occasions
  (per LPWUS period/cycle); or
LP WUS subgroup ID = floor (UE_ID/(A*B)) mod Y, where A is the number of LPWUS frames
  (per LPWUS period/cycle) and B is the number of LP WUS occasions per LP WUS frames;
  or
LP WUS subgroup ID = UE_ID mod Y
where paging subgroup ID can be assigned by AMF through NAS signalling; or it can be
determined using formula;
```

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state |
| | Ns: number of paging occasions for a PF |
| | UE_ID: 5G-S-TMSI mod X, where X is 32768, if eDRX (extended DRX) is applied; |
| | otherwise, X is 8192 |

```
  subgroupsNumForUEID: number of paging subgroups for UE_ID based subgrouping in a
    PO, which is signalled in system information
```

subgroupsNumPerPO: number of paging subgroups per PO, which is signalled in
system information

In one embodiment, “Y*number of POs per PEI” bits are carried in LP WUS payload. Number of POs per PEI (or po-NumPerPEI) is signaled by a gNB in system information. Each bit is uniquely mapped to LP WUS subgroup ID and PO (PO amongst the POs associated with PEI occasion corresponding to the LP WUS occasion). Upon reception of LP WUS payload in LP WUS occasion, a UE checks if the bit corresponding to its LP WUS subgroup ID and its PO (PO amongst the POs associated with PEI occasion corresponding to the LP WUS occasion) is set to 1. If set to 1, the UE monitors the PEI in PEI occasion. POs associated with PEI occasion can be indexed from zero to number of POs per PEI, the index of UE's PO amongst these POs can be given by i_{PO}=((UE_IDmodN)·N_{S}+i_s)mod N_{PO}^{PEI}) is set to 1. N_{PO}^{PEI} is the number of POs per PEI.

In one embodiment, a paging/PEI monitoring/wakeup indication field of LP WUS payload includes N_{PO}^{PEI} (Number of POs per PEI or po-NumPerPEI, signalled in system information) segments of K bits, where K=N_{SG}^{PO} (i.e., number of LP WUS subgroups or Y, signaled in system information). For a LPWUS subgroup index i_{SG}, 0≤i_{SG}<K, a UE determines a value for the (i_{PO}·K+i_{SG}) bit in the paging/PEI monitoring/wakeup indication field of LP WUS payload, where i_{PO}=((UE_IDmodN)·N_{S}+i_s)mod N_{PO}^{PEI} is a paging occasion index, and UE_ID, N, N_{S}, i_{SG}, and i_s are as defined earlier. When the value is “1,” the UE monitors paging or PEI-O using MR; otherwise, the UE is not required to monitor paging or PEI-O.

In one embodiment, “Y*number of POs per PEI* number of PEI-O per LP WUS occasion” bits are carried in LP WUS payload. Number of POs per PEI (or po-NumPerPEI) is signaled by a gNB in system information. Each bit is uniquely mapped to PEI-O, LP WUS subgroup ID and PO (PO amongst the POs associated with PEI occasion corresponding to the LP WUS occasion). Upon reception of LP WUS payload in LP WUS occasion, a UE checks if the bit corresponding to its PEI-O, LP WUS subgroup ID and its PO (PO amongst the POs associated with PEI occasion corresponding to the LP WUS occasion) is set to 1. If set to 1, the UE monitors the PEI in its PEI occasion. POs associated with PEI occasion can be indexed from zero to number of POs per PEI, the index of UE's PO amongst these POs can be given by i_{PO}=((UE_IDmodN)·N_{S}+i_s)mod N_{PO}^{PEI}) is set to 1. N_{PO}^{PEI} is the number of POs per PEI.

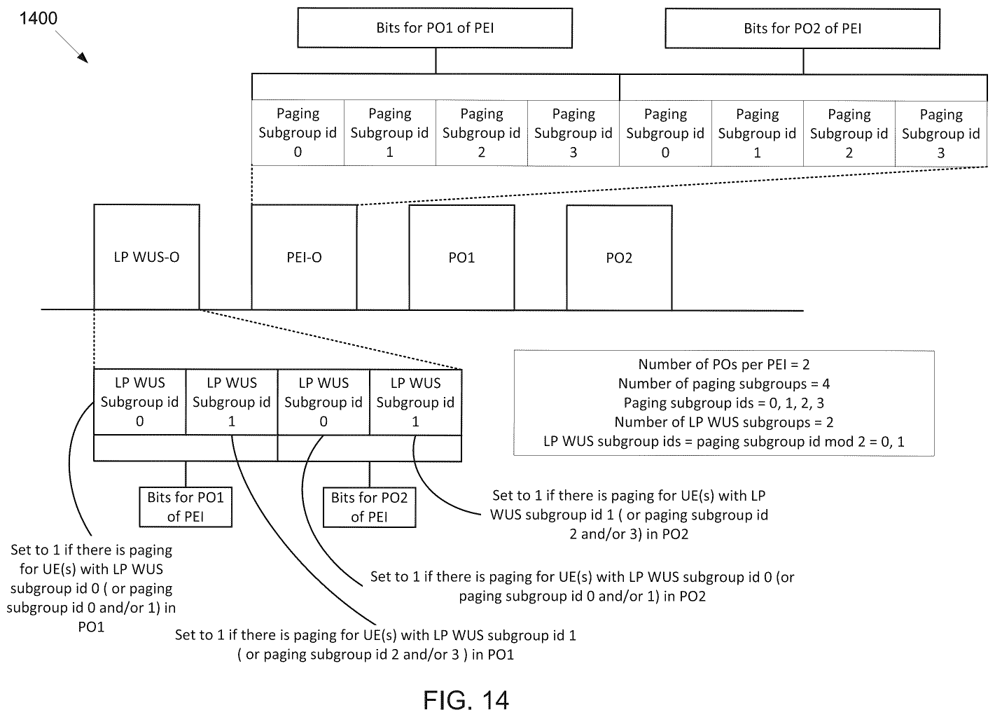

FIG. 14 illustrates an example of LP WUS subgroup ID determination 1400 according to embodiments of the present disclosure. An embodiment of the LP WUS subgroup ID determination 1400 shown in FIG. 14 is for illustration only.

FIG. 14 is an example illustration according to this embodiment. The number of POs per PEI is 2 (PO1 with i_{PO})=0 and PO2 with i_{PO}=1). The number of paging subgroups is 4. The paging subgroup IDs are 0, 1, 2, 3. The number (Y) of LP WUS subgroups is 2. LP WUS subgroup ID=paging subgroup ID mod 2. So, there are two LP WUS subgroup IDs, 0 and 1. There are, “Y*number of POs per PEI”=4 bits in LP WUS payload. These 4 bits are uniquely mapped to LP WUS subgroup IDs and POs (POs associated with PEI occasion corresponding to the LP WUS occasion). Each bit uniquely maps to one of [LP WUS subgroup ID 0, PO1 of PEI], [LP WUS subgroup ID 1, PO1 of PEI], [LP WUS subgroup ID 0, PO2 of PEI] and [LP WUS subgroup ID 1, PO2 of PEI], which bit is mapped to which combination of LP WUS subgroup IDs and POs can be pre-defined. In the example, bit 0 is mapped to [LP WUS subgroup ID 0, PO1 of PEI], bit 1 is mapped to [LP WUS subgroup ID 1, PO1 of PEI], bit 2 is mapped to [LP WUS subgroup ID 0, PO2 of PEI] and bit 3 is mapped to [LP WUS subgroup ID 1, PO2 of PEI]. Bit 0 is set to 1 if there is paging for UE(s) with LP WUS subgroup ID paging subgroup id 0 and/or 1 and whose PO is the PO1 associated with PEI occasion corresponding to the LP WUS occasion. Note that these UEs LP WUS subgroup ID is 0. Bit 1 is set to 1 if there is paging for UE(s) with paging subgroup id 2 and/or 3 and whose PO is the PO1 associated with PEI occasion corresponding to the LP WUS occasion.

Note that these UEs LP WUS subgroup ID is 1. Bit 2 is set to 1 if there is paging for UE(s) with paging subgroup id 0 and/or 1 and whose PO is the PO2 associated with PEI occasion corresponding to the LP WUS occasion. Note that these UEs LP WUS subgroup ID is 0. Bit 3 is set to 1 if there is paging for UE(s) with paging subgroup id 2 and/or 3 and whose PO is the PO2 associated with PEI occasion corresponding to the LP WUS occasion. Note that these UEs LP WUS subgroup ID is 1.

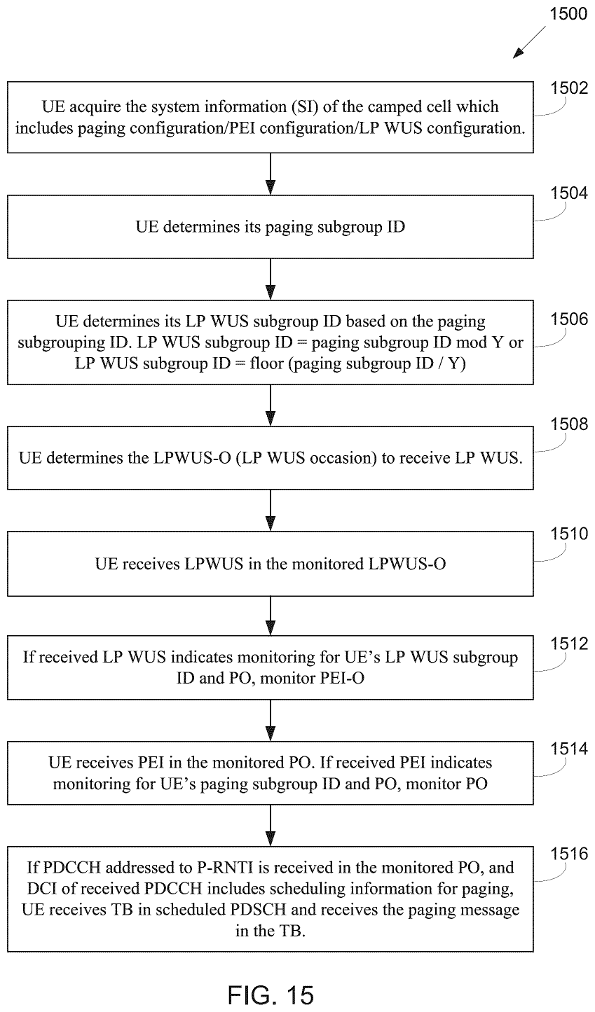

FIG. 15 illustrates a flowchart of a method 1500 for receiving a paging message according to embodiments of the present disclosure. The method 3300 as may be performed by a UE (e.g., 111-116 as illustrated in FIG. 1). An embodiment of the method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

According to an embodiment, a UE operation for monitoring LP WUS and receiving paging is illustrated in FIG. 15.

As illustrated in FIG. 15, the UE in step 1502 acquires the system information (SI) of the camped cell which includes paging configuration/PEI configuration/LP WUS configuration. In step 1504, the UE determines the paging subgroup ID. In step 1506, the UE determines the LP WUS subgroup ID based on the paging subgrouping ID. LP WUS subgroup ID=paging subgroup ID mod Y or LP WUS subgroup ID=floor (paging subgroup ID/Y). In step 1508, the UE determines the LPWUS-O (LP WUS occasion) to receive LP WUS. In step 1510, the UE receives LPWUS in the monitored LPWUS-O. In step 1512, if received LP WUS indicates monitoring for UE's LP WUS subgroup ID and PO, the UE monitors PEI-O. In step 1514, the UE receives PEI in the monitored PO. If received PEI indicates monitoring for UE's paging subgroup ID and PO, the UE monitors PO. In step 1516, if PDCCH addressed to P-RNTI is received in the monitored PO, and DCI of received PDCCH includes scheduling information for paging, the UE receives TB in scheduled PDSCH and receives the paging message in the TB.

A UE may be in an RRC_IDLE or an RRC_INACTIVE state. The UE has acquired the SI of the camped cell which includes a paging configuration/PEI configuration/LP WUS configuration. The UE may have received the CN assigned paging subgroup ID from AMF while the UE was in an RRC_CONNECTED state. The UE may receive CN paging (in the RRC_IDLE and in the RRC_INACTIVE), RAN paging (in the RRC_INACTIVE), system information update notifications, ETWS/CMAS notifications from the camped cell.

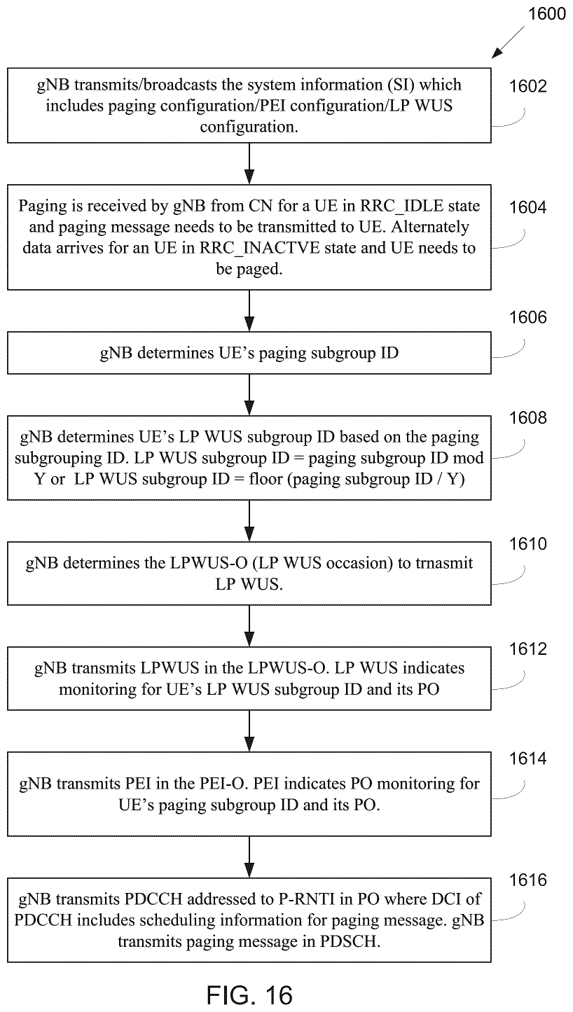

FIG. 16 illustrates a flowchart of a method 1600 for transmitting a paging message according to embodiments of the present disclosure. The method 1600 as may be performed by a BS (e.g., 101-103 as illustrated in FIG. 1). An embodiment of the method 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As illustrated in FIG. 16, the gNB in step 1602 transmits/broadcasts the SI which includes paging configuration/PEI configuration/LP WUS configuration. In step 1604, the paging is received by the gNB from a CN for a UE in an RRC_IDLE state and the paging message needs to be transmitted to the UE. Alternately data arrives for the UE in an RRC_INACTVE state and the UE needs to be paged. In step 1606, the gNB determines UE's paging subgroup ID. In step 1608, the gNB determines UE's LP WUS subgroup ID based on the paging subgrouping ID. LP WUS subgroup ID=paging subgroup ID mod Y or LP WUS subgroup ID=floor (paging subgroup ID/Y). In step 1610, the gNB determines the LPWUS-O (LP WUS occasion) to transmit LP WUS. In step 1612, the gNB transmits LPWUS in the LPWUS-O. LP WUS indicates monitoring for UE's LP WUS subgroup ID and its PO. In step 1614, the gNB transmits PEI in the PEI-O. The PEI indicates PO monitoring for UE's paging subgroup ID and its PO. In step 1616, the gNB transmits PDCCH addressed to P-RNTI in PO where DCI of PDCCH includes scheduling information for a paging message. The gNB transmits the paging message in PDSCH.

A UE determine its paging subgroup ID. If the UE has been assigned the paging subgrouping ID by CN and camped cell supports CN assigned paging subgrouping, paging subgroup ID is the CN assigned paging subgrouping ID. If the UE has not been assigned the paging subgrouping ID by CN or camped cell does not support CN assigned paging subgrouping and camped cell supports a UE ID based paging subgrouping, paging subgroup ID is determined as shown in TABLE 2.

TABLE 2

| | |
|---|---|
| ∘ | SubgroupID = (floor (UE_ID/(N*Ns)) mod subgroupsNumForUEID) + |
| | (subgroupsNumPerPO − subgroupsNumForUEID) |

```
  N: number of total paging frames in T, which is the DRX cycle of an RRC_IDLE state; N is
    broadcasted in system information
  Ns: number of paging occasions for a PF; Ns is broadcasted in system information
  UE_ID: 5G-S-TMSI mod X, where X is 32768, if eDRX is applied; otherwise, X is 8192
  subgroupsNumForUEID: number of subgroups for UE_ID based subgrouping in a PO, which
    is broadcasted in system information
  subgroupsNumPerPO: number of subgroups per PO, which is broadcasted in system
    information
A UE determines its LP WUS subgroup ID based on the paging subgrouping ID. The LP WUS
subgroup ID is determined as follows:
```

| | |
|---|---|
| - | LP WUS subgroup ID = paging subgroup ID mod Y |
| | or |
| | LP WUS subgroup ID = floor (paging subgroup ID/Y) |
| | or |
| | LP WUS subgroup ID = paging subgroup ID; |
| - | where paging subgroup ID can be assigned by AMF through NAS signalling; or it can |
| | be determined using formula; |

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE |
| | state |
| | Ns: number of paging occasions for a PF |
| | UE_ID: 5G-S-TMSI mod X, where X is 32768, if eDRX (extended DRX) is |
| | applied; otherwise, X is 8192 |
| | subgroupsNumForUEID: number of paging subgroups for UE_ID based |
| | subgrouping in a PO, which is broadcasted in system information |
| | subgroupsNumPerPO: number of paging subgroups per PO, which is |
| | broadcasted in system information |

```
In an alternate embodiment, a UE determines LP WUS subgroup ID as follows
LP WUS subgroup ID = (floor (UE_ID/(N*Ns)) mod LPWUSsubgroupsNumForUEID) +
(Y − LPWUSsubgroupsNumForUEID); or
LP WUS subgroup ID = floor (UE_ID/(N*Ns)) mod LPWUSsubgroupsNumForUEID, where
  LPWUSsubgroupsNumForUEID is the number of LPWUS subgroups for UE_ID based LP
  WUS subgrouping; or
LP WUS subgroup ID = floor (UE_ID/(N*Ns)) mod Y; or
```

LP WUS subgroup ID = floor(UE_ID/A) mod Y, where A is the number of LPWUS
occasions (per LPWUS period/cycle); or
LP WUS subgroup ID = floor(UE_ID/(A*B)) mod Y, where A is the number of LPWUS
frames (per LPWUS period/cycle) and B is the number of LP WUS occasions per LP
WUS frames; or
LP WUS subgroup ID = UE_ID mod Y; or
LP WUS subgroup ID = LP WUS subgroup ID assigned by CN (e.g. AMF). LP WUS

subgroup ID assigned by CN can be the paging subgroup ID assigned by CN. LP WUS subgroup
ID assigned by CN can be different from paging subgroup ID assigned by CN.

A UE determines the LPWUS-O (LP WUS occasion) to receive LP WUS. An LPWUS-O may be a set of “S*X” consecutive LP WUS monitoring occasions, where “S” is the number of transmitted SSBs/LP SSs, and X is the number of LP WUS monitoring occasions per SSB/LP SS. if configured or is equal to 1 otherwise. The [x*S+K]^{th} LP WUS monitoring occasion in the LPWUS-O corresponds to the K^{th} transmitted SSB/LP SS, where x=0, 1, . . . , X−1, K=1, 2, . . . , S. The LP WUS monitoring occasions are sequentially numbered from zero starting from the first LP WUS monitoring occasion in the LP WUS-O. When the UE detects a LP WUS within its LPWUS-O, the UE is not required to monitor the subsequent LP WUS monitoring occasions associated with the same LPWUS-O.

In one embodiment, an LP WUS configuration indicates LPWUS-Os (e.g., a configuration may signal period and/offset where LPWUS-O occurs periodically with the signalled period and first period may start at an offset from SFN 0, starting time (e.g., slot/symbol), starting frequency resource (e.g., PRB index), number of PRBs and number of slots/symbols of each LPWUS monitoring occasion may also be included in the configuration). In one embodiment, a UE monitors the latest LPWUS-O starting at an offset (can be pre-defined or configured in system information) before the start of UE's PEI-O or PF or PO. In one embodiment, a UE monitors the latest LPWUS-O starting at least at an offset (can be pre-defined or configured in system information) before the start of UE's PEI-O or PF or PO. In one embodiment, a UE monitors the first LPWUS-O starting after an “offset (can be pre-defined or configured in system information) before the start of UE's PEI-O or PF or PO.” In one embodiment, the time location of LP WUS occasion is determined by a reference point and an offset.

The reference point is the start of a reference frame determined by a frame-level offset from the start of the frame of PEI-O, frame-level offset is signaled in system information; PEI-O is determined as explained earlier.

The offset is a symbol-level offset from the reference point to the start of the LPWUS-O, symbol-level offset is signaled in system information. symbol-level offset can be zero if not signaled.

A UE may monitor LP WUS (using LR) in the determined LPWUS-O, if the UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

LP WUS may be monitored on same DL carrier/frequency as the carrier/frequency on which the signals (such as PDCCH/PDSCH) by MR are received. LP WUS can be received on different DL carrier/frequency than the carrier/frequency on which the signals (such as PDCCH/PDSCH) by MR are received. The DL carrier/frequency for LP WUS can be signaled by the gNB in SI (e.g., SIB1 or MIB or any another SIB). The DL BWP for receiving LP WUS can be initial DL BWP or it can be a different BWP signalled by the gNB in SI (e.g., SIB1 or MIB or another SIB).

A UE receives LPWUS in the monitored LPWUS-O. The UE checks if the received LP WUS indicates monitoring for UE's LP WUS subgroup ID and its PO (PO amongst the POs associated with PEI occasion corresponding to the LP WUS occasion, POs associated with PEI can be indexed from zero to number of POs per PEI, the index of UE's PO amongst these POs can be given by i_{PO}=((UE_IDmodN)·N_{S}+i_s)mod N_{PO}^{PEI}). If yes, the UE monitors PEI in the PEI-O (using MR). Alternately, the UE checks if the bit in the LP WUS payload corresponding to its LP WUS subgroup ID and its PO is set to 1. If yes, the UE monitors the PEI in the PEI-O.

If the UE detects PEI (i.e., it receives PDCCH addressed to P-RNTI in PEI-O) and the PEI (i.e., DCI of received PDCCH) indicates the paging subgroup the UE belongs to monitor its associated PO, the UE monitors the associated PO. If the UE does not detect PEI on the monitored PEI occasion or the PEI does not indicate the paging subgroup the UE belongs to monitor its associated PO, the UE is not required to monitor the associated PO. If PDCCH addressed to P-RNTI is received in the PO, and DCI of received PDCCH includes scheduling information for paging, the UE receives TB in scheduled PDSCH and receives the paging message in the TB.

According to an embodiment, a gNB operation for transmitting LP WUS and paging is illustrated in FIG. 16.

A gNB transmits/broadcasts the SI which includes a paging configuration/PEI configuration/LP WUS configuration.

Paging is received by a gNB from CN for a UE in an RRC_IDLE state and a paging message needs to be transmitted to a UE. Alternately data arrives for a UE in an RRC_INACTVE state and the UE needs to be paged.

A gNB determines UE's paging subgroup ID. If a UE has been assigned the paging subgrouping ID by CN and cell supports CN assigned paging subgrouping, paging subgroup ID is the CN assigned paging subgrouping ID. If the UE has not been assigned the paging subgrouping ID by CN or cell does not support CN assigned paging subgrouping and cell supports the UE ID based paging subgrouping, paging subgroup ID is determined as shown in TABLE 3.

TABLE 3

| | |
|---|---|
| ∘ | SubgroupID = (floor (UE_ID/(N*Ns)) mod subgroupsNumForUEID) + |
| | (subgroupsNumPerPO − subgroupsNumForUEID) |

```
  N: number of total paging frames in T, which is the DRX cycle of an RRC_IDLE state; N is
    broadcasted in system information
  Ns: number of paging occasions for a PF; Ns is broadcasted in system information
  UE_ID: received from AMF
  subgroupsNumForUEID: number of subgroups for UE_ID based subgrouping in a PO, which
    is broadcasted in system information
  subgroupsNumPerPO: number of subgroups per PO, which is broadcasted in system
    information
```

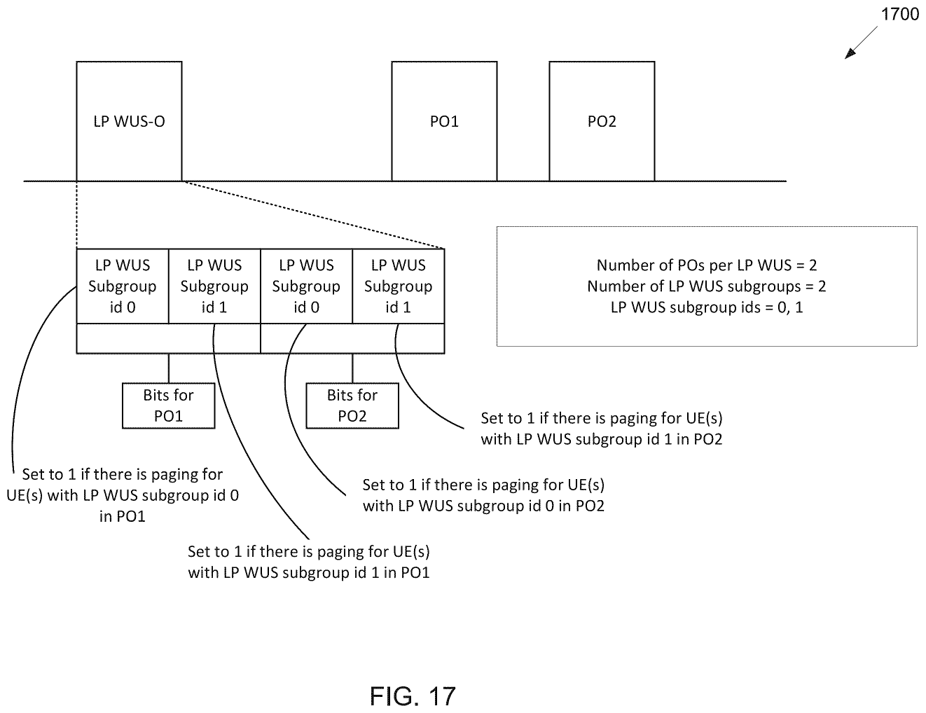

FIG. 17 illustrates an example of LP WUS subgroup ID determination 1700 according to embodiments of the present disclosure. An embodiment of the LP WUS subgroup ID determination 1700 shown in FIG. 17 is for illustration only.

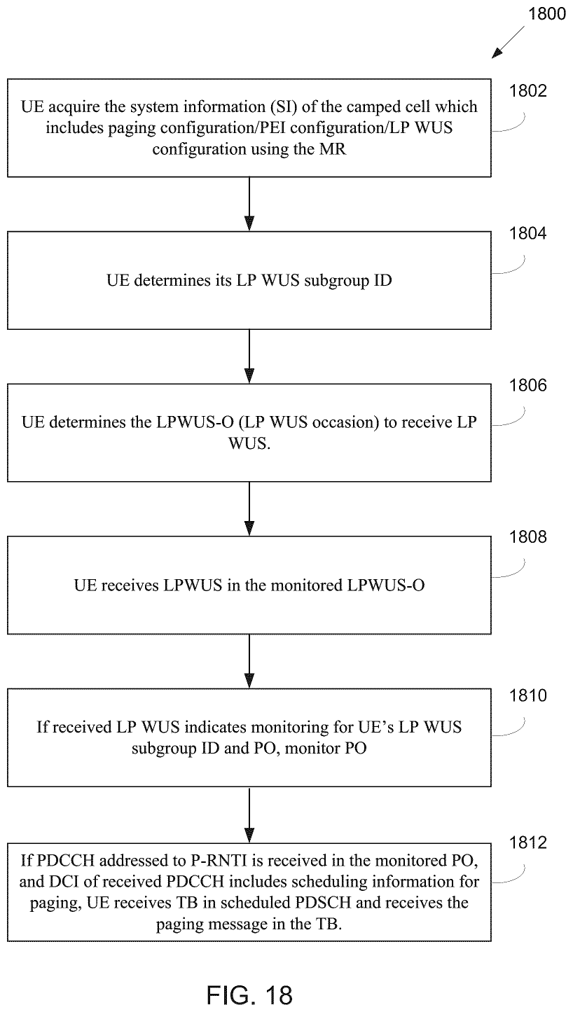

FIG. 18 illustrates a flowchart of a method 1800 for receiving a paging message according to embodiments of the present disclosure. The method 1800 as may be performed by a UE (e.g., 111-116 as illustrated in FIG. 1). An embodiment of the method 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

As illustrated in FIG. 18, the UE in step 1802 acquires the SI of the camped cell which includes paging configuration/PEI configuration/LP WUS configuration using the MR. In step 1804, the UE determines its LP WUS subgroup ID. In step 1806, the UE determines the LP-WUS-O (e.g., LP WUS occasion) to receive LP WUS. In step 1808, the UE receives LP WUS in the monitored LP WUS-O. In step 1810, if received LP WUS indicates monitoring for UE's LP WUS subgroup ID and PO, the UE monitors PO. In step 1812, if PDCCH addressed to P-RNTI is received in the monitored PO, and DCI of received PDCCH includes scheduling information for paging, the UE receives TB in scheduled PDSCH and receives the paging message in the TB.

A gNB determines UE's LP WUS subgroup ID based on the paging subgrouping ID. The LP WUS subgroup ID is determined as shown in TABLE 4.

TABLE 4

| - | LP WUS subgroup ID = paging subgroup ID mod Y | |
|---|---|---|
| | or | |
| | LP WUS subgroup ID = floor (paging subgroup ID/Y) | |
| | or | |
| | LP WUS subgroup ID = paging subgroup ID; | |
| - | where paging subgroup ID can be assigned by AMF through NAS signalling; or it can | |
| | be determined using formula; | |
| | ∘ | SubgroupID = (floor (UE_ID/(N*Ns)) mod subgroupsNumForUEID) + |
| | | (subgroupsNumPerPO − subgroupsNumForUEID) |
| | | N: number of total paging frames in T, which is the DRX cycle of an RRC_IDLE |
| | | state |
| | | Ns: number of paging occasions for a PF |
| | | UE_ID: 5G-S-TMSI mod X, where X is 32768, if eDRX (extended DRX) is |
| | | applied; otherwise, X is 8192 |
| | | subgroupsNumForUEID: number of paging subgroups for UE_ID based |
| | | subgrouping in a PO, which is broadcasted in system information |
| | | subgroupsNumPerPO: number of paging subgroups per PO, which is |
| | | broadcasted in system information |

In one alternate embodiment, a gNB determines UE's LP WUS subgroup ID as shown in TABLE 5.

```
TABLE 5
LP WUS subgroup ID = (floor (UE_ID/(N*Ns)) mod LPWUSsubgroupsNumForUEID) +
(Y − LPWUSsubgroupsNumForUEID); or
LP WUS subgroup ID = floor (UE_ID/(N*Ns)) mod LPWUSsubgroupsNumForUEID, where
  LPWUSsubgroupsNumForUEID is the number of LPWUS subgroups for UE_ID based LP
  WUS subgrouping; or LP WUS subgroup ID = floor (UE_ID/(N*Ns)) mod Y; or
    LP WUS subgroup ID = floor(UE_ID/A) mod Y, where A is the number of LPWUS
    occasions (per LPWUS period/cycle); or
    LP WUS subgroup ID = floor(UE_ID/(A*B)) mod Y, where A is the number of LPWUS
    frames (per LPWUS period/cycle) and B is the number of LP WUS occasions per LP
    WUS frames; or
    LP WUS subgroup ID = UE_ID mod Y ; or
    LP WUS subgroup ID = LP WUS subgroup ID assigned by CN (e.g. AMF). LP WUS
    subgroup ID assigned by CN can be the paging subgroup ID assigned by CN. LP WUS
    subgroup ID assigned by CN can be different from paging subgroup ID assigned by CN.
```

A gNB determines the LPWUS-O (LP WUS occasion) to transmit LP WUS.

In one embodiment, an LP WUS configuration indicates LPWUS-Os (e.g., a configuration may signal period and/offset where LPWUS-O occurs periodically with the signalled period and first period may start at an offset from SFN 0, starting time (e.g., slot/symbol), starting frequency resource (e.g., PRB index), number of PRBs and number of slots/symbols of each LPWUS monitoring occasion may also be included in the configuration). In one embodiment, LPWUS-O for transmitting LP WUS to a UE is the latest LPWUS-O starting at an offset (can be pre-defined or configured in system information) before the start of UE's PEI-O or PF or PO. In one embodiment, LPWUS-O for transmitting LP WUS to the UE the latest LPWUS-O starting at least at an offset (can be pre-defined or configured in system information) before the start of UE's PEI-O or PF or PO. In one embodiment, LPWUS-O for transmitting LP WUS to the UE is the first LPWUS-O starting after an “offset (can be pre-defined or configured in system information) before the start of UE's PEI-O or PF or PO.” In one embodiment, the time location of LP WUS occasion is determined by a reference point and an offset.

The reference point is the start of a reference frame determined by a frame-level offset from the start of the frame of UE's PEI-O, frame-level offset is signaled in system information.

The offset is a symbol-level offset from the reference point to the start of the LPWUS-O, symbol-level offset is signaled in system information. symbol-level offset can be zero if not signaled.

A gNB transmits LPWUS in the determined LPWUS-O. LP WUS indicates monitoring for UE's LP WUS subgroup ID and its PO (PO amongst the POs associated with PEI occasion corresponding to the LP WUS occasion, POs associated with PEI can be indexed from zero to number of POs per PEI, the index of UE's PO amongst these POs can be given by i_{PO}=((UE_IDmodN)·N_{S}+i_s)mod N_{PO}^{PEI}). The bit in the LP WUS payload corresponding to UE's LP WUS subgroup ID and UE's PO is set to 1.

A gNB transmits PEI (i.e., PDCCH addressed to P-RNTI) in the PEI-O corresponding to UE's PO. PEI (DCI of PDCCH addressed to P-RNTI transmitted in PEI-O) indicates PO monitoring for UE's paging subgroup ID and its PO. The bit in the PEI payload corresponding to UE's paging subgroup ID and UE's PO is set to 1.

A gNB transmits PDCCH addressed to P-RNTI in PO where DCI of PDCCH includes scheduling information for a paging message. The gNB transmits the paging message in PDSCH.

According to an embodiment of this disclosure, UEs can be categorized into LP WUS subgroups. The total number (Y) of LP WUS subgroups can be configurable. The configuration can be signaled in system information (e.g., SIB) or in an RRC message. The LP WUS subgroup ID of the UE is determined as shown in TABLE 6.

TABLE 6

| - | LP WUS subgroup ID can be assigned by AMF through NAS signalling; or it can be | |
|---|---|---|
| | determined using formula; | |
| | ∘ | LP WUS subgroup ID = (floor (UE_ID/(N*Ns)) mod |
| | | LPWUSsubgroupsNumForUEID) + (LPWUSsubgroupsNumPerPO − |
| | | LPWUSsubgroupsNumForUEID) |
| | | N: number of total paging frames in T, which is the DRX cycle of an RRC_IDLE |
| | | state |
| | | Ns: number of paging occasions for a PF |
| | | UE_ID: 5G-S-TMSI mod X, where X is 32768, if eDRX is applied; otherwise, |
| | | X is 8192 |
| | | LPWUSsubgroupsNumForUEID: number of subgroups for UE_ID based |
| | | subgrouping in a PO, which is broadcasted in system information |
| | | LPWUSsubgroupsNumPerPO (Y): number of subgroups per PO, which is |
| | | broadcasted in system information |

In one embodiment, LP WUS subgroup ID is same as paging subgrouping ID. LPWUSsubgroupsNumForUEID is same as subgroupsNumForUEID and parameter subgroupsNumForUEID is used instead of LPWUSsubgroupsNumForUEID. LPWUSsubgroupsNumPerPO is same as subgroupsNumPerPO and parameter subgroupsNumPerPO is used instead of LPWUSsubgroupsNumPerPO.

In this embodiment, “Y*number of POs per LPWUS” bits are carried in LP WUS payload. Number of POs per LP WUS (or po-NumPerLPWUS) is signaled by a gNB in system information. Each bit is uniquely mapped to LP WUS subgroup ID and PO (PO amongst the POs associated with the LP WUS occasion). Upon reception of LP WUS payload in LP WUS occasion, a UE checks if the bit corresponding to its LP WUS subgroup ID and its PO (PO amongst the POs associated with the LP WUS occasion) is set to 1. If set to 1, the UE monitors its PO. POs associated with LP WUS can be indexed from zero to number of POs per LP WUS, the index of UE's PO amongst these POs can be given by i_{PO}=((UE_IDmodN)·N_{S}+i_s)mod N_{PO}^{LPWUS}) is set to 1. N_{PO}^{LPWUS} is the number of POs per LP WUS (or po-NumPerLPWUS signalled in system information). In one embodiment Number of POs per LP WUS is same as Number of POs per PEI and po-NumPerPEI is used instead of po-NumPerLPWUS.

In one embodiment, paging/PO monitoring/wakeup indication field of LP WUS payload includes N_{PO}^{LPWUS} (Number of POs per LP WUS or po-NumPerLPWUS, signalled in system information) segments of K bits, where K=N_{SG}^{PO} (i.e., number of LP WUS subgroups or Y, signaled in system information). For a LPWUS subgroup index i_{SG}, 0≤i_{SG}<K, a UE determines a value for the (i_{PO}·K+i_{SG}) bit in the paging/PO monitoring/wakeup indication field of LP WUS payload, where i_{PO}=((UE_IDmodN)·N_{S}+i_s)mod N_{PO}^{LPWUS} is a paging occasion index, and UE_ID, N, N_{S}, i_{SG}, and i_s are as defined earlier. When the value is “1,” the UE monitors PO using MR; otherwise, the UE is not required to monitor the paging occasion. In one embodiment Number of POs per LP WUS is same as Number of POs per PEI and po-NumPerPEI is used instead of po-NumPerLPWUS. number of LP WUS subgroups is same as number of paging subgroups and number of paging subgroups is used instead of number of LP WUS subgroups.

FIG. 17 is an example illustration according to this embodiment. The number of POs per LP WUS is 2 (PO1 with i_{PO}=0 and PO2 with i_{PO}=1). The number of LP WUS subgroups is 2. The LP WUS subgroup IDs are 0, 1. There are, “Y*number of POs per LP WUS”=4 bits in LP WUS payload. These 4 bits are uniquely mapped to LP WUS subgroup IDs and POs (POs associated with the LP WUS occasion). Each bit uniquely maps to one of [LP WUS subgroup ID 0, PO1], [LP WUS subgroup ID 1, PO1], [LP WUS subgroup ID 0, PO2] and [LP WUS subgroup ID 1, PO2], which bit is mapped to which combination of LP WUS subgroup IDs and POs can be pre-defined. In the example, bit 0 is mapped to [LP WUS subgroup ID 0, PO1], bit 1 is mapped to [LP WUS subgroup ID 1, PO1], bit 2 is mapped to [LP WUS subgroup ID 0, PO2] and bit 3 is mapped to [LP WUS subgroup ID 1, PO2]. Bit 0 is set to 1 if there is paging for UE(s) with LP WUS subgroup id 0 and whose PO is the PO1 corresponding to the LP WUS occasion. Bit 1 is set to 1 if there is paging for UE(s) with LPWUS subgroup id 1 and whose PO is the PO1 corresponding to the LP WUS occasion. Bit 2 is set to 1 if there is paging for UE(s) with LP WUS subgroup id 0 and whose PO is the PO2 corresponding to the LP WUS occasion. Bit 3 is set to 1 if there is paging for UE(s) with LP WUS subgroup id 1 and whose PO is the PO2 corresponding to the LP WUS occasion.

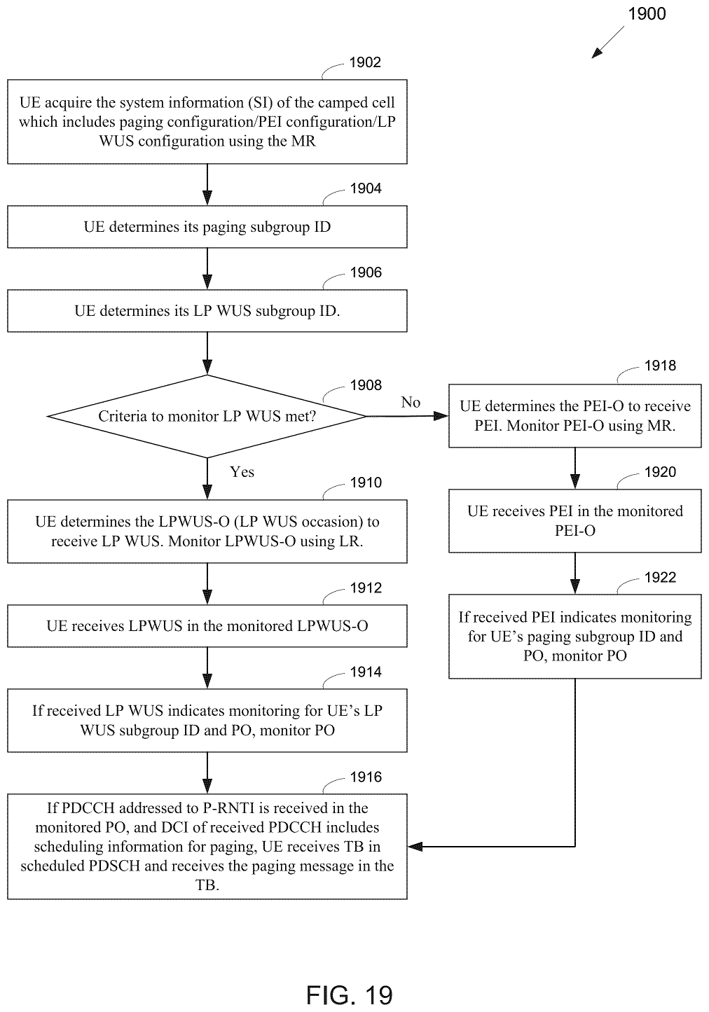

According to an embodiment, a UE operation for monitoring LP WUS and receiving paging is illustrated in FIG. 19.

FIG. 19 illustrates a flowchart of a method 1900 for receiving a paging message according to embodiments of the present disclosure. The method 1900 as may be performed by a UE (e.g., 111-116 as illustrated in FIG. 1). An embodiment of the method 1900 shown in FIG. 19 is for illustration only. One or more of the components illustrated in FIG. 19 can be implemented in specialized circuitry configured to perform the noted functions or one or more of the components can be implemented by one or more processors executing instructions to perform the noted functions.

As illustrated in FIG. 19, in step 1902, the UE acquires the SI of the camped cell which includes a paging configuration/PEI configuration/LP WUS configuration using the MR. In step 1904, the UE determines its paging subgroup ID. In step 1906, the UE determines its LP WUS subgroup ID. In step 1908, the UE determines whether the criteria to monitor LP WUS is met. If yes, in step 1910, the UE determines the LPWUS-O (LP WUS occasion) to receive LP WUS and monitors LPWUS-O using LR. In step 1912, the UE receives LPWUS in the monitored LPWUS-O. In step 1914, if received LP WUS indicates monitoring for UE's LP WUS subgroup ID and PO, the UE monitors PO. In step 1916, if PDCCH addressed to P-RNTI is received in the monitored PO, and DCI of received PDCCH includes scheduling information for paging, the UE receives TB in scheduled PDSCH and receives the paging message in the TB. In step 1908, if no, the UE in step 1918 determines the PEI-O to receive PEI and monitors PEI-O using MR. In step 1920, the UE receives PEI in the monitored PEI-O. In step 1922, if received PEI indicates monitoring for UE's paging subgroup ID and PO, the UE monitors PO.

A UE may be in an RRC_IDLE or an RRC_INACTIVE state. The UE has acquired the SI of the camped cell which includes a paging configuration/PEI configuration/LP WUS configuration using the MR. The UE may have received the CN assigned paging subgroup ID from AMF while the UE was in an RRC_CONNECTED state. The UE may receive CN paging (in the RRC_IDLE and in the RRC_INACTIVE), RAN paging (in the RRC_INACTIVE), system information update notifications, ETWS/CMAS notifications from the camped cell.

A UE determine its LPWUS subgroup ID. If the UE has been assigned the LPWUS subgrouping ID by CN and camped cell supports CN assigned LPWUS subgrouping, LPWUS subgroup ID is the CN assigned LPWUS subgrouping ID. If the UE has not been assigned the LPWUS subgrouping ID by CN or camped cell does not support CN assigned LPWUS subgrouping and camped cell supports the UE ID based LPWUS subgrouping, LPWUS subgroup ID is determined as shown in TABLE 7.

TABLE 7

| | |
|---|---|
| ∘ | LP WUS subgroup ID = (floor (UE_ID/(N*Ns)) mod LPWUSsubgroupsNumForUEID) + |
| | (LPWUSsubgroupsNumPerPO − LPWUSsubgroupsNumForUEID) |
| | N: number of total paging frames in T, which is the DRX cycle of an RRC_IDLE state |
| | Ns: number of paging occasions for a PF |
| | UE_ID: 5G-S-TMSI mod X, where X is 32768, if eDRX is applied; otherwise, X is 8192 |
| | LPWUSsubgroupsNumForUEID: number of subgroups for UE_ID based subgrouping in a |
| | PO, which is broadcasted in system information |
| | LPWUSsubgroupsNumPerPO (Y): number of subgroups per PO, which is broadcasted in |
| | system information |

In one embodiment, LP WUS subgroup ID is same as paging subgrouping ID. LPWUSsubgroupsNumForUEID is same as subgroupsNumForUEID and parameter subgroupsNumForUEID is used instead of LPWUSsubgroupsNumForUEID. LPWUSsubgroupsNumPerPO is same as subgroupsNumPerPO and parameter subgroupsNumPerPO is used instead of LPWUSsubgroupsNumPerPO.

A UE determines the LPWUS-O (LP WUS occasion) to receive LP WUS. An LPWUS-O may be a set of “S*X” consecutive LP WUS monitoring occasions, where “S” is the number of transmitted SSBs/LP SSs, and X is the number of LP WUS monitoring occasions per SSB/LP SS. if configured or is equal to 1 otherwise. The [x*S+K]^{th} LP WUS monitoring occasion in the LPWUS-O corresponds to the K^{th} transmitted SSB/LP SS, where x=0, 1, . . . , X−1, K=1, 2, . . . , S. The LP WUS monitoring occasions are sequentially numbered from zero starting from the first LP WUS monitoring occasion in the LP WUS-O. When the UE detects a LP WUS within its LPWUS-O, the UE is not required to monitor the subsequent LP WUS monitoring occasions associated with the same LPWUS-O.

In one embodiment, an LP WUS configuration indicates LPWUS-Os (e.g., a configuration may signal period and/offset where LPWUS-O occurs periodically with the signalled period and first period may start at an offset from SFN 0, starting time (e.g., slot/symbol), starting frequency resource (e.g., PRB index), number of PRBs and number of slots/symbols of each LPWUS monitoring occasion may also be included in the configuration). In one embodiment, a UE monitors the latest LPWUS-O starting at an offset (can be pre-defined or configured in system information) before the start of UE's PF or PO. In one embodiment, a UE monitors the latest LPWUS-O starting at least at an offset (can be pre-defined or configured in system information) before the start of UE's PF or PO. In one embodiment, a UE monitors the first LPWUS-O starting after an “offset (can be pre-defined or configured in system information) before the start of PF or PO.” In one embodiment, the time location of LP WUS occasion is determined by a reference point and an offset.

The reference point is the start of a reference frame determined by a frame-level offset from the start of the first PF of the PF(s) associated with the LPWUS-O, frame-level offset is signaled in system information; The first PF of the PFs associated with the LPWUS-O is provided by (SFN for PF)-floor (i_{PO}/Ns)*T/N; where i_{PO}=((UE_IDmodN)·N_{S}+i_s)mod N_{PO}^{LPWUS} is a paging occasion index, N_{PO}^{LPWUS}, is signaled by Number of POs per LP WUS. In one embodiment Number of POs per LP WUS is same as Number of POs per PEI and po-NumPerPEI is used instead of po-NumPerLPWUS.

The offset is a symbol-level offset from the reference point to the start of the LPWUS-O, symbol-level offset is signaled in system information. symbol-level offset can be zero if not signaled.

A UE may monitor LP WUS (using LR), if the UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

LP WUS may be monitored on same DL carrier/frequency as the carrier/frequency on which the signals (such as PDCCH/PDSCH) by MR are received. LP WUS can be received on different DL carrier/frequency than the carrier/frequency on which the signals (such as PDCCH/PDSCH) by MR are received. The DL carrier/frequency for LP WUS can be signaled by the gNB in SI (e.g., SIB1 or MIB or any another SIB). The DL BWP for receiving LP WUS can be initial DL BWP or it can be a different BWP signalled by the gNB in SI (e.g., SIB1 or MIB or another SIB).

A UE receives LPWUS in the monitored LPWUS-O. The UE checks if the received LP WUS indicates monitoring for UE's LP WUS subgroup ID and its PO (PO amongst the POs associated with the LP WUS occasion, POs associated with LP WUS can be indexed from zero to number of POs per LP WUS, the index of UE's PO amongst these POs can be given by i_{PO}=((UE_IDmodN)·N_{S}+i_s)mod N_{PO}^{LPWUS}). If yes, the UE monitors PO (using MR). Alternately, the UE checks if the bit in the LP WUS payload corresponding to its LP WUS subgroup ID and its PO is set to 1. If yes, the UE monitors its PO. In one embodiment Number of POs per LP WUS is same as Number of POs per PEI and po-NumPerPEI is used instead of po-NumPerLPWUS.

If PDCCH addressed to P-RNTI is received in the PO, and DCI of received PDCCH includes scheduling information for paging, the UE receives TB in scheduled PDSCH and receives the paging message in the TB.

According to an embodiment, a UE operation for monitoring LP WUS and receiving paging is illustrated in FIG. 19.

A UE may be in an RRC_IDLE or an RRC_INACTIVE state. The UE has acquired the SI of the camped cell which includes a paging configuration/PEI configuration/LP WUS configuration using the MR. the UE may have received the CN assigned paging subgroup ID from AMF while the UE was in an RRC_CONNECTED state. The UE may receive CN paging (in the RRC_IDLE and in the RRC_INACTIVE), RAN paging (in the RRC_INACTIVE), system information update notifications, ETWS/CMAS notifications from the camped cell.

A UE determine its LPWUS subgroup ID. The UE determine its paging subgroup ID. In one embodiment, LPWUS subgroup ID is same as paging subgroup ID, the UE only determines the paging subgroup ID.

If criteria to monitor LP WUS is met (Criteria: if a UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.)

The UE determines the LPWUS-O (LP WUS occasion) to receive LP WUS. Monitor LPWUS-O using LR. The UE receives LPWUS in the monitored LPWUS-O. The UE checks if the received LP WUS indicates monitoring for UE's LP WUS subgroup ID and its PO (PO amongst the POs associated with the LP WUS occasion, POs associated with LP WUS can be indexed from zero to number of POs per LP WUS, the index of UE's PO amongst these POs can be given by i_{PO}=((UE_IDmodN)·N_{S}+i_s)mod N_{PO}^{LPWUS}). If yes, the UE monitors PO (using MR). Alternately, the UE checks if the bit in the LP WUS payload corresponding to its LP WUS subgroup ID and its PO is set to 1. If yes, the UE monitors its PO. In one embodiment Number of POs per LP WUS is same as Number of POs per PEI and po-NumPerPEI is used instead of po-NumPerLPWUS. If PDCCH addressed to P-RNTI is received in the monitored PO, and DCI of received PDCCH includes scheduling information for paging, the UE receives TB in scheduled PDSCH and receives the paging message in the TB.

If criteria to monitor LP WUS is not met: (1) the UE determines the PEI-O to receive PEI. Monitor PEI-O using MR; (2) the UE receives PEI in the monitored PEI-O; (3) if received PEI indicates monitoring for UE's paging subgroup ID and PO, monitor PO; and (4) if PDCCH addressed to P-RNTI is received in the monitored PO, and DCI of received PDCCH includes scheduling information for paging, the UE receives TB in scheduled PDSCH and receives the paging message in the TB.

According to an embodiment of this disclosure, UEs can be categorized into LP WUS subgroups. The total number (Y) of LP WUS subgroups can be configurable. The configuration can be signaled in system information (e.g., SIB) or in an RRC message. UE's LP WUS subgroup ID is determined as shown in TABLE 8.

```
TABLE 8
LP WUS subgroup ID = paging subgroup ID mod Y; or
LP WUS subgroup ID = floor (paging subgroup ID/Y); or
LP WUS subgroup ID = (floor (UE_ID/(N*Ns)) mod LPWUSsubgroupsNumForUEID) + (Y
  LPWUSsubgroupsNumForUEID), where LPWUSsubgroupsNumForUEID is the number of
  LPWUS subgroups for UE_ID based subgrouping; or
LP WUS subgroup ID = floor (UE_ID/(N*Ns)) mod LPWUSsubgroupsNumForUEID, where
  LPWUSsubgroupsNumForUEID is the number of LPWUS subgroups for UE_ID based LP
  WUS subgrouping; or
LP WUS subgroup ID = paging subgroup ID; or
LP WUS subgroup ID = floor (UE_ID/(N*Ns)) mod Y; or
LP WUS subgroup ID = floor (UE_ID/A) mod Y, where A is the number of LPWUS occasions
  (per LPWUS period/cycle); or
LP WUS subgroup ID = floor (UE_ID/(A*B)) mod Y, where A is the number of LPWUS frames
  (per LPWUS period/cycle) and B is the number of LP WUS occasions per LP WUS frames;
  or
LP WUS subgroup ID = UE_ID mod Y
where paging subgroup ID can be assigned by AMF through NAS signalling; or it can be
determined using formula;
```

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state |
| | Ns: number of paging occasions for a PF |
| | UE_ID: 5G-S-TMSI mod X, where X is 32768, if eDRX (extended DRX) is applied; |
| | otherwise, X is 8192 |
| | subgroupsNumForUEID: number of paging subgroups for UE_ID based subgrouping |
| | in a PO, which is broadcasted in system information |
| | subgroupsNumPerPO: number of paging subgroups per PO, which is broadcasted in |
| | system information |

In this embodiment, “Y” bits are carried in LP WUS payload. Each bit is uniquely mapped to LP WUS subgroup ID. Upon reception of LP WUS payload in LP WUS occasion, a UE checks if the bit corresponding to its LP WUS subgroup ID is set to 1. If set to 1, the UE monitors the PEI.

In one embodiment, paging/PEI monitoring/wakeup indication field of LP WUS payload includes K bits, where K=N_{SG}^{PO} (i.e., number of LP WUS subgroups or Y, signaled in system information). For a LPWUS subgroup index i_{SG}, 0≤i_{SG}<K, a UE determines a value for the (i_{SG}) bit in the paging/PEI monitoring/wakeup indication field of LP WUS payload. When the value is “1,” the UE monitors paging or PEI-O using MR; otherwise, the UE is not required to monitor the paging or PEI-O.

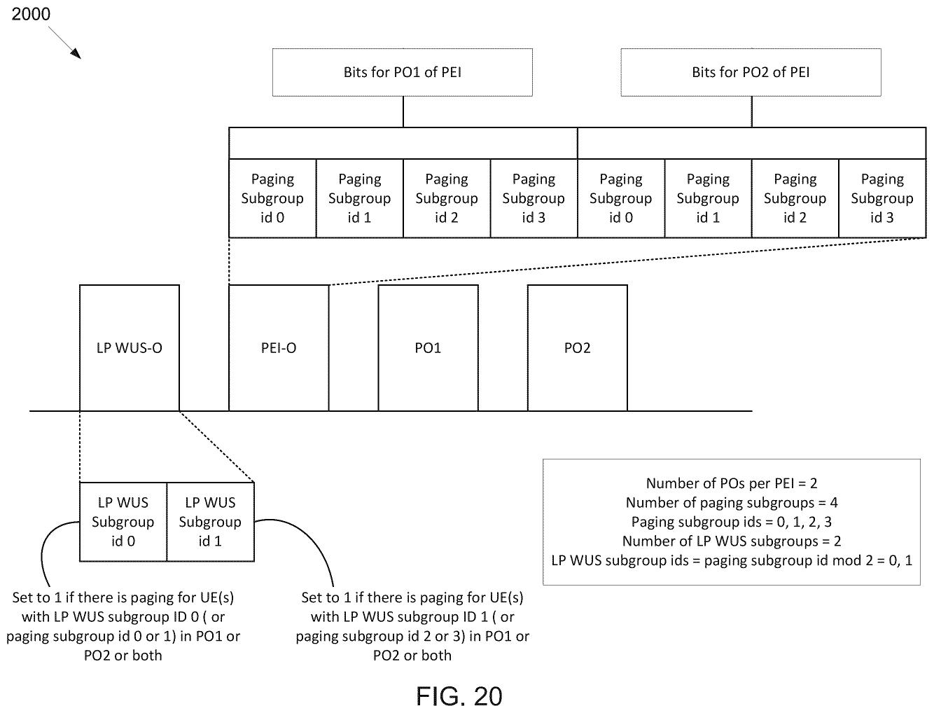

FIG. 20 illustrates an example of LP WUS subgroup ID determination 2000 according to embodiments of the present disclosure. An embodiment of the LP WUS subgroup ID determination 2000 shown in FIG. 20 is for illustration only.

FIG. 20 is an example illustration according to this embodiment. The number of POs per PEI is 2. The number of paging subgroups is 4. The paging subgroup IDs are 0, 1, 2, 3. The number (Y) of LP WUS subgroups is 2. LP WUS subgroup ID=paging subgroup ID mod 2. So, there are two LP WUS subgroup IDs, 0 and 1. There are, “Y”=2 bits in LP WUS payload. These 2 bits are uniquely mapped to LP WUS subgroup IDs. In the example, bit 0 is mapped to LP WUS subgroup ID 0 and bit 1 is mapped to LP WUS subgroup ID 1. Bit 0 is set to 1 if there is paging for UE(s) with paging subgroup id 0 and/or 1 in PO1 or PO2 or both. Note that for these UEs LP WUS subgroup ID is 0. Bit 0 is set to 1 if there is paging for UE(s) with LP WUS subgroup ID 0 in PO1 or PO2 or both. Bit 1 is set to 1 if there is paging for UE(s) with paging subgroup id 2 and/or 3 in PO1 or PO2 or both. Note that these UEs LP WUS subgroup ID is 1. Bit 1 is set to 1 if there is paging for UE(s) with LP WUS subgroup ID 1 in PO1 or PO2 or both.

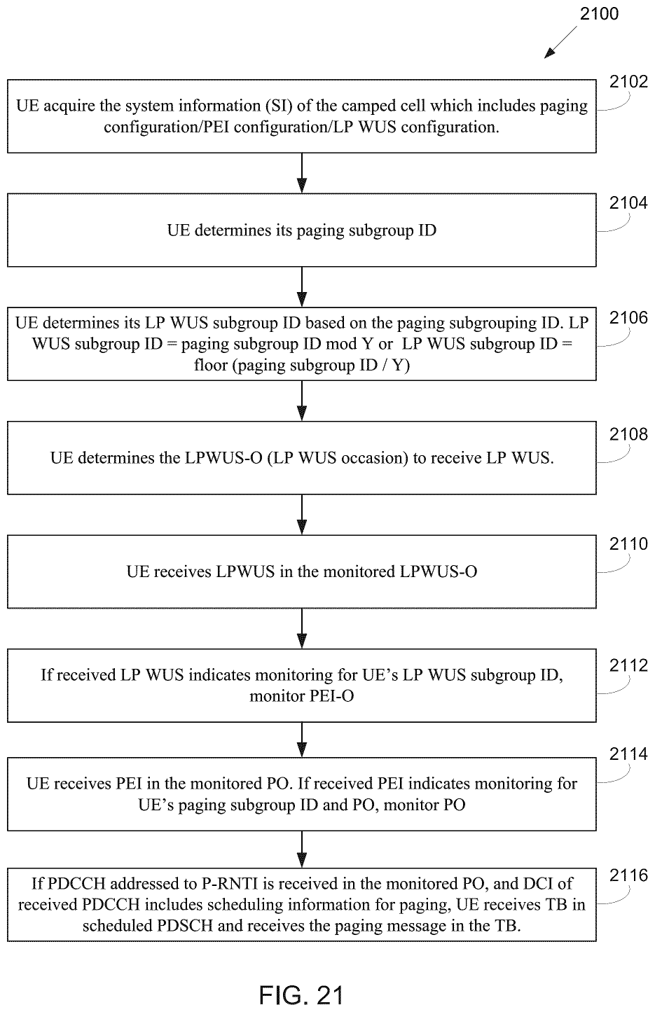

According to an embodiment, a UE operation for monitoring LP WUS and receiving paging is illustrated in FIG. 21.

FIG. 21 illustrates a flowchart of a method 2100 for receiving a paging message according to embodiments of the present disclosure. The method 2100 as may be performed by a UE (e.g., 111-116 as illustrated in FIG. 1). An embodiment of the method 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

As illustrated in FIG. 21, the UE in step 2102 acquires the SI of the camped cell which includes a paging configuration/PEI configuration/LP WUS configuration. In step 2104, the UE determines its paging subgroup ID. In step 2106, the UE determines its LP WUS subgroup ID based on the paging subgrouping ID. LP WUS subgroup ID=paging subgroup ID mod Y or LP WUS subgroup ID=floor (paging subgroup ID/Y). In step 2108, the UE determines the LPWUS-O (LP WUS occasion) to receive LP WUS. In step 2110, the UE receives LPWUS in the monitored LPWUS-O. In step 2112, if received LP WUS indicates monitoring for UE's LP WUS subgroup ID, the UE monitors PEI-O. In step 2114, the UE receives PEI in the monitored PO. If received PEI indicates monitoring for UE's paging subgroup ID and PO, the UE monitors PO. In step 2116, if PDCCH addressed to P-RNTI is received in the monitored PO, and DCI of received PDCCH includes scheduling information for the paging, the UE receives TB in scheduled PDSCH and receives the paging message in the TB.

A UE may be in an RRC_IDLE or an RRC_INACTIVE state. The UE has acquired the SI of the camped cell which includes a paging configuration/PEI configuration/LP WUS configuration. The UE may have received the CN assigned paging subgroup ID from AMF while the UE was in an RRC_CONNECTED state. The UE may receive CN paging (in the RRC_IDLE and in the RRC_INACTIVE), RAN paging (in the RRC_INACTIVE), system information update notifications, ETWS/CMAS notifications from the camped cell.

A UE determine its paging subgroup ID. If the UE has been assigned the paging subgrouping ID by CN and camped cell supports CN assigned paging subgrouping, paging subgroup ID is the CN assigned paging subgrouping ID. If the UE has not been assigned the paging subgrouping ID by CN or camped cell does not support CN assigned paging subgrouping and camped cell supports the UE ID based paging subgrouping, paging subgroup ID is determined as shown in TABLE 9.

TABLE 9

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state; N is |
| | broadcasted in system information |
| | Ns: number of paging occasions for a PF; Ns is broadcasted in system information |
| | UE_ID: 5G-S-TMSI mod X, where X is 32768, if eDRX is applied; otherwise, X is 8192 |
| | subgroupsNumForUEID: number of subgroups for UE_ID based subgrouping in a PO, which |
| | is broadcasted in system information |
| | subgroupsNumPerPO: number of subgroups per PO, which is broadcasted in system |
| | information |

A UE determines its LP WUS subgroup ID based on the paging subgrouping ID. The LP WUS subgroup ID is determined as shown in TABLE 10.

TABLE 10

| - | LP WUS subgroup ID = paging subgroup ID mod Y | |
|---|---|---|
| | or | |
| | LP WUS subgroup ID = floor (paging subgroup ID/Y) | |
| | or | |
| | LP WUS subgroup ID = paging subgroup ID; | |
| - | where paging subgroup ID can be assigned by AMF through NAS signalling; or it can | |
| | be determined using formula; | |
| | ∘ | SubgroupID = (floor (UE_ID/(N*Ns)) mod subgroupsNumForUEID) + |
| | | (subgroupsNumPerPO − subgroupsNumForUEID) |
| | | N: number of total paging frames in T, which is the DRX cycle of an RRC_IDLE |
| | | state |
| | | Ns: number of paging occasions for a PF |
| | | UE_ID: 5G-S-TMSI mod X, where X is 32768, if eDRX (extended DRX) is |
| | | applied; otherwise, X is 8192 |
| | | subgroupsNumForUEID: number of paging subgroups for UE_ID based |
| | | subgrouping in a PO, which is broadcasted in system information |
| | | subgroupsNumPerPO: number of paging subgroups per PO, which is |
| | | broadcasted in system information |

In another embodiment, a UE determines LP WUS subgroup ID as shown in TABLE 11.

```
TABLE 11
LP WUS subgroup ID = (floor (UE_ID/(N*Ns)) mod LPWUSsubgroupsNumForUEID) +
(Y − LPWUSsubgroupsNumForUEID); or
LP WUS subgroup ID = floor (UE_ID/(N*Ns)) mod Y; or
  LP WUS subgroup ID = floor(UE_ID/A) mod Y, where A is the number of LPWUS
  occasions (per LPWUS period/cycle); or
  LP WUS subgroup ID = floor(UE_ID/(A*B)) mod Y, where A is the number of LPWUS
  frames (per LPWUS period/cycle) and B is the number of LP WUS occasions per LP
  WUS frames; or
  LP WUS subgroup ID = UE_ID mod Y
```

A UE determines the LPWUS-O (LP WUS occasion) to receive LP WUS. An LPWUS-O may be a set of “S*X” consecutive LP WUS monitoring occasions, where “S” is the number of transmitted SSBs/LP SSs, and X is the number of LP WUS monitoring occasions per SSB/LP SS. if configured or is equal to 1 otherwise. The [x*S+K]^{th} LP WUS monitoring occasion in the LPWUS-O corresponds to the K^{th} transmitted SSB/LP SS, where x=0, 1, . . . , X−1, K=1, 2, . . . , S. The LP WUS monitoring occasions are sequentially numbered from zero starting from the first LP WUS monitoring occasion in the LP WUS-O. When the UE detects a LP WUS within its LPWUS-O, the UE is not required to monitor the subsequent LP WUS monitoring occasions associated with the same LPWUS-O.

In one embodiment, an LP WUS configuration indicates LPWUS-Os (e.g., a configuration may signal period and/offset where LPWUS-O occurs periodically with the signalled period and first period may start at an offset from SFN 0, starting time (e.g., slot/symbol), starting frequency resource (e.g., PRB index), number of PRBs and number of slots/symbols of each LPWUS monitoring occasion may also be included in the configuration). In one embodiment, a UE monitors the latest LPWUS-O starting at an offset (can be pre-defined or configured in system information) before the start of UE's PEI-O or PF or PO. In one embodiment, a UE monitors the latest LPWUS-O starting at least at an offset (can be pre-defined or configured in system information) before the start of UE's PEI-O or PF or PO. In one embodiment, a UE monitors the first LPWUS-O starting after an “offset (can be pre-defined or configured in system information) before the start of UE's PEI-O or PF or PO.” In one embodiment, the time location of LP WUS occasion is determined by a reference point and an offset.

The reference point is the start of a reference frame determined by a frame-level offset from the start of the frame of UE's PEI-O, frame-level offset is signaled in system information;

The offset is a symbol-level offset from the reference point to the start of the LPWUS-O, symbol-level offset is signaled in system information. symbol-level offset can be zero if not signaled.

A UE may monitor LP WUS (using LR), if the UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

LP WUS may be monitored on same DL carrier/frequency as the carrier/frequency on which the signals (such as PDCCH/PDSCH) by MR are received. LP WUS can be received on different DL carrier/frequency than the carrier/frequency on which the signals (such as PDCCH/PDSCH) by MR are received. The DL carrier/frequency for LP WUS can be signaled by the gNB in SI (e.g., SIB1 or MIB or any another SIB). The DL BWP for receiving LP WUS can be initial DL BWP or it can be a different BWP signalled by the gNB in SI (e.g., SIB1 or MIB or another SIB).

A UE receives LPWUS in the monitored LPWUS-O. The UE checks if the received LP WUS indicates monitoring for UE's LP WUS subgroup ID. If yes, the UE monitors PEI in the PEI-O (using MR). Alternately, the UE checks if the bit in the LP WUS payload corresponding to its LP WUS subgroup ID is set to 1. If yes, the UE monitors the PEI in the PEI-O.

If the UE detects PEI and the PEI indicates the paging subgroup the UE belongs to monitor its associated PO, the UE monitors the associated PO. If the UE does not detect PEI on the monitored PEI occasion or the PEI does not indicate the paging subgroup the UE belongs to monitor its associated PO, the UE is not required to monitor the associated PO. If PDCCH addressed to P-RNTI is received in the PO, and DCI of received PDCCH includes scheduling information for paging, the UE receives TB in scheduled PDSCH and receives the paging message in the TB.

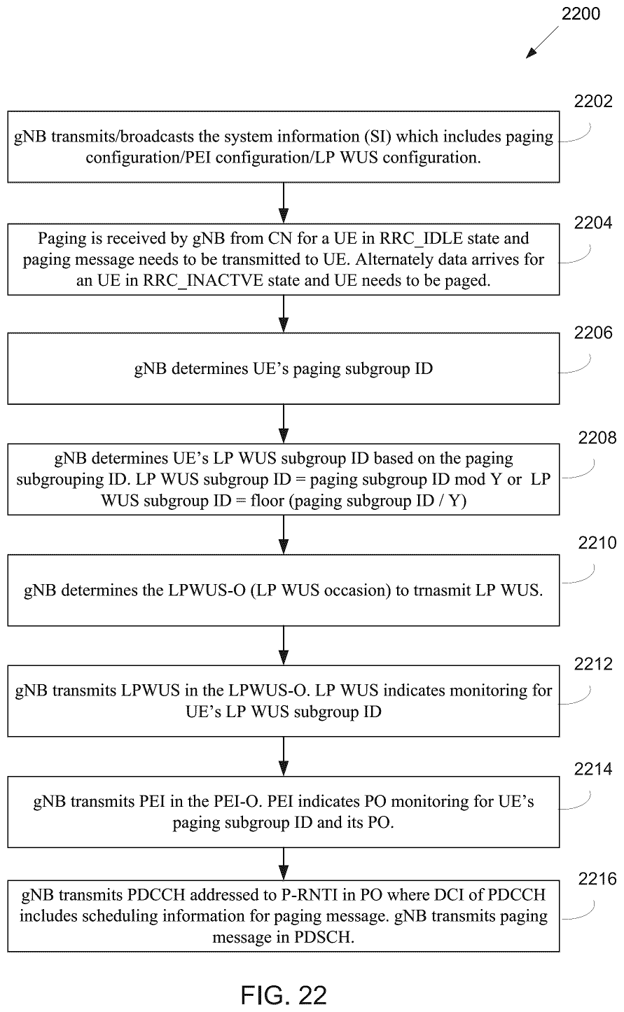

FIG. 22 illustrates a flowchart of a method 2200 for transmitting a paging message according to embodiments of the present disclosure. The method 2200 as may be performed by a BS (e.g., 101-103 as illustrated in FIG. 1). An embodiment of the method 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions.

According to an embodiment, a gNB operation for transmitting LP WUS and paging is illustrated in FIG. 22.

As illustrated in FIG. 22, in step 2202, the gNB transmits/broadcasts the SI which includes a paging configuration/PEI configuration/LP WUS configuration. In step 2204, the paging is received by the gNB from a CN for a UE in an RRC_IDLE state and a paging message needs to be transmitted to the UE. Alternately, data arrives for the UE in an RRC_INACTVE state and UE needs to be paged. In step 2206, the gNB determines UE's paging subgroup ID. In step 2208, the gNB determines UE's LP WUS subgroup ID based on the paging subgrouping ID. LP WUS subgroup ID=paging subgroup ID mod Y or LP WUS subgroup ID=floor (paging subgroup ID/Y). In step 2210, the gNB determines the LPWUS-O (LP WUS occasion) to transmit LP WUS. In step 2212, the gNB transmits LPWUS in the LPWUS-O. The LP WUS indicates monitoring for UE's LP WUS subgroup ID. In step 2214, the gNB transmits PEI in the PEI-O. The PEI indicates PO monitoring for UE's paging subgroup ID and its PO. In step 2216, the gNB transmits PDCCH addressed to P-RNTI in PO where DCI of PDCCH includes scheduling information for the paging message. The gNB transmits the paging message in PDSCH.

A gNB transmits/broadcasts the SI which includes a paging configuration/PEI configuration/LP WUS configuration.

Paging is received by a gNB from CN for a UE in an RRC_IDLE state and a paging message needs to be transmitted to a UE. Alternately data arrives for a UE in an RRC_INACTVE state and the UE needs to be paged.

A gNB determines UE's paging subgroup ID. If a UE has been assigned the paging subgrouping ID by CN and cell supports CN assigned paging subgrouping, paging subgroup ID is the CN assigned paging subgrouping ID. If the UE has not been assigned the paging subgrouping ID by CN or cell does not support CN assigned paging subgrouping and cell supports the UE ID based paging subgrouping, paging subgroup ID is determined as shown in TABLE 12.

TABLE 12

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state; N is |
| | broadcasted in system information |
| | Ns: number of paging occasions for a PF; Ns is broadcasted in system information |
| | UE_ID: received from AMF |
| | subgroupsNumForUEID: number of subgroups for UE_ID based subgrouping in a PO, which |
| | is broadcasted in system information |
| | subgroupsNumPerPO: number of subgroups per PO, which is broadcasted in system |
| | information |

A gNB determines UE's LP WUS subgroup ID based on the paging subgrouping ID. The LP WUS subgroup ID is determined as shown in TABLE 13.

TABLE 13

| - | LP WUS subgroup ID = paging subgroup ID mod Y | |
|---|---|---|
| | or | |
| | LP WUS subgroup ID = floor (paging subgroup ID/Y) | |
| | or | |
| | LP WUS subgroup ID = paging subgroup ID; | |
| - | where paging subgroup ID can be assigned by AMF through NAS signalling; or it can | |
| | be determined using formula; | |
| | ∘ | SubgroupID = (floor (UE_ID/(N*Ns)) mod subgroupsNumForUEID) + |
| | | (subgroupsNumPerPO − subgroupsNumForUEID) |
| | | N: number of total paging frames in T, which is the DRX cycle of an RRC_IDLE |
| | | state |
| | | Ns: number of paging occasions for a PF |
| | | UE_ID: 5G-S-TMSI mod X, where X is 32768, if eDRX (extended DRX) is |
| | | applied; otherwise, X is 8192 |
| | | subgroupsNumForUEID: number of paging subgroups for UE_ID based |
| | | subgrouping in a PO, which is broadcasted in system information |
| | | subgroupsNumPerPO: number of paging subgroups per PO, which is |
| | | broadcasted in system information |

In an alternate embodiment, a gNB determines UE's LP WUS subgroup ID as shown in TABLE 14.

```
TABLE 14
LP WUS subgroup ID = (floor (UE_ID/(N*Ns)) mod LPWUSsubgroupsNumForUEID) +
(Y − LPWUSsubgroupsNumForUEID); or
LP WUS subgroup ID = floor (UE_ID/(N*Ns)) mod LPWUSsubgroupsNumForUEID, where
  LPWUSsubgroupsNumForUEID is the number of LPWUS subgroups for UE_ID based LP
  WUS subgrouping; or
  LP WUS subgroup ID = floor (UE_ID/(N*Ns)) mod Y; or
    LP WUS subgroup ID = floor(UE_ID/A) mod Y, where A is the number of LPWUS
    occasions (per LPWUS period/cycle); or
    LP WUS subgroup ID = floor(UE_ID/(A*B)) mod Y, where A is the number of LPWUS
    frames (per LPWUS period/cycle) and B is the number of LP WUS occasions per LP
    WUS frames; or
    LP WUS subgroup ID = UE_ID mod Y
```

A gNB determines the LPWUS-O (LP WUS occasion) to transmit LP WUS.

In one embodiment, an LP WUS configuration indicates LPWUS-Os (e.g., a configuration may signal period and/offset where LPWUS-O occurs periodically with the signalled period and first period may start at an offset from SFN 0, starting time (e.g., slot/symbol), starting frequency resource (e.g., PRB index), number of PRBs and number of slots/symbols of each LPWUS monitoring occasion may also be included in the configuration). In one embodiment, LPWUS-O for transmitting LP WUS to a UE is the latest LPWUS-O starting at an offset (can be pre-defined or configured in system information) before the start of UE's PEI-O or PF or PO. In one embodiment, LPWUS-O for transmitting LP WUS to the UE the latest LPWUS-O starting at least at an offset (can be pre-defined or configured in system information) before the start of UE's PEI-O or PF or PO. In one embodiment, LPWUS-O for transmitting LP WUS to the UE is the first LPWUS-O starting after an “offset (can be pre-defined or configured in system information) before the start of UE's PEI-O or PF or PO.” In one embodiment, the time location of LP WUS occasion is determined by a reference point and an offset.

The reference point is the start of a reference frame determined by a frame-level offset from the start of the frame of UE's PEI-O, frame-level offset is signaled in system information.

The offset is a symbol-level offset from the reference point to the start of the LPWUS-O, symbol-level offset is signaled in system information. symbol-level offset can be zero if not signaled.

A gNB transmits LPWUS in the LPWUS-O. LP WUS indicates monitoring for UE's LP WUS subgroup ID. The bit in the LP WUS payload corresponding to UE's LP WUS subgroup ID is set to 1.

A gNB transmits PEI in the PEI-O. PEI indicates PO monitoring for UE's paging subgroup ID and its PO. The bit in the PEI payload corresponding to UE's paging subgroup ID and UE's PO is set to 1.

A gNB transmits PDCCH addressed to P-RNTI in PO where DCI of PDCCH includes scheduling information for a paging message.

A gNB transmits a paging message in PDSCH.

According to an embodiment of this disclosure, “number of POs per PEI” bits are carried in LP WUS payload. Number of POs per PEI (or po-NumPerPEI) is signaled by a gNB in system information. Each bit is uniquely mapped to PO (PO amongst the POs associated with PEI occasion corresponding to the LP WUS occasion). POs associated with PEI can be indexed from zero to number of POs per PEI, the index of UE's PO amongst these POs can be given by i_{PO}=((UE_IDmodN)·N_{S}+i_s)mod N_{PO}^{PEI}) is set to 1. N_{PO}^{PEI} is the number of POs per PEI (or po-NumPerPEI signalled in system information). Upon reception of LP WUS payload in LP WUS occasion, a UE checks if the bit corresponding to its PO (PO amongst the POs associated with PEI occasion corresponding to the LP WUS occasion) is set to 1. If set to 1, the UE monitors the PEI.

In one embodiment, paging/PEI monitoring/wakeup indication field of LP WUS payload includes K bits, where K=N_{PO}^{PEI} (Number of POs per PEI or po-NumPerPEI, signalled in system information). A UE determines a value for the (i_{PO}) bit in the paging/PEI monitoring/wakeup indication field of LP WUS payload, where i_{PO}=((UE_IDmodN)·N_{S}+i_s)mod N_{PO}^{PEI} is a paging occasion index, and UE_ID, N, N_{S}, i_{SG}, and i_s are as defined earlier. When the value is “1,” the UE monitors paging or PEI-O using MR; otherwise, the UE is not required to monitor the paging or PEI-O.

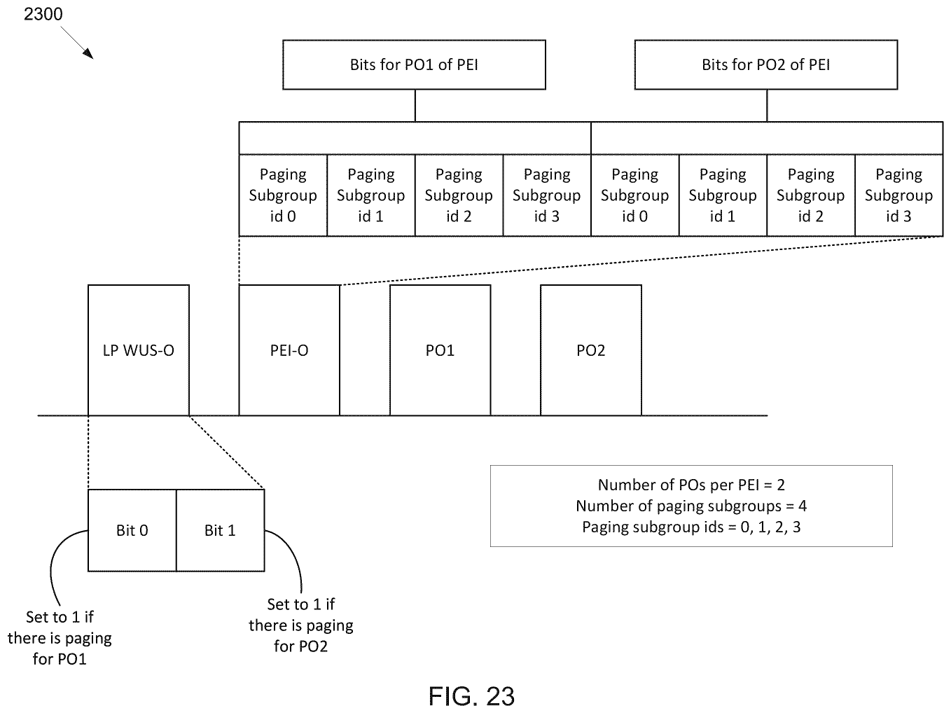

FIG. 23 illustrates an example of PEI-O and PO determination 2300 according to embodiments of the present disclosure. An embodiment of the PEI-O and PO determination 2300 shown in FIG. 23 is for illustration only.

FIG. 23 is an example illustration according to this embodiment. The number of POs per PEI is 2 (PO1 with i_{PO}=0 and PO2 with i_{PO}=1). The number of paging subgroups is 4. The paging subgroup IDs are 0, 1, 2, 3. There are, “number of POs per PEI”=2 bits in LP WUS payload. These 2 bits are uniquely mapped to POs (POs associated with PEI occasion corresponding to the LP WUS occasion). Each bit uniquely maps to one of PO1 of PEI or PO2 of PEI. In the example, bit 0 is mapped to PO1 of PEI, bit 1 is mapped to PO2 of PEI. Bit 0 is set to 1 if there is paging for UE(s) associated with PO1 of PEI occasion corresponding to the LP WUS occasion. Bit 1 is set to 1 if there is paging for UE(s) associated with PO1 of PEI occasion corresponding to the LP WUS occasion.

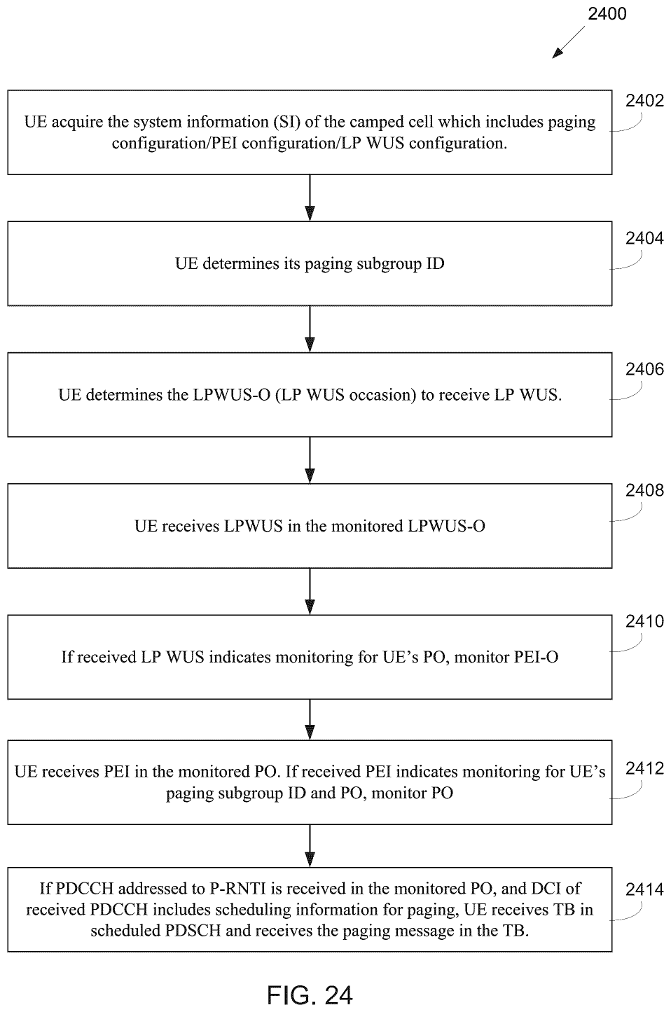

According to an embodiment, a UE operation for monitoring LP WUS and receiving paging is illustrated in FIG. 24.

FIG. 24 illustrates a flowchart of a method 2400 for receiving a paging message according to embodiments of the present disclosure. The method 2400 as may be performed by a UE (e.g., 111-116 as illustrated in FIG. 1). An embodiment of the method 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions.

As illustrated in FIG. 24, the UE in step 2402 acquires the SI of the camped cell which includes a paging configuration/PEI configuration/LP WUS configuration. In step 2404, the UE determines its paging subgroup ID. In step 2406, the UE determines the LPWUS-O (LP WUS occasion) to receive LP WUS. In step 2408, the UE receives LPWUS in the monitored LPWUS-O. In step 2410, if received LP WUS indicates monitoring for UE's PO, the UE monitors PEI-O. In step 2412, the UE receives PEI in the monitored PO. If received PEI indicates monitoring for UE's paging subgroup ID and PO, the UE monitors PO. In step 2414, if PDCCH addressed to P-RNTI is received in the monitored PO, and DCI of received PDCCH includes scheduling information for paging, the UE receives TB in scheduled PDSCH and receives the paging message in the TB.

A UE may be in an RRC_IDLE or an RRC_INACTIVE state. The UE has acquired the SI of the camped cell which includes a paging configuration/PEI configuration/LP WUS configuration. The UE may have received the CN assigned paging subgroup ID from AMF while the UE was in an RRC_CONNECTED state. The UE may receive CN paging (in the RRC_IDLE and in the RRC_INACTIVE), RAN paging (in the RRC_INACTIVE), system information update notifications, ETWS/CMAS notifications from the camped cell.

A UE determine its paging subgroup ID. If the UE has been assigned the paging subgrouping ID by CN and camped cell supports CN assigned paging subgrouping, paging subgroup ID is the CN assigned paging subgrouping ID. If the UE has not been assigned the paging subgrouping ID by CN or camped cell does not support CN assigned paging subgrouping and camped cell supports the UE ID based paging subgrouping, paging subgroup ID is determined as shown in TABLE 15.

TABLE 15

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state; N is |
| | broadcasted in system information |
| | Ns: number of paging occasions for a PF; Ns is broadcasted in system information |
| | UE_ID: 5G-S-TMSI mod X, where X is 32768, if eDRX is applied; otherwise, X is 8192 |
| | subgroupsNumForUEID: number of subgroups for UE_ID based subgrouping in a PO, which |
| | is broadcasted in system information |
| | subgroupsNumPerPO: number of subgroups per PO, which is broadcasted in system |
| | information |

A UE determines the LPWUS-O (LP WUS occasion) to receive LP WUS. An LPWUS-O may be a set of “S*X” consecutive LP WUS monitoring occasions, where “S” is the number of transmitted SSBs/LP SSs, and X is the number of LP WUS monitoring occasions per SSB/LP SS. if configured or is equal to 1 otherwise. The [x*S+K]^{th} LP WUS monitoring occasion in the LPWUS-O corresponds to the K^{th} transmitted SSB/LP SS, where x=0, 1, . . . , X−1, K=1, 2, . . . , S. The LP WUS monitoring occasions are sequentially numbered from zero starting from the first LP WUS monitoring occasion in the LP WUS-O. When the UE detects a LP WUS within its LPWUS-O, the UE is not required to monitor the subsequent LP WUS monitoring occasions associated with the same LPWUS-O.

In one embodiment, an LP WUS configuration indicates LPWUS-Os. In one embodiment, a UE monitors the latest LPWUS-O starting at an offset (can be pre-defined or configured in system information) before the start of UE's PEI-O or PF or PO. In one embodiment, a UE monitors the latest LPWUS-O starting at least at an offset (can be pre-defined or configured in system information) before the start of UE's PEI-O or PF or PO. In one embodiment, a UE monitors the first LPWUS-O starting after an “offset (can be pre-defined or configured in system information) before the start of UE's PEI-O or PF or PO.” In one embodiment, the time location of LP WUS occasion is determined by a reference point and an offset.

The reference point is the start of a reference frame determined by a frame-level offset from the start of the frame of UE's PEI-O, frame-level offset is signaled in system information.

The offset is a symbol-level offset from the reference point to the start of the LPWUS-O, symbol-level offset is signaled in system information. symbol-level offset can be zero if not signaled.

A UE may monitor LP WUS (using LR) in the determined LPWUS-O, if the UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

LP WUS may be monitored on same DL carrier/frequency as the carrier/frequency on which the signals (such as PDCCH/PDSCH) by MR are received. LP WUS can be received on different DL carrier/frequency than the carrier/frequency on which the signals (such as PDCCH/PDSCH) by MR are received. The DL carrier/frequency for LP WUS can be signaled by a gNB in SI (e.g., SIB1 or MIB or any another SIB). The DL BWP for receiving LP WUS can be initial DL BWP or it can be a different BWP signalled by the gNB in SI (e.g., SIB1 or MIB or another SIB).

A UE receives LPWUS in the monitored LPWUS-O. The UE checks if the received LP WUS indicates monitoring for UE's PO (PO amongst the POs associated with PEI occasion corresponding to the LP WUS occasion, POs associated with PEI can be indexed from zero to number of POs per PEI, the index of UE's PO amongst these POs can be given by i_{PO}=((UE_IDmodN)·N_{S}+i_s)mod N_{PO}^{PEI}). If yes, the UE monitors PEI in the PEI-O (using MR). Alternately, the UE checks if the bit in the LP WUS payload corresponding to its PO is set to 1. If yes, the UE monitors the PEI in the PEI-O.

If the UE detects PEI and the PEI indicates the paging subgroup the UE belongs to monitor its associated PO, the UE monitors the associated PO. If the UE does not detect PEI on the monitored PEI occasion or the PEI does not indicate the paging subgroup the UE belongs to monitor its associated PO, the UE is not required to monitor the associated PO. If PDCCH addressed to P-RNTI is received in the PO, and DCI of received PDCCH includes scheduling information for paging, the UE receives TB in scheduled PDSCH and receives the paging message in the TB.

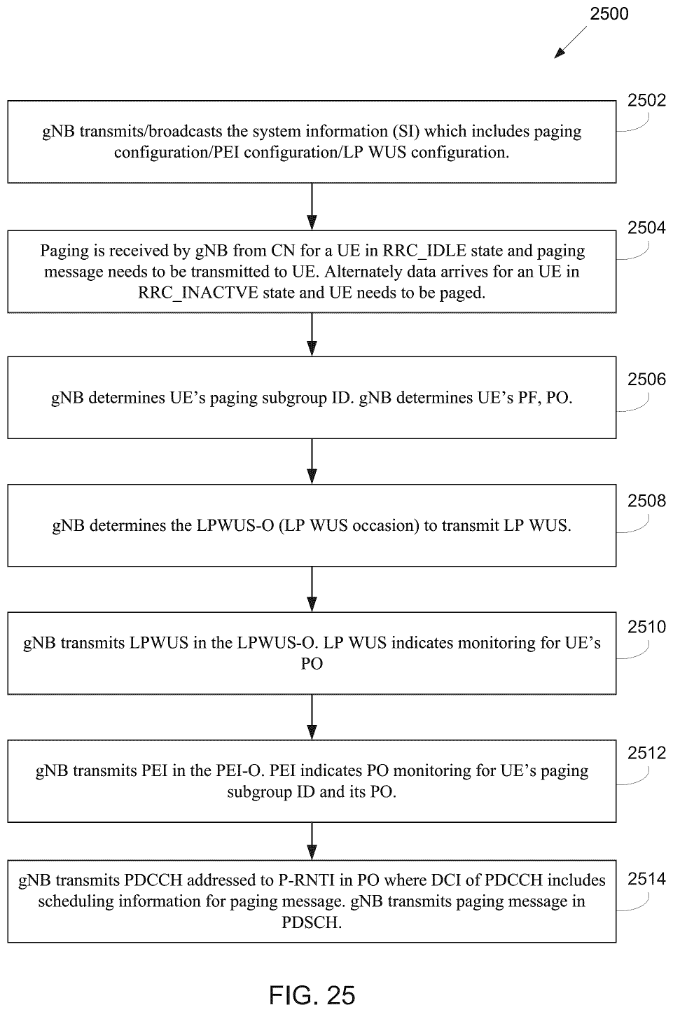

FIG. 25 illustrates a flowchart of a method 2500 for transmitting a paging message according to embodiments of the present disclosure. The method 2500 as may be performed by a UE (e.g., 111-116 as illustrated in FIG. 1). An embodiment of the method 2500 shown in FIG. 25 is for illustration only. One or more of the components illustrated in FIG. 25 can be implemented in specialized circuitry configured to perform the noted functions or one or more of the components can be implemented by one or more processors executing instructions to perform the noted functions.

According to an embodiment, a gNB operation for transmitting LP WUS and paging is illustrated in FIG. 25.

As illustrated in FIG. 25, in step 2502, the gNB transmits/broadcasts the SI which includes a paging configuration/PEI configuration/LP WUS configuration. In step 2504, a paging is received by the gNB from a CN for a UE in an RRC_IDLE state and a paging message needs to be transmitted to the UE. Alternately, data arrives for the UE in an RRC_INACTVE state and the UE needs to be paged. In step 2506, the gNB determines UE's paging subgroup ID. The gNB determines UE's PF, PO. In step 2508, the gNB determines the LPWUS-O (LP WUS occasion) to transmit LP WUS. In step 2510, the gNB transmits LP WUS in the LPWUS-O. The LP WUS indicates monitoring for UE's PO. In step 2512, the gNB transmits PEI in the PEI-O. The PEI indicates PO monitoring for UE's paging subgroup ID and its PO. In step 2514, the gNB transmits PDCCH addressed to P-RNTI in PO where DCI of PDCCH includes scheduling information for a paging message. The gNB transmits the paging message in PDSCH.

A gNB transmits/broadcasts the SI which includes a paging configuration/PEI configuration/LP WUS configuration.

Paging is received by a gNB from CN for a UE in an RRC_IDLE state and a paging message needs to be transmitted to a UE. Alternately data arrives for a UE in an RRC_INACTVE state and the UE needs to be paged.

A gNB determines UE's paging subgroup ID. If a UE has been assigned the paging subgrouping ID by CN and cell supports CN assigned paging subgrouping, paging subgroup ID is the CN assigned paging subgrouping ID. If the UE has not been assigned the paging subgrouping ID by CN or cell does not support CN assigned paging subgrouping and cell supports the UE ID based paging subgrouping, paging subgroup ID is determined as shown in TABLE 16.

TABLE 16

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state; N is |
| | broadcasted in system information |
| | Ns: number of paging occasions for a PF; Ns is broadcasted in system information |
| | UE_ID: received from AMF |
| | subgroupsNumForUEID: number of subgroups for UE_ID based subgrouping in a PO, which |
| | is broadcasted in system information |
| | subgroupsNumPerPO: number of subgroups per PO, which is broadcasted in system |
| | information |

A gNB determines the LPWUS-O (LP WUS occasion) to transmit LP WUS.

In one embodiment, an LP WUS configuration indicates LPWUS-Os (e.g., a configuration may signal period and/offset where LPWUS-O occurs periodically with the signalled period and first period may start at an offset from SFN 0, starting time (e.g., slot/symbol), starting frequency resource (e.g., PRB index), number of PRBs and number of slots/symbols of each LPWUS monitoring occasion may also be included in the configuration). In one embodiment, LPWUS-O for transmitting LP WUS to a UE is the latest LPWUS-O starting at an offset (can be pre-defined or configured in system information) before the start of UE's PEI-O or PF or PO. In one embodiment, LPWUS-O for transmitting LP WUS to the UE the latest LPWUS-O starting at least at an offset (can be pre-defined or configured in system information) before the start of UE's PEI-O or PF or PO. In one embodiment, LPWUS-O for transmitting LP WUS to the UE is the first LPWUS-O starting after an “offset (can be pre-defined or configured in system information) before the start of UE's PEI-O or PF or PO.” In one embodiment, the time location of LP WUS occasion is determined by a reference point and an offset.

The reference point is the start of a reference frame determined by a frame-level offset from the start of the frame of UE's PEI-O, frame-level offset is signaled in system information.

The offset is a symbol-level offset from the reference point to the start of the LPWUS-O, symbol-level offset is signaled in system information. symbol-level offset can be zero if not signaled.

A gNB transmits LPWUS in the LPWUS-O. LP WUS indicates monitoring for UE's PO (PO amongst the POs associated with PEI occasion corresponding to the LP WUS occasion, POs associated with PEI can be indexed from zero to number of POs per PEI, the index of UE's PO amongst these POs can be given by i_{PO}=((UE_IDmodN)·N_{S}+i_s)mod N_{PO}^{PEI}). The bit in the LP WUS payload corresponding to UE's PO is set to 1.

A gNB transmits PEI in the PEI-O. PEI indicates PO monitoring for UE's paging subgroup ID and its PO. The bit in the PEI payload corresponding to UE's paging subgroup ID and UE's PO is set to 1.

A gNB transmits PDCCH addressed to P-RNTI in PO where DCI of PDCCH includes scheduling information for a paging message.

A gNB transmits a paging message in PDSCH.

According to an embodiment of this disclosure, UEs can be categorized into LP WUS subgroups each identified by an LP WUS subgroup ID. The total number (Y) of LP WUS subgroups can be configurable. The configuration can be signaled in system information (e.g., SIB) or in an RRC message.

UE's LP WUS subgroup ID is determined (by UE and gNB) as shown in TABLE 17.

```
TABLE 17
LP WUS subgroup ID = paging subgroup ID mod Y; or
LP WUS subgroup ID = floor (paging subgroup ID/Y); or
LP WUS subgroup ID = (floor (UE_ID/(N*Ns)) mod LPWUSsubgroupsNumForUEID) + (Y
  LPWUSsubgroupsNumForUEID), where LPWUSsubgroupsNumForUEID is the number of
  LPWUS subgroups for UE_ID based subgrouping; or
LP WUS subgroup ID = floor (UE_ID/(N*Ns)) mod LPWUSsubgroupsNumForUEID, where
  LPWUSsubgroupsNumForUEID is the number of LPWUS subgroups for UE_ID based LP
  WUS subgrouping; or
LP WUS subgroup ID = paging subgroup ID; or
LP WUS subgroup ID = floor(UE_ID/(N*Ns)) mod Y; or
LP WUS subgroup ID = floor (UE_ID/A) mod Y, where A is the number of LPWUS occasions
  (per LPWUS period/cycle); or
LP WUS subgroup ID = floor (UE_ID/(A*B)) mod Y, where A is the number of LPWUS frames
  (per LPWUS period/cycle) and B is the number of LP WUS occasions per LP WUS frames;
  or
LP WUS subgroup ID = UE_ID mod Y
where paging subgroup ID can be assigned by AMF through NAS signalling; or it can be
determined using formula;
```

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state |
| | Ns: number of paging occasions for a PF |
| | UE_ID: 5G-S-TMSI mod X, where X is 32768, if eDRX (extended DRX) is applied; |
| | otherwise, X is 8192 |
| | subgroupsNumForUEID: number of paging subgroups for UE_ID based subgrouping |
| | in a PO, which is broadcasted in system information |
| | subgroupsNumPerPO: number of paging subgroups per PO, which is broadcasted in |
| | system information |

In one embodiment, each of these LP WUS subgroup ID is mapped to different LP WUS occasion. A UE monitors the LP WUS occasion associated with its LP WUS subgroup id. If LP WUS is received in the monitored LP WUS occasion, the UE monitor its PEI-O.

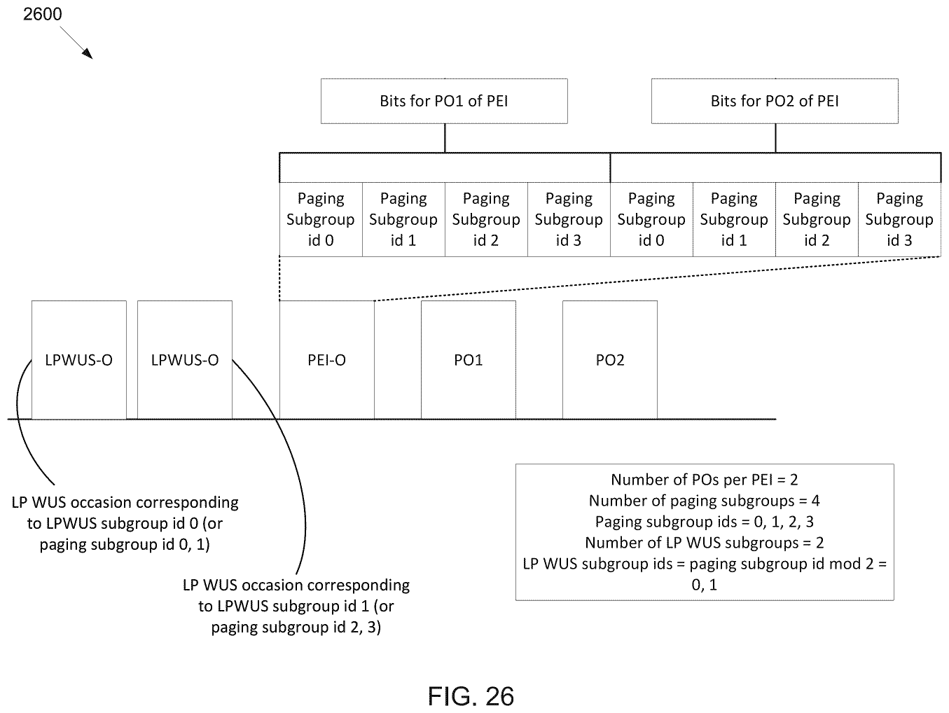

FIGS. 26-32 illustrate examples of PEI-O and PO determination 2600 to 3200 according to embodiments of the present disclosure. Embodiments of the PEI-O and PO determination 2600 to 3200 shown in FIGS. 26-32 are for illustration only.

FIG. 26 is an example illustration according to this embodiment. The number of POs per PEI is 2. The number of paging subgroups is 4. The paging subgroup IDs are 0, 1, 2, 3. The number (Y) of LP WUS subgroups is 2. LP WUS subgroup ID=paging subgroup ID mod 2. So, there are two LP WUS subgroup IDs, 0 and 1. LP WUS occasions are mapped to LPWUS subgroup ids 0 and 1. A UE monitors the LP WUS occasion associated with its LP WUS subgroup id. If LP WUS is received in the monitored LP WUS occasion, the UE monitor its PEI-O. If the UE detects PEI (i.e., it receives PDCCH addressed to P-RNTI in PEI-O) and the PEI (i.e., DCI of received PDCCH) indicates the paging subgroup the UE belongs to monitor its associated PO, the UE monitors the associated PO. If the UE does not detect PEI on the monitored PEI occasion or the PEI does not indicate the paging subgroup the UE belongs to monitor its associated PO, the UE is not required to monitor the associated PO. If PDCCH addressed to P-RNTI is received in the PO, and DCI of received PDCCH includes scheduling information for paging, the UE receives TB in scheduled PDSCH and receives the paging message in the TB.

In one embodiment, po-NumPerPEI LP WUS occasions precedes the PEI-O. Number of POs per PEI (or po-NumPerPEI) is signaled by a gNB in system information. POs associated with PEI can be indexed from zero to number of POs per PEI, the index of UE's PO amongst these POs can be given by i_{PO}=((UE_IDmodN)·N_{S}+i_s)mod N_{PO}^{PEI}) is set to 1. N_{PO}^{PEI} is the number of POs per PEI (or po-NumPerPEI signalled in system information). A UE monitors the LP WUS occasion associated with its PO (i.e., i_{PO}). If LP WUS is received in the monitored LP WUS occasion, the UE monitor its PEI-O.

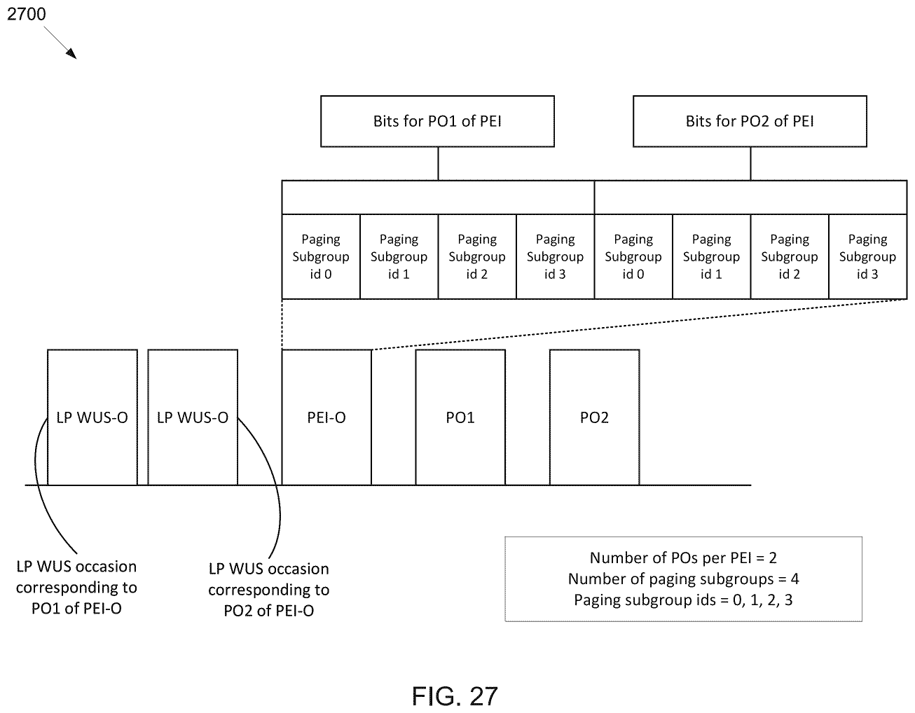

FIG. 27 is an example illustration according to this embodiment. The number of POs per PEI is 2. The number of paging subgroups is 4. The paging subgroup IDs are 0, 1, 2, 3. LP WUS occasions are mapped to PO1 and PO 2 of PEI-O a UE monitors the LP WUS occasion associated with its PO (i.e., i_{PO}). If LP WUS is received in the monitored LP WUS occasion, the UE monitors its PEI-O. If the UE detects PEI (i.e., it receives PDCCH addressed to P-RNTI in PEI-O) and the PEI (i.e., DCI of received PDCCH) indicates the paging subgroup the UE belongs to monitor its associated PO, the UE monitors the associated PO. If the UE does not detect PEI on the monitored PEI occasion or the PEI does not indicate the paging subgroup the UE belongs to monitor its associated PO, the UE is not required to monitor the associated PO. If PDCCH addressed to P-RNTI is received in the PO, and DCI of received PDCCH includes scheduling information for paging, the UE receives TB in scheduled PDSCH and receives the paging message in the TB.

According to an embodiment of this disclosure, UEs can be categorized into LP WUS subgroups each identified by an LP WUS subgroup ID. The total number (Y) of LP WUS subgroups can be configurable. The configuration can be signaled in system information (e.g., SIB) or in an RRC message.

UE's LP WUS subgroup ID is determined (by UE and gNB) as shown in TABLE 18.

```
TABLE 18
LP WUS subgroup ID = paging subgroup ID mod Y; or
LP WUS subgroup ID = floor (paging subgroup ID/Y); or
LP WUS subgroup ID = (floor (UE_ID/(N*Ns)) mod LPWUSsubgroupsNumForUEID) + (Y
  LPWUSsubgroupsNumForUEID), where LPWUSsubgroupsNumForUEID is the number of
  LPWUS subgroups for UE_ID based subgrouping; or
LP WUS subgroup ID = floor (UE_ID/(N*Ns)) mod LPWUSsubgroupsNumForUEID, where
  LPWUSsubgroupsNumForUEID is the number of LPWUS subgroups for UE_ID based LP
  WUS subgrouping; or
LP WUS subgroup ID = paging subgroup ID; or
LP WUS subgroup ID = floor(UE_ID/(N*Ns)) mod Y; or
LP WUS subgroup ID = floor (UE_ID/A) mod Y, where A is the number of LPWUS occasions
  (per LPWUS period/cycle); or
LP WUS subgroup ID = floor (UE_ID/(A*B)) mod Y, where A is the number of LPWUS frames
  (per LPWUS period/cycle) and B is the number of LP WUS occasions per LP WUS frames;
  or
LP WUS subgroup ID = UE_ID mod Y
where paging subgroup ID can be assigned by AMF through NAS signalling; or it can be
determined using formula;
```

| | |
|---|---|
| ∘ | SubgroupID = (floor (UE_ID/(N*Ns)) mod subgroupsNumForUEID) + |
| | (subgroupsNumPerPO − subgroupsNumForUEID) |
| | N: number of total paging frames in T, which is the DRX cycle of an RRC_IDLE state |
| | Ns: number of paging occasions for a PF |
| | UE_ID: 5G-S-TMSI mod X, where X is 32768, if eDRX (extended DRX) is applied; |
| | otherwise, X is 8192 |
| | subgroupsNumForUEID: number of paging subgroups for UE_ID based subgrouping |
| | in a PO, which is broadcasted in system information |
| | subgroupsNumPerPO: number of paging subgroups per PO, which is broadcasted in |
| | system information |

Each of these LP WUS subgroup ID is mapped to different LP WUS occasion. A UE monitors the LP WUS occasion associated with its LP WUS subgroup id. According to an embodiment of this disclosure, “number of POs per PEI” bits are carried in LP WUS payload. Number of POs per PEI (or po-NumPerPEI) is signaled by a gNB in system information. Each bit is uniquely mapped to PO (PO amongst the POs associated with PEI occasion corresponding to the LP WUS occasion). POs associated with PEI can be indexed from zero to number of POs per PEI, the index of UE's PO amongst these POs can be given by i_{PO}=((UE_IDmodN)·N_{S}+i_s)mod N_{PO}^{PEI}) is set to 1. N_{PO}^{PEI} is the number of POs per PEI (or po-NumPerPEI signalled in system information). Upon reception of LP WUS payload in monitored LP WUS occasion, the UE checks if the bit corresponding to its PO (PO amongst the POs associated with PEI occasion corresponding to the LP WUS occasion) is set to 1. If set to 1, the UE monitors its PEI-O. In one embodiment, paging/PEI monitoring/wakeup indication field of LP WUS payload includes K bits, where K=N_{PO}^{PEI} (Number of POs per PEI or po-NumPerPEI, signalled in system information). The UE determines a value for the (i_{PO}) bit in the paging/PEI monitoring/wakeup indication field of LP WUS payload received in monitored LPWUS occasion, where i_{PO}=((UE_IDmodN). N_{S}+i_s)mod N_{PO}^{PEI} is a paging occasion index, and UE_ID, N, N_{S}, i_{SG}, and i_s are as defined earlier. When the value is “1,” the UE monitors paging or PEI-O using MR; otherwise, the UE is not required to monitor the paging or PEI-O.

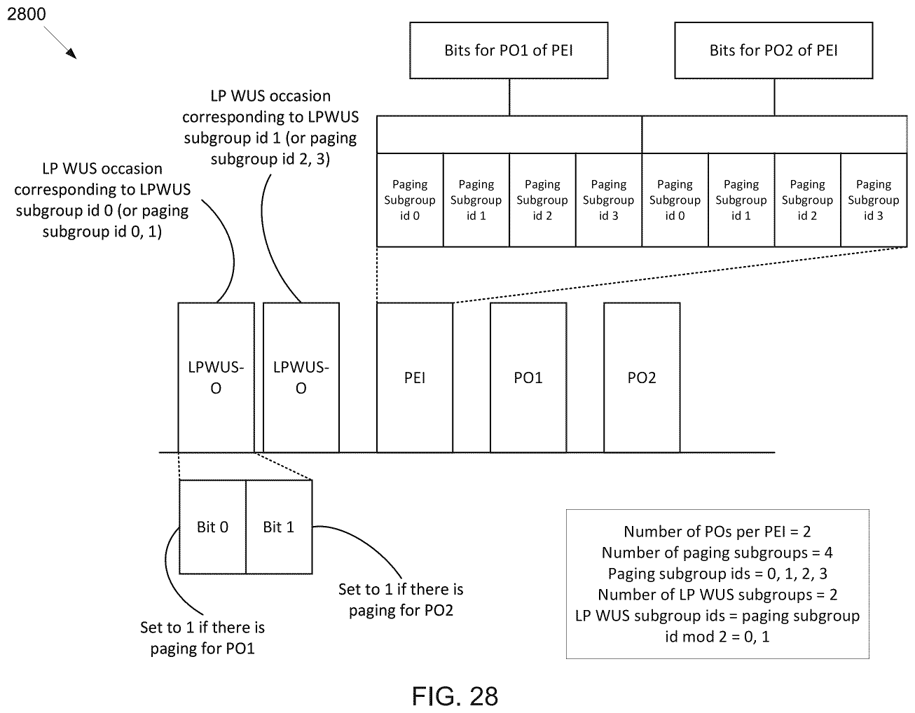

FIG. 28 is an example illustration according to this embodiment. The number of POs per PEI is 2 (PO1 with i_{PO}=0 and PO2 with i_{PO}=1). The number of paging subgroups is 4. The paging subgroup IDs are 0, 1, 2, 3. There are two LP WUS subgroup ids. LP WUS occasions are mapped to LPWUS subgroup ids 0 and 1. A UE monitors the LP WUS occasion associated with its LP WUS subgroup id. There are, “number of POs per PEI”=2 bits in LP WUS payload. These 2 bits are uniquely mapped to POs (POs associated with PEI occasion corresponding to the LP WUS occasion). Each bit uniquely maps to one of PO1 of PEI or PO2 of PEI. In the example, bit 0 is mapped to PO1 of PEI, bit 1 is mapped to PO2 of PEI. Bit 0 is set to 1 if there is paging for UE(s) associated with PO1 of PEI occasion corresponding to the LP WUS occasion. Bit 1 is set to 1 if there is paging for UE(s) associated with PO1 of PEI occasion corresponding to the LP WUS occasion.

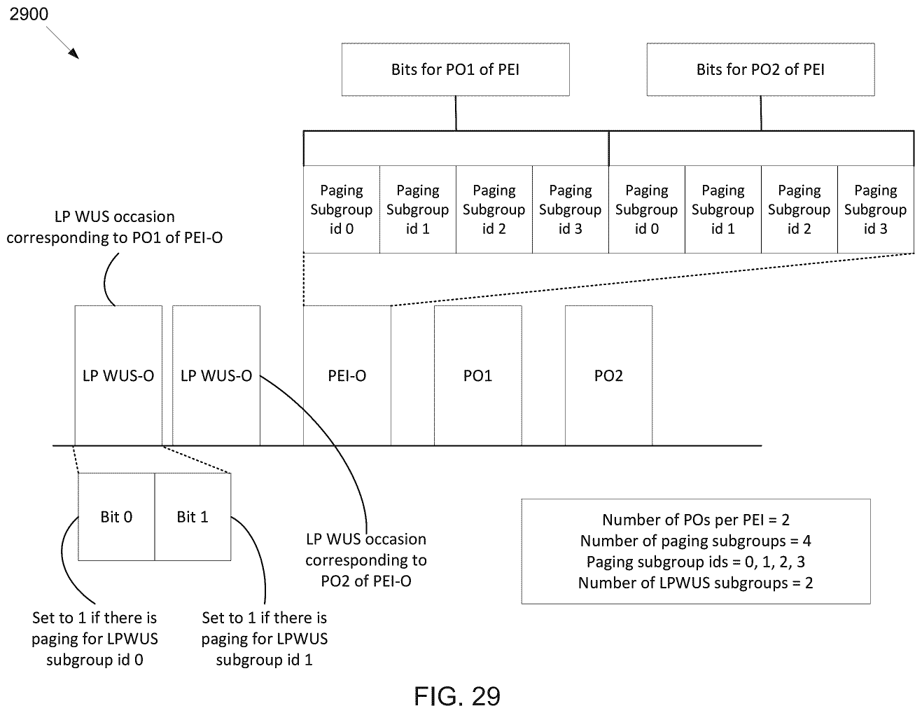

In one embodiment, po-NumPerPEI LP WUS occasions precedes the PEI-O. Number of POs per PEI (or po-NumPerPEI) is signaled by a gNB in system information. POs associated with PEI can be indexed from zero to number of POs per PEI, the index of UE's PO amongst these POs can be given by i_{PO}=((UE_IDmodN)·N_{S}+i_s)mod N_{PO}^{PEI}) is set to 1. N_{PO}^{PEI} is the number of POs per PEI (or po-NumPerPEI signalled in system information). A UE monitors the LP WUS occasion associated with its PO (i.e., i_{PO}). Paging/PEI monitoring/wakeup indication field of LP WUS payload includes K bits, where K=number of LPWUS subgroups is signalled in system information. The UE determines a value for the (i_{SG}) bit in the paging/PEI monitoring/wakeup indication field of LP WUS payload, where i_{SG} is the LPWUS subgroup id. When the value is “1,” the UE monitors paging or PEI-O using MR; otherwise, the UE is not required to monitor the paging or PEI-O. FIG. 29 is an example illustration according to this embodiment.

A UE may be in an RRC_IDLE or an RRC_INACTIVE state. The UE has acquired the SI of the camped cell which includes a paging configuration/PEI configuration/LP WUS configuration. The UE may have received the CN assigned paging subgroup ID from AMF while the UE was in an RRC_CONNECTED state. The UE may receive CN paging (in the RRC_IDLE and in the RRC_INACTIVE), RAN paging (in the RRC_INACTIVE), system information update notifications, ETWS/CMAS notifications from the camped cell.

A UE may monitor LP WUS (using LR) in the LPWUS-O, if the UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

LP WUS may be monitored on same DL carrier/frequency as the carrier/frequency on which the signals (such as PDCCH/PDSCH) by MR are received. LP WUS can be received on different DL carrier/frequency than the carrier/frequency on which the signals (such as PDCCH/PDSCH) by MR are received. The DL carrier/frequency for LP WUS can be signaled by the gNB in SI (e.g., SIB1 or MIB or any another SIB). The DL BWP for receiving LP WUS can be initial DL BWP or it can be a different BWP signalled by the gNB in SI (e.g., SIB1 or MIB or another SIB).

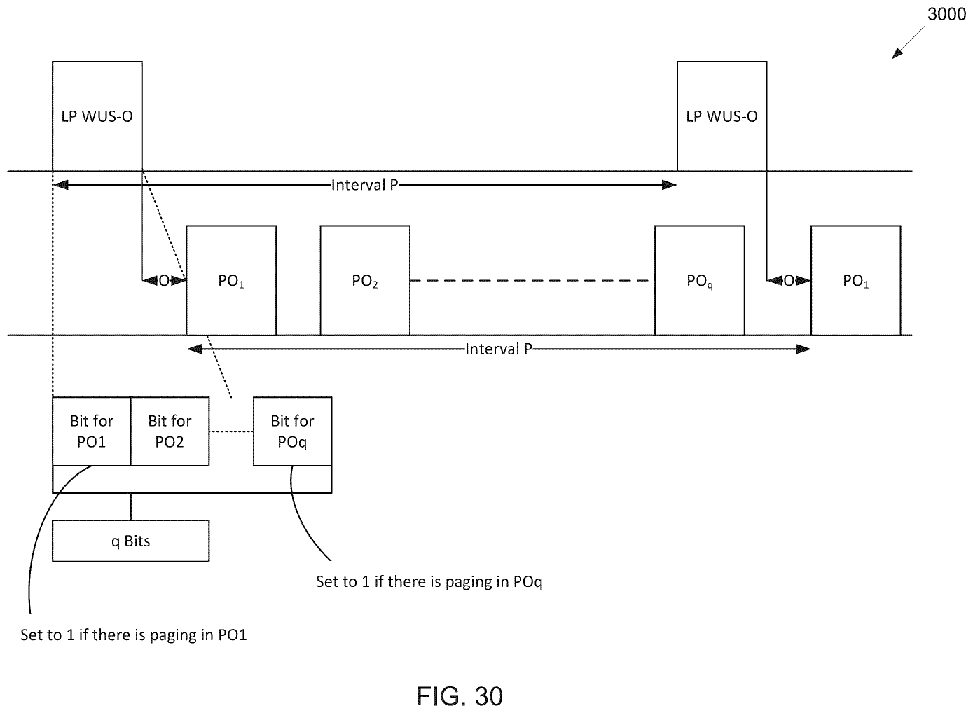

In one embodiment, LPWUS-Os monitored by a UE occur periodically at interval P as shown in FIG. 30. Interval P can be signaled by a gNB in system information. LPWUS payload transmitted in LPWUS-O include “Q” bits mapped to “Q” POs, where each bit is mapped to a PO. The POs indicated by a LP WUS occasion are the POs occurring in the interval “offset (O)+P” from the end of the LPWUS-O. Offset can be signaled by the gNB in system information. These “Q” POs are sequentially mapped to Q bits in LPWUS payload. In one embodiment, the POs indicated by a LP WUS occasion are the Q consecutive POs starting from the first PO after an “offset” from end of LPWUS-O. Offset and Q can be signaled by the gNB in system information.

Paging/PEI monitoring/wakeup indication field of LP WUS payload includes Q bits, where Q=number of POs. A UE determines a value for the bit in the paging/PEI monitoring/wakeup indication field of LP WUS payload corresponding to its PO amongst the Q POs indicated by the monitored LPWUS-O. When the value is “1,” the UE monitors paging or PEI-O corresponding to its PO or its PO using MR; otherwise, the UE is not required to monitor the paging or PEI-O or PO. FIG. 30 is an example illustration according to this embodiment. Note that UE determines its PF/PO/PEI-O as explained earlier.

A UE may be in an RRC_IDLE or an RRC_INACTIVE state. The UE has acquired the SI of the camped cell which includes a paging configuration/PEI configuration/LP WUS configuration. The UE may have received the CN assigned paging subgroup ID from AMF while the UE was in an RRC_CONNECTED state. The UE may receive CN paging (in the RRC_IDLE and in the RRC_INACTIVE), RAN paging (in the RRC_INACTIVE), system information update notifications, ETWS/CMAS notifications from the camped cell.

A UE may monitor LP WUS (using LR) in the LPWUS-O, if the UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

LP WUS may be monitored on same DL carrier/frequency as the carrier/frequency on which the signals (such as PDCCH/PDSCH) by MR are received. LP WUS can be received on different DL carrier/frequency than the carrier/frequency on which the signals (such as PDCCH/PDSCH) by MR are received. The DL carrier/frequency for LP WUS can be signaled by the gNB in SI (e.g., SIB1 or MIB or any another SIB). The DL BWP for receiving LP WUS can be initial DL BWP or it can be a different BWP signalled by the gNB in SI (e.g., SIB1 or MIB or another SIB).

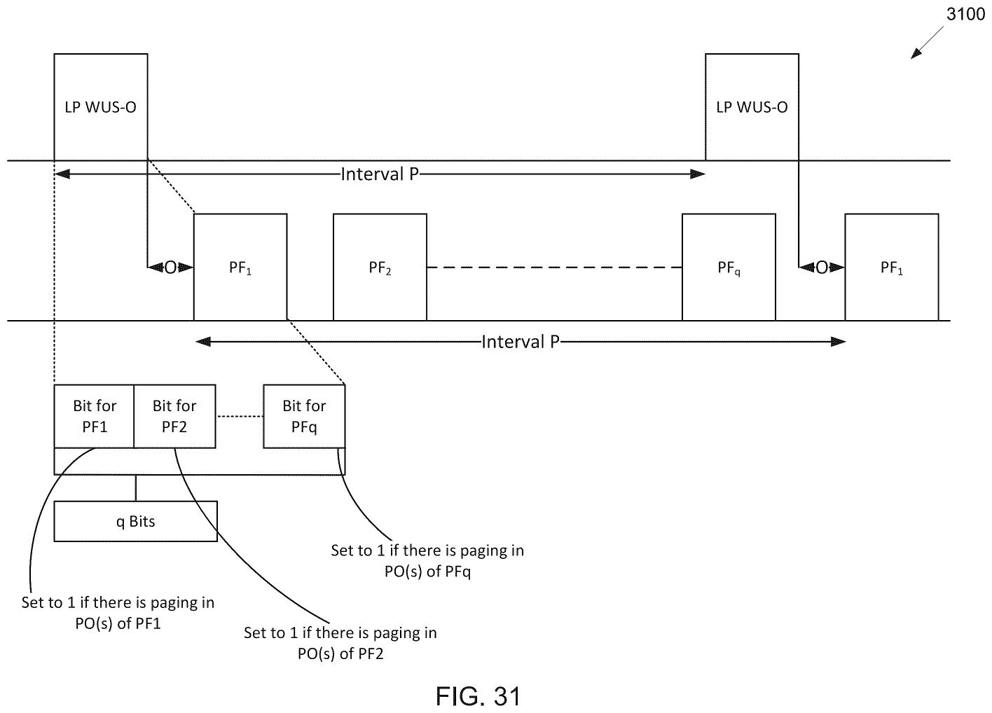

In one embodiment, LPWUS-Os monitored by a UE occur periodically at interval Pas shown in FIG. 31. Interval P can be signaled by the gNB in system information. LPWUS payload transmitted in LPWUS-O include “Q” bits mapped to “Q” PFs, where each bit is mapped to a PF. The PFs indicated by a LP WUS occasion are the PFs occurring in the interval “offset (O)+P” from the end of the LPWUS-O. Offset can be signaled by the gNB in system information. These “Q” PFs are sequentially mapped to Q bits in LPWUS payload. In one embodiment, the PFs indicated by a LP WUS occasion are the Q consecutive PFs starting from the first PF after an “offset” from end of LPWUS-O. Offset and Q can be signaled by the gNB in system information.

Paging/PEI monitoring/wakeup indication field of LP WUS payload includes Q bits, where Q=number of PFs. A UE determines a value for the bit in the paging/PEI monitoring/wakeup indication field of LP WUS payload corresponding to its PF amongst the Q PFs indicated by the monitored LPWUS-O. When the value is “1,” the UE monitors paging or PEI-O corresponding to its PO or its PO using MR; otherwise, the UE is not required to monitor the paging or PEI-O or PO. FIG. 30 is an example illustration according to this embodiment. Note that UE determines its PF/PO/PEI-O as explained earlier.

Criteria to monitor LP WUS based on a UE type and BWP.

In fifth generation wireless communication system UEs with reduced capabilities are supported.

A RedCap UE is the UE with following reduced capability: (1) the maximum bandwidth is 20 MHz for FR1 (i.e., frequency range of 410 MHZ-7125 MHZ), and is 100 MHZ for FR2 (i.e., frequency range of 24250 MHz-52600 MHZ). A UE features and corresponding capabilities related to a UE bandwidths wider than 20 MHz in FR1 or wider than 100 MHz in FR2 are not supported by RedCap UEs; (2) the maximum mandatory supported DRB (data radio bearer) number is 8; (3) the mandatory supported PDCP SN (packet data convergence protocol sequence number) length is 12 bits while 18 bits being optional; (4) the mandatory supported RLC AM SN length is 12 bits while 18 bits being optional; (5) for FR1, 1 DL MIMO layer if 1 Rx branch is supported, and 2 DL MIMO layers if 2 Rx branches are supported; for FR2, either 1 or 2 DL MIMO layers can be supported, while 2 Rx branches are supported. For FR1 and FR2, UE features and corresponding capabilities related to more than 2 UE Rx branches or more than 2 DL MIMO layers, as well as UE features and capabilities related to more than 1 UE Tx branch or more than 1 UL MIMO layer are not supported by RedCap UEs; and (6) CA, MR-DC, DAPS, CPAC and IAB (i.e., the RedCap UE is not expected to act as IAB node) related UE features and corresponding capabilities are not supported by RedCap UEs. All other feature groups or components of the feature groups as captured in TR 38.822 (3GPP TR 38.822: “NR; User Equipment (UE) feature list) as well as capabilities specified in this specification remain applicable for RedCap UEs same as non-RedCap UEs, unless indicated otherwise.

An eRedCap UE is the UE with one or more of the following reduced capability in addition to reduced capability defined for a RedCap UE: (1) UE BB bandwidth reduction: (i) 5 MHz BB bandwidth only for PDSCH (for both unicast and broadcast) and PUSCH, with 20 MHZ RF bandwidth for UL and DL; and (ii) the other physical channels and signals are still allowed to use a BWP up to the 20 MHz maximum UE RF+BB bandwidth; and (2) UE peak data rate reduction.

A UE may monitor LP WUS (using LR) in the LPWUS-O, if the UE supports LP WUS and/or is camped in a cell supporting LP WUS and/or cell quality or RSRP of DL path loss reference is below a configured threshold and/or a gNB has indicated to monitor LP WUS for UE's (paging) subgroup and/or the gNB has indicated the UE to monitor LP WUS in an RRC release message and/or the UE is in same cell where it last received RRCRelease message and/or low mobility (e.g., cell quality or RSRP of DL path loss reference has not changed above a threshold over a time interval) criteria is met and/or not at cell edge criteria is met and/or “If lastUsedCellOnlyLPWUS (or lastUsedCellOnly) is configured in system information of camped cell and the UE most recently received RRCRelease without noLastCellUpdateLPWUS (or noLastCellUpdate) in this cell” and/or “If lastUsedCellOnlyLPWUS (or lastUsedCellOnly) is not configured in system information of camped cell.” LR is used to receive LP WUS.

BWP aspects and a UE type may need to be additionally considered to determine whether to monitor LP WUS or not. In one embodiment, an LP WUS configuration is signaled separately for redcap specific initial DL BWP and non-redcap specific initial DL BWP.

If a UE is (c) redcap UE and if the UE supports LP WUS and if redcap specific initial DL BWP is configured and if an LP WUS configuration for redcap specific initial DL BWP is configured: if the UE is in coverage of LP WUS i.e., cell quality or RSRP of DL path loss reference is below a configured threshold (and/or other criteria to monitor LP WUS are met); the UE monitors LP WUS in redcap specific initial DL BWP, else the UE does not monitor LP WUS.

If a UE is (c) redcap UE and if the UE support LP WUS and if redcap specific initial DL BWP is configured and if an LP WUS configuration for redcap specific initial DL BWP is not configured: (1) Option 1: the UE does not monitor LP WUS; (2) Option 2: if an LP WUS configuration for non-redcap specific initial DL BWP is configured, the UE monitors LP WUS in redcap specific initial DL BWP using the LP WUS configuration for non-redcap specific initial DL BWP. If the LP WUS configuration for non-redcap specific initial DL BWP is not configured, the UE does not monitor LP WUS; and (3) Option 3: if an LP WUS configuration for non-redcap specific initial DL BWP is configured, the UE monitors LP WUS in non-redcap specific initial DL BWP.

If the UE is (c) redcap UE and if the UE support LP WUS and if redcap specific initial DL BWP is not configured and if an LP WUS configuration for non-redcap specific initial DL BWP is configured; or if the UE is not a (c) redcap UE and if the UE support LP WUS and if an LP WUS configuration for non-redcap specific initial DL BWP is configured: if the UE is in coverage of LP WUS i.e., cell quality or RSRP of DL path loss reference is below a configured threshold (and/or other criteria to monitor LP WUS are met), a UE monitors LP WUS in non-redcap specific initial DL BWP, else a UE does not monitor LP WUS.

If a UE is (c) redcap UE and if the UE support LP WUS and if redcap specific initial DL BWP is not configured and if an LP WUS configuration for non-redcap specific initial DL BWP is not configured; or if the UE is not a (c) redcap UE and if the UE support LP WUS and if an LP WUS configuration for non-redcap specific initial DL BWP is not configured: the UE does not monitor LP WUS.

Handling overlapping between SI reception and LP WUS occasion: a UE receives LP WUS using LR. LP WUS indicates that the UE may monitor PEI.

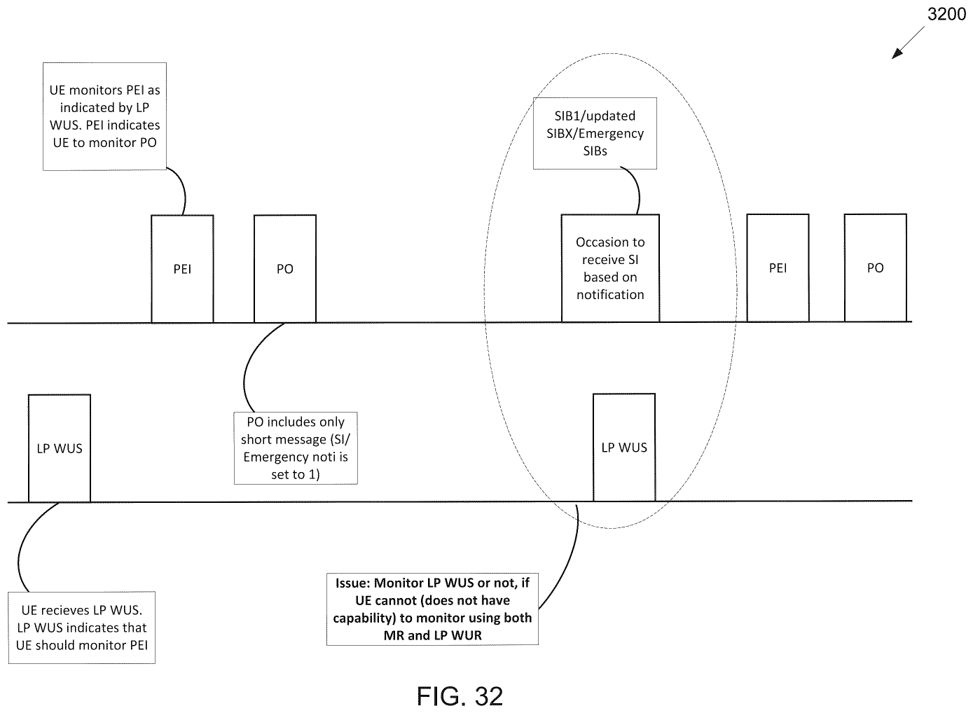

A UE monitors PEI as indicated by LP WUS using MR. PEI indicates the UE to monitor PO. UE monitors PO using MR. PO includes a short message (with SI/Emergency notification is set to 1). A UE needs to acquire the updated SIBs/emergency nonfiction SIBs using MR. The occasion to receive SI/SIBs based on notification may overlap with LP WUS occasion as shown in FIG. 32.

A UE may not have the capability to monitor using both LR and MR concurrently. In case, the UE does not have the capability to monitor using both LR and MR concurrently and occasion to monitor SI and monitor LP WUS overlap.

In one embodiment, a UE do not monitor LP WUS monitoring (i.e., skip LP WUS monitoring) and monitor SI. The UE monitors PEI associated with skipped LP WUS.

In one embodiment, a UE monitors LP WUS and delay monitoring of SI to occasion not overlapping with LP WUS.

In one embodiment, if SI/SIB is related to emergency notification, a UE do not monitor LP WUS monitoring (i.e., skip LP WUS monitoring) and monitor SI. Otherwise, the UE monitors LP WUS and delay monitoring of SI to occasion not overlapping with LP WUS.

A UE may not have the capability to monitor using both LR and MR concurrently. In case, the UE does not have the capability to monitor using both LR and MR concurrently.

In one embodiment, a UE do not monitor DL using LR (i.e., skip monitoring DL signals using LR) and priorities monitoring DL using MR. In one example, the UE may priorities monitoring SSBs using MR over monitoring LPSS/LPWS-O using LR.

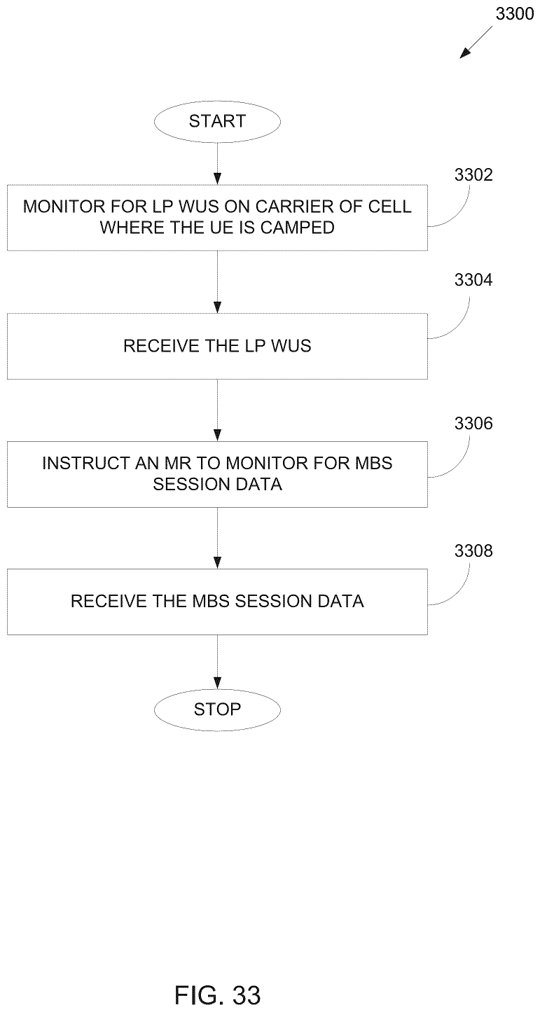

FIG. 33 illustrates a flowchart of a method 3300 for a paging monitoring operation for a multicast and broadcast session according to embodiments of the present disclosure. The method 3300 as may be performed by a UE (e.g., 111-116 as illustrated in FIG. 1). An embodiment of the method 3300 shown in FIG. 33 is for illustration only. One or more of the components illustrated in FIG. 33 can be implemented in specialized circuitry configured to perform the noted functions or one or more of the components can be implemented by one or more processors executing instructions to perform the noted functions.

As illustrated in FIG. 33, the method 3300 begins at step 3302. In step 3302, the UE monitors for an LP WUS on a carrier of a cell where the UE is camped.

In step 3304, the UE receives the LP WUS.

In step 3306, the UE instructs an MR to monitor for MBS session data in response to a reception of the LP WUS.

In step 3308, the UE receives the MBS session data when at least one MBS session is activated.

In one embodiment, when the LP WUS includes an MBS group notification or an MBS subgroup notification, the UE monitors, via the MR, a PO and receives a paging message indicating at least one TMGI for the activated at least one MBS session. In such embodiments, the MBS group notification is (i) one bit, (ii) a dedicated sequence for an MBS with which the LP WUS is scrambled, or (iii) a dedicated LP WUS occasion for the MBS group notification or an MBS paging indication.

In such embodiment, the LP WUS includes at least one of: a) at least one TMGI for the activated at least one MBS session; b) bit map information for at least one of an MBS group notification or an MBS paging indication, each of the at least one TMGI being configured as a different value, respectively; and c) includes an indication indicating the UE to resume a reception of MBS session data in a radio resource control inactive (RRC_INACTIVE) state, the indication being configured per the at least one TMGI or being configured as a common value for the at least one TMGI.

In one embodiment, the UE, in response to the reception of the LP WUS, monitors, via the MR, a PO; receives a paging message indicating at least one TMGI for the activated at least one MBS session; and receive the MBS session data of the activated at least one MBS session indicated in the paging message.

In one embodiment, the UE, when the LP WUS includes a paging subgroup notification or a LP WUS subgroup notification: monitors, via the MR, a PO; receives a paging message indicating at least one TMGI for the activated at least one MBS session; and receive the MBS session data of the activated at least one MBS session indicated in the paging message.

In one embodiment, the UE, when the LP WUS includes an indication to monitor a paging message: monitors, via the MR, a PO; receives a paging message indicating at least one TMGI for the activated at least one MBS session; and receive the MBS session data of the activated at least one MBS session indicated in the paging message.

In one embodiment, the UE determines to instruct the LR to monitor for the LP WUS when at least one of: (1) the UE supports the LP WUS, (2) the UE camps in the cell supporting the LP WUS, (3) at least one of cell quality or a RSRP of a DL path loss reference is below a configured threshold, (4) a BS indicates the UE to monitor the LP WUS for a paging subgroup, (5) the BS indicates the UE to monitor the LP WUS in a RRC release message, (6) the UE camps in a same cell where the UE lastly receives the RRC release message, and (7) a low mobility condition for the UE is met, the low mobility condition being met when the cell quality or the RSRP of the DL path loss reference is not changed above the configured threshold during a configured time interval, wherein: the LP WUS is received, via the LR, on: (1) a first DL carrier or frequency that is same as a second DL carrier or frequency where a PDCCH and a PDSCH are received, or (2) the first DL carrier or frequency that is different than the second DL carrier or frequency where the PDCCH and the PDSCH are received; the first DL carrier or frequency for the LP WUS is configured, via a SIB, by the BS; and a DL BWP for receiving the LP WUS is (i) an initial DL BWP or (ii) a different BWP configured, via the SIB, by the BS.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a low-power receiver (LR) configured to:
monitor for a low power wakeup signal (LP WUS) on a carrier of a cell where the UE is camped, and
receive the LP WUS;
a processor operably coupled to the LR, the processor configured to instruct a main receiver (MR) to monitor for multicast broadcast (MBS) session data in response to a reception of the LP WUS; and
the MR operably coupled to the processor, the MR configured to receive the MBS session data when at least one MBS session is activated.

2. The UE of claim 1, wherein:
when the LP WUS includes an MBS group notification or an MBS subgroup notification:
the processor is further configured to monitor, via the MR, a paging occasion (PO), and
the MR is further configured to receive a paging message indicating at least one temporary mobile group identity (TMGI) for the activated at least one MBS session; and
the MBS group notification is (i) one bit, (ii) a dedicated sequence for an MBS with which the LP WUS is scrambled, or (iii) a dedicated LP WUS occasion for the MBS group notification or an MBS paging indication.

3. The UE of claim 1, wherein the LP WUS includes at least one of:
a) at least one temporary mobile group identity (TMGI) for the activated at least one MBS session;
b) bit map information for at least one of an MBS group notification or an MBS paging indication, each of the at least one TMGI being configured as a different value, respectively; and
c) includes an indication indicating the UE to resume a reception of the MBS session data in a radio resource control inactive (RRC_INACTIVE) state, the indication being configured per the at least one TMGI or being configured as a common value for the at least one TMGI.

4. The UE of claim 1, wherein:
in response to the reception of the LP WUS, the processor is further configured to monitor, via the MR, a paging occasion (PO); and
the MR is further configured to:
receive a paging message indicating at least one temporary mobile group identity (TMGI) for the activated at least one MBS session, and
receive the MBS session data of the activated at least one MBS session indicated in the paging message.

5. The UE of claim 1, wherein, when the LP WUS includes a paging subgroup notification or a LP WUS subgroup notification:
the processor is further configured to monitor, via the MR, a paging occasion (PO); and
the MR is further configured to:
receive a paging message indicating at least one temporary mobile group identity (TMGI) for the activated at least one MBS session; and
receive the MBS session data of the activated at least one MBS session indicated in the paging message.

6. The UE of claim 1, wherein, when the LP WUS includes an indication to monitor a paging message:
the processor is further configured to monitor, via the MR, a paging occasion (PO); and
the MR is further configured to:
receive a paging message indicating at least one temporary mobile group identity (TMGI) for the activated at least one MBS session, and
receive the MBS session data of the activated at least one MBS session indicated in the paging message.

7. The UE of claim 1, wherein:
the LP WUS is received, via the LR, on:
a first downlink (DL) carrier or frequency that is same as a second DL carrier or frequency where a physical downlink control channel (PDCCH) and a physical downlink shared channel (PDSCH) are received, or
the first DL carrier or frequency that is different than the second DL carrier or frequency where the PDCCH and the PDSCH are received;
the first DL carrier or frequency for the LP WUS is configured, via a system information block (SIB), by a base station (BS);
a DL bandwidth part (BWP) for receiving the LP WUS is (i) an initial DL BWP or (ii) a different BWP configured, via the SIB, by the BS; and
the processor is further configured to determine to instruct the LR to monitor for the LP WUS when at least one of:
the UE supports the LP WUS,
the UE camps in the cell supporting the LP WUS,
at least one of cell quality or a reference signal received power (RSRP) of a downlink (DL) path loss reference is below a configured threshold,
the BS indicates the UE to monitor the LP WUS for a paging subgroup,
the BS indicates the UE to monitor the LP WUS in a radio resource control (RRC) release message,
the UE camps in a same cell where the UE lastly receives the RRC release message, and
a low mobility condition for the UE is met, the low mobility condition being met when the cell quality or the RSRP of the DL path loss reference is not changed above the configured threshold during a configured time interval.

8. A method of a user equipment (UE) comprising a low-power receiver (LR) in a wireless communication system, the method comprising:
monitoring for a low power wakeup signal (LP WUS) on a carrier of a cell where the UE is camped;
receiving the LP WUS;
instructing a main receiver (MR) to monitor for multicast broadcast (MBS) session data in response to a reception of the LP WUS; and
receiving the MBS session data when at least one MBS session is activated.

9. The method of claim 8, further comprising, when the LP WUS includes an MBS group notification or an MBS subgroup notification:
monitoring, via the MR, a paging occasion (PO); and
receiving a paging message indicating at least one temporary mobile group identity (TMGI) for the activated at least one MBS session,
wherein the MBS group notification is (i) one bit, (ii) a dedicated sequence for an MBS with which the LP WUS is scrambled, or (iii) a dedicated LP WUS occasion for the MBS group notification or an MBS paging indication.

10. The method of claim 8, wherein the LP WUS includes at least one of:
a) at least one temporary mobile group identity (TMGI) for the activated at least one MBS session;
b) bit map information for at least one of an MBS group notification or an MBS paging indication, each of the at least one TMGI being configured as a different value, respectively; and
c) includes an indication indicating the UE to resume a reception of MBS session data in a radio resource control inactive (RRC_INACTIVE) state, the indication being configured per the at least one TMGI or being configured as a common value for the at least one TMGI.

11. The method of claim 8, further comprising:
in response to the reception of the LP WUS, monitoring, via the MR, a paging occasion (PO);
receiving a paging message indicating at least one temporary mobile group identity (TMGI) for the activated at least one MBS session; and
receiving the MBS session data of the activated at least one MBS session indicated in the paging message.

12. The method of claim 8, wherein, when the LP WUS includes a paging subgroup notification or a LP WUS subgroup notification, further comprising:
monitoring, via the MR, a paging occasion (PO);
receiving a paging message indicating at least one temporary mobile group identity (TMGI) for the activated at least one MBS session; and
receiving the MBS session data of the activated at least one MBS session indicated in the paging message.

13. The method of claim 8, wherein, when the LP WUS includes an indication to monitor a paging message, further comprising:
monitoring, via the MR, a paging occasion (PO);
receiving a paging message indicating at least one temporary mobile group identity (TMGI) for the activated at least one MBS session; and
receiving the MBS session data of the activated at least one MBS session indicated in the paging message.

14. The method of claim 8, further comprising:
determining to instruct the LR to monitor for the LP WUS when at least one of:
the UE supports the LP WUS,
the UE camps in the cell supporting the LP WUS,
at least one of cell quality or a reference signal received power (RSRP) of a downlink (DL) path loss reference is below a configured threshold,
a base station (BS) indicates the UE to monitor the LP WUS for a paging subgroup,
the BS indicates the UE to monitor the LP WUS in a radio resource control (RRC) release message,
the UE camps in a same cell where the UE lastly receives the RRC release message, and
a low mobility condition for the UE is met, the low mobility condition being met when the cell quality or the RSRP of the DL path loss reference is not changed above the configured threshold during a configured time interval,
wherein:
the LP WUS is received, via the LR, on:
a first downlink (DL) carrier or frequency that is same as a second DL carrier or frequency where a physical downlink control channel (PDCCH) and a physical downlink shared channel (PDSCH) are received, or
the first DL carrier or frequency that is different than the second DL carrier or frequency where the PDCCH and the PDSCH are received;
the first DL carrier or frequency for the LP WUS is configured, via a system information block (SIB), by the BS; and
a DL bandwidth part (BWP) for receiving the LP WUS is (i) an initial DL BWP or (ii) a different BWP configured, via the SIB, by the BS.

15. A base station (BS) in a wireless communication system, the BS comprising:
a processor configured to generate a low power wakeup signal (LP WUS); and
a transceiver operably coupled to the processor, the transceiver configured to:
transmit, to a user equipment (UE) comprising a low-power receiver (LR), the LP WUS on a carrier of a cell where the UE is camped, and
transmit, to the UE, multicast broadcast (MBS) session data after transmitting the LP WUS, wherein the MBS session data is monitored by a main receiver (MR) of the UE when at least one MBS session is activated.

16. The BS of claim 15, wherein:
when the LP WUS includes an MBS group notification or an MBS subgroup notification, the transceiver is further configured to:
transmit, to the UE, a paging occasion (PO), the PO being monitored via the MR, and
transmit, to the UE, a paging message indicating at least one temporary mobile group identity (TMGI) for the activated at least one MBS session; and
the MBS group notification is (i) one bit, (ii) a dedicated sequence for an MBS with which the LP WUS is scrambled, or (iii) a dedicated LP WUS occasion for the MBS group notification or an MBS paging indication.

17. The BS of claim 15, wherein the LP WUS includes at least one of:
a) at least one temporary mobile group identity (TMGI) for the activated at least one MBS session;
b) bit map information for at least one of an MBS group notification or an MBS paging indication, each of the at least one TMGI being configured as a different value, respectively; and
c) includes an indication indicating the UE to resume a reception of MBS session data in a radio resource control inactive (RRC_INACTIVE) state, the indication being configured per the at least one TMGI or being configured as a common value for the at least one TMGI.

18. The BS of claim 15, wherein the transceiver is further configured to:
transmit, to the UE, a paging occasion (PO) after transmitting the LP WUS, the PO is monitored via the MR;
transmit a paging message indicating at least one temporary mobile group identity (TMGI) for the activated at least one MBS session; and
transmit the MBS session data of the activated at least one MBS session indicated in the paging message.

19. The BS of claim 15, wherein, when the LP WUS includes a paging subgroup notification or a LP WUS subgroup notification, the transceiver is further configured to:
transmit, to the UE, a PO, the PO being monitored via the MR;
transmit, to the UE, a paging message indicating at least one temporary mobile group identity (TMGI) for the activated at least one MBS session; and
transmit, to the UE, the MBS session data of the activated at least one MBS session indicated in the paging message.

20. The BS of claim 15, wherein, when the LP WUS includes an indication to monitor a paging message, the transceiver is further configured to:
transmit, to the UE, a paging occasion (PO), the PO being monitored via the MR;
transmit, to the UE, a paging message indicating at least one temporary mobile group identity (TMGI) for the activated at least one MBS session; and
transmit, to the UE, the MBS session data of the activated at least one MBS session indicated in the paging message.
